(19) United States
(12) Patent Application Publication
(10) Pub. No.: US 2011/0202328 A1
(43) Pub. Date: Aug. 18, 2011

(54) System for the determination of selective absorbent molecules through predictive correlations

(75) Inventors: Kevin C. Furman, Houston, TX (US); Michael Siskin, Westfield, NJ (US); Alan R. Katritzky, Gainesville, FL (US)

(73) Assignee: ExxonMobil Research and Engineering Company, Annandale, NJ (US)

(21) Appl. No.: 12/886,899

(22) Filed: Sep. 21, 2010

Related U.S. Application Data
(60) Provisional application No. 61/278,230, filed on Oct. 2, 2009.

(51) Int. Cl. G06G 7/58

(52) U.S. Cl. 703/12

(57) ABSTRACT

A method for determining absorbent molecules that are effective for the property of acid gas removal from feedstreams comprising a) determining a set of known molecules that are effective for acid gas removal, b) defining descriptive parameters (descriptors) that correlate with the structure of molecules with known acid gas removal, c) assigning a value to each descriptor for each of the known molecules and developing a quantitative structure and property relationship (QSPR), and d) generating molecular structures that will be effective for acid gas removal from the structure and property relationship.

This application claims the benefit of U.S. Provisional Application No. 61/278,230 filed Oct. 2, 2009.

### BACKGROUND OF THE INVENTION

The present invention is a method for determining molecules of interest with respect to a molecular property. In particular, the present invention correlates experimental H₂S vs. CO₂ selectivity values with projected absorbents using molecular descriptions developed by quantitative structure-property relationships (QSPR).

Theoretically, all of the information required to determine chemical and physical properties of a chemical compound is coded within its structural formula. Quantitative Structure-Property Relationships (QSPR) is the process by which chemical structure is quantitatively correlated with a well defined process such as chemical reactivity. The goal of QSPR is to find a mathematical relationship between an activity or property under investigation and one or more descriptive parameters (descriptors) related to the structure of the molecule for a chemical compound.

A fundamental goal of QSPR studies is to predict physical, chemical, biological and technological properties of chemicals from simpler “descriptors”, calculated solely from molecular structure. To accomplish this, numerous experimental and computed descriptors have been developed for QSPR studies. The descriptor associates a real number with a chemical, and then sorts the set of chemicals according to the numerical value of the specific property. Each descriptor or property provides a scale for a particular set of chemicals.

QSPR or quantitative structure related analysis of physicochemical properties prior to 1970 had major applications only in analytical chemistry. The last three decades, however, have seen the development of a theoretical basis of QSPR with many contributions. Review papers on QSPR are given below. The development of this methodology was also supported by the simultaneous development of molecular structure-based descriptors that made it possible to describe molecules more precisely.

QSPR is now well-established and correlates varied complex physicochemical properties of a compound with its molecular structure through a set of descriptors. The basic strategy of QSPR is to find the optimum quantitative relationship between descriptors and structures, enabling the prediction of properties. QSPR became more attractive for chemists when new software tools allowed them to discover and to understand how molecular structure influences properties and to predict and prepare optimum structures. The software is now amenable to chemical and physical interpretation. There are still significant opportunities for the application of purely structure-based molecular descriptors in QSAR models through the use of physicochemical properties predicted with QSPR.

The QSPR approach has been applied in many different areas, including (i) properties of single molecules (e.g., boiling point, critical temperature, vapor pressure, flash point and autoignition temperature, density, refractive index, melting point; (ii) interactions between different molecular species (e.g., octanol/water partition coefficient, aqueous solubility of liquids and solids, aqueous solubility of gases and vapors, solvent polarity scales, GC retention time and response factor); (iii) surfactant properties (e.g., critical micelle concentration, cloud point) and (iv) complex properties of polymers (e.g., polymer glass transition temperature, polymer refractive index, rubber vulcanization acceleration).

### SUMMARY OF THE INVENTION

The present invention includes a method for generating and/or identifying molecules of interest with respect to some molecular property. The molecular property is selectivity or a property which combines selectivity, aqueous solubility and vapor pressure for finding H₂S absorbents.

Three characteristics, which are of ultimate importance in determining the effectiveness of the absorbent compounds to be identified for H₂S removal, are “selectivity”, “loading” and “capacity”. The term “selectivity” as used throughout this document is defined as the following mole ratio fraction:

$$\frac{( moles of {H}_{2} S / moles of {CO}_{2} ) in liquid phase}{( moles of {H}_{2} S / moles of {CO}_{2} ) in gaseous phase}$$

The higher this fraction, the greater the selectivity of the absorbent solution for the H₂S gas. The term “loading” is defined as the concentration of the [H₂S+CO₂] gases [including H₂S and CO₂ both physically dissolved and chemically combined] in the absorbent solution as expressed in total moles of the two gases per mole of the amine. “Capacity” is defined as the moles of H₂S loaded in the absorbent solution after the absorption step minus the moles of H₂S loaded in the absorbent solution after the desorption step.

Let P represent either selectivity alone or an alternate relationship of selectivity, aqueous solubility and vapor pressure. The alternate relationship for the property P of a molecule that is to be predicted is defined as follows:

$$P = \frac{S \cdot {( {L}_{W} )}^{X}}{{( VP )}^{Y}}$$

where S is selectivity, L_{W} is aqueous solubility of the compound, VP is vapor pressure of the compound, and X and Y are exponent values which may take values from the set {0.5, 1, 2}. The choice of such a combined property was directed by the requirement that the prospective absorbents should have, apart to from a good selectivity, also high water solubility and low volatility.

The invention includes the following steps:
Define a set of descriptive parameters (descriptors) to use in the Quantitative Structure-Property Relationship (QSPR),
Define a set of known molecules with known selectivity (and aqueous solubility and vapor pressure if using the alternate relationship for P),
Either manually or via computational software calculate the value of each descriptor for each of the known molecules,
Use either the Whole Molecule Approach or the Molecular Fragment Approach to generate a list of molecules that have strongly correlated likelihood of being useful as H₂S absorbents,
The Whole Molecule Approach or the Molecular Fragment Approach are described in detail below.

### BRIEF DESCRIPTION OF THE DRAWINGS

FIG. 1 is a flow diagram of the steps of the present invention.

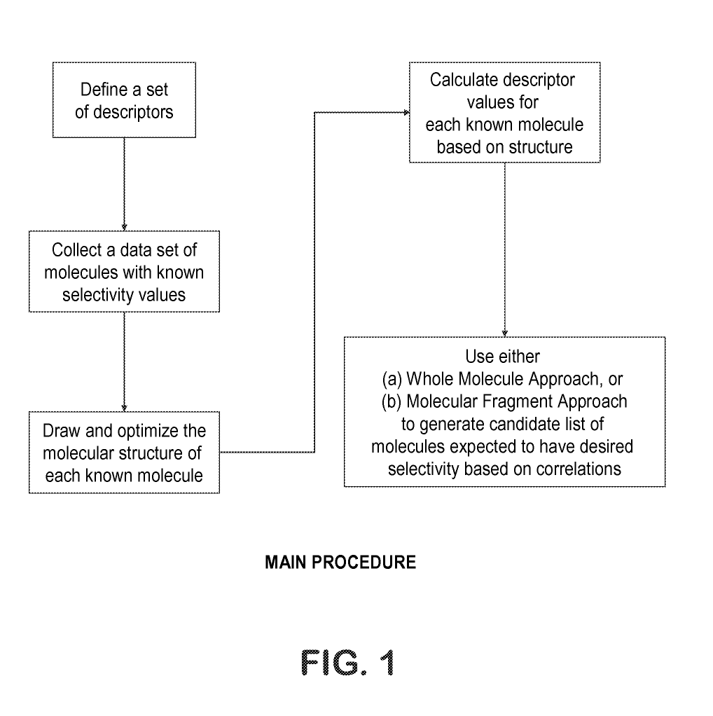

FIG. 2 is a flow diagram of the steps of the whole molecule approach.

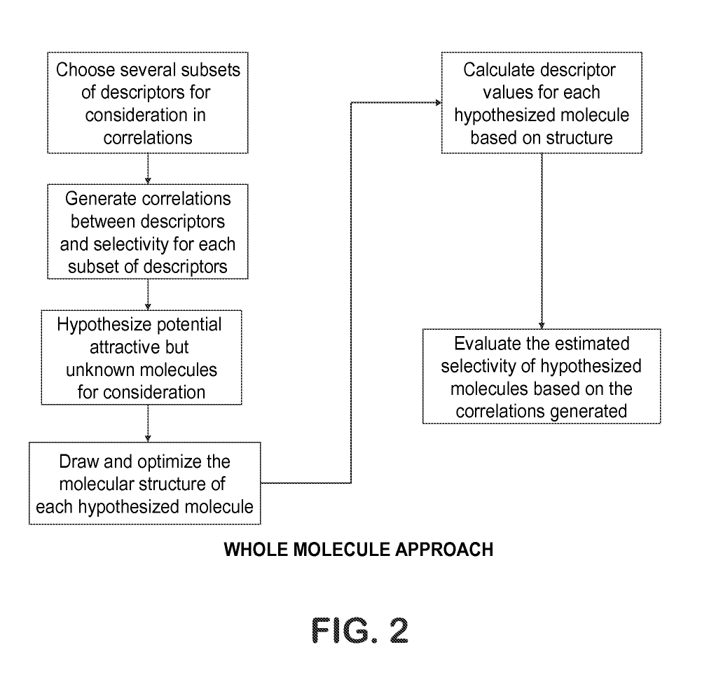

FIG. 3 is a flow diagram of the steps of the molecular fragment approach.

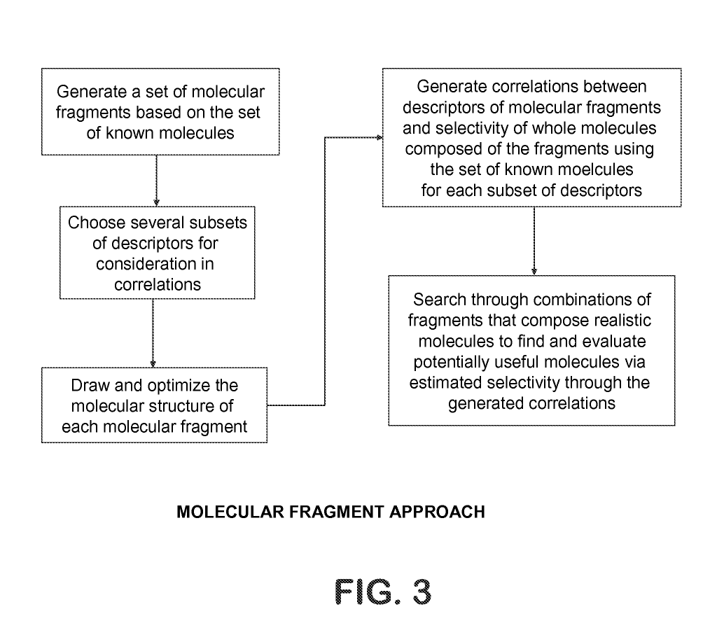

FIG. 4 shows number of parameters (n) plotted vs. R2 (▴) and R2cv () values.

FIG. 5 shows plot of observed vs. predicted logarithmic vapor pressure values.

FIG. 6 shows plot of observed vs. predicted combined property using Model #1.

FIG. 7 shows plot of observed vs. predicted combined property using Model #2.

FIG. 8 shows plot of observed vs. predicted combined property using Model #3.

FIG. 9 shows plot of observed vs. predicted combined property using Model #4.

FIG. 10 shows lot of observed vs. predicted combined property using Model #5.

FIG. 11 shows plot of observed vs. predicted combined property using Model #6.

FIG. 12 shows plot of observed vs. predicted combined property using Model #7.

FIG. 13 shows plot of observed vs. predicted combined property using Model #8.

### DETAILED DESCRIPTION OF THE PREFERRED EMBODIMENTS

The invention includes a method for generating and/or identifying molecules with respect to some molecular property via predictive correlations. In the present invention the molecular property is selectivity or a newly defined property which combines selectivity, aqueous solubility and vapor pressure for finding H₂S absorbents. The predictive correlations are found via Quantitative Structure-Property Relationships (OSPR), which is the process by which chemical structure is quantitatively correlated with a well defined process with measurable and reproducible parameters. The main goals of the invention are (i) to correlate experimental H₂S vs CO₂ selectivity values for series of postulated absorbents with theoretical molecular descriptors, by developing QSPR models, and (ii) to predict new active compounds with better selectivity than known so far and (iii) to identify structural characteristics with significant influence on the selectivity.

This is achieved by either the whole molecule approach or molecular fragment approach.

Descriptive parameters (descriptors) must be chosen to use in QSPR. Descriptors may be chosen using commercial software packages. Alternately, descriptions may be chosen based on the numerous published papers on QSPR. A list of descriptors is given in Appendix 8.

There are a huge variety of programs for QSPR/QSAR analysis. However, most of those are not interchangeable/equivalent: the programs developed especially for performing QSAR analysis are focused mainly on the description of the ligand-receptor interactions, while those devoted to QSPR rely on a huge descriptor space and advanced variable selection techniques. All programs for optimization of the chemical structure (and even those used only for structure drawing) provide some rudimentary tools for descriptor calculations.

HyperChem and ChemDraw are good examples of programs to optimize chemical structures. Programs able to perform QSPR analysis on technological properties, together with links to them are listed below with a short description of their advantages and disadvantages:

### Dragon

http://www.talete.mi.it/help/dragon_help/index.html?IntroducingDRAGON
DRAGON calculates more than 1,600 descriptors, but completely lacks any form of statistical calculations, so programs such as Statistica or Systat would be necessary.

### Molgen-QSPR

http://www.molgen.de/?src=documents/molgenqspr.html
MOLGEN calculates about 700 arithmetical, topological and geometrical descriptors (but not quantum-mechanical) and in addition includes some basic statistical methods.

### Preclav (PRoperty Evaluation by CLAss Variables)

http://www.softpedia.com/get/Science-CAD/PRECLAV.shtml
Calculates about 1100 global, local and grid/field descriptors but analyzes a maximum of 500 molecules split into training and test subsets. Selects Is descriptors using only R² and Class functions, which is a way too limited approach.

### Topix

http://www.lohninger.com/topix.html
   This program calculates a set of about 130 topological and structural descriptors.

Some general reviews of CODESSA applications include:
(i) A. R. Katritzky, M. Karelson, U. Maran, Y. Wang Collect. Czech. Chem. Commun., 1999, 64, 1551.
(ii) A. R. Katritzky, U. Maran, V. S. Lobanov, M. Karelson J. Chem. Inf. Comput. Sci., 2000 40, 1.
(iii) A. R. Katritzky, D. Fara, R. Petrukhin, D. Tatham, U. Maran, A. Lomaka, M. Karelson Curr. Top. Med. Chem., 2002, 2, 1333

### Whole Molecule Approach

Given the set of known molecules and the complete set of descriptors under consideration, a smaller subset of the descriptors is chosen for inclusion in correlations that will be developed to assess unknown molecules in the prediction of selectivity (P). The selection of descriptor values for inclusion in a particular correlation equation can be done in a number of ways based on statistical criteria. The selectivity (P data) for the known molecules is fit to a posed equation for relating the chosen subset of descriptor values to selectivity to (P). This fitting can be done via linear regression or other computational methods.

Once one or more correlation equations have been generated that relate selectivity P to descriptor values, the procedure is as follows:
1. Pose one or more potential unknown molecules to consider as candidates
2. Draw these molecules and either manually or computationally predict their descriptors values.
3. Input the predicted descriptor values for the unknown molecules into the correlation equation(s) and estimate potential selectivity P.

### Molecular Fragment Approach

Given the set of known molecules, create two or more sets of molecular fragments which may be combined to form potential absorbent molecules. Molecular fragments should be based on molecular fragments that are present in the known molecules such that the known molecules can be reconstructed using these molecular fragments and any rules developed for how to combine fragments into molecules.

Draw the protonated versions of each of the molecular fragments and either manually or computationally calculate the values for their molecular descriptors for all descriptors in the given complete set of descriptors.

Screen the set of all molecular descriptors for those that are common among all known molecules with known data for selectivity, vapor pressure and solubility. Then classify each descriptor in some scheme in order to designate how it will be treated in the predictive correlations when molecular fragments are combined to form molecules. Some methodology should then be used to decide on a subset of descriptors for inclusion in the predictive correlation.

The selectivity or P data for the known molecules formed by their substituent molecular fragments is fit to a posed equation for relating the chosen subset of descriptor values to selectivity or P for molecules composed of molecular fragments. This fitting can be done via linear regression or other computational methods.

Finally, promising molecules are found by searching for the molecules composed of molecular fragments with the highest value of P (or selectivity) predicted from the correlation equation(s). This search can be conducted with some form of enumeration of combinations of molecular fragments or a search algorithm.

The algorithm necessary to carry out the Whole Molecule and Molecular Fragment approaches is given in Appendix 7.

### EXAMPLES

Examples presented are meant to be non-limiting.

### Example 1

### Whole Molecule Approach: Models, Predictions

To carry out Quantitative Structure Property Relationships (QSPR) analysis for H₂S selectivity of potential absorbent molecules, experimental selectivity data for 33 absorbents (Appendix A1) at CO₂/H₂S loadings of 0.1, 0.2, 0.3 and 0.4 were used and four model-sets (Table 1-4) with common descriptors were developed (Table 5 for all loadings). Statistical parameters are acceptable for all models. The H₂S selectivity values for a total of 67 (including isomers) new possible absorbents (Appendix 2) chosen using the physicochemical meaning of the theoretical molecular descriptors from model-sets #1-4 (Table 1-4) were also predicted.

TABLE 1
4-parameter models with descriptors D2, D27, D32 and/or D37

| | | | | |
|---|---|---|---|---|
| Loading | QSPR Models | R² | R²cv | s |

Set #1 with D2, D27, D32 and D37

| | | | | |
|---|---|---|---|---|
| 0.1 | S = −2671.56 + 4.60(D27) − 1.28(D2) + 13.03(D32) + 46.73(D37) | 0.76 | 0.65 | 3.24 |
| 0.2 | S = −2536.67 + 2.94(D27) + 13.39(D32) + 8.71(D37) − 1.4(D2) | 0.64 | 0.45 | 3.43 |
| 0.3 | S = −2334.76 + 4.33(D27) − 1.34(D2) + 10.60(D32) + 68.95(D37) | 0.77 | 0.61 | 2.91 |
| 0.4 | S = −1907.9 + 4.19(D27) − 1.29(D2) + 86.19(D37) + 7.82(D32) | 0.87 | 0.77 | 1.74 |

TABLE 2
4-PARAMETER MODELS WITH DESCRIPTORS D2, D27, D32 AND D4

| | | | | |
|---|---|---|---|---|
| Loading | QSPR Models | R² | R²cv | s |

Set #2 with D2, D27, D32 and D4

| | | | | |
|---|---|---|---|---|
| 0.1 | S = −1963.68 + 4.26(D27) + 0.088(D4) + 10.52(D32) − 1.06(D2) | 0.78 | 0.68 | 3.13 |
| 0.2 | S = −2078.72 + 2.73(D27) + 11.15(D32) − 1.16(D2) + 0.092(D4) | 0.70 | 0.57 | 3.16 |
| 0.3 | S = −1913.68 + 3.60(D27) + 10.24(D32) + 0.078(D4) − 1.03(D2) | 0.74 | 0.60 | 3.07 |
| 0.4 | S = −1461.9 + 3.10(D27) + 0.089(D4) + 7.82(D32) − 0.90(D2) | 0.83 | 0.68 | 2.04 |

TABLE 3
4-PARAMETER MODELS WITH DESCRIPTORS D47, D50, D25 AND D21

| | | | | |
|---|---|---|---|---|
| Loading | QSPR Models | R² | R²cv | s |

Set #3 with D47, D50, D25 and D21

| | | | | |
|---|---|---|---|---|
| 0.1 | S = 481.46 − 0.25(D25) − 13.19(D47) − 0.071(D21) − 3.75(D50) | 0.80 | 0.71 | 2.95 |
| 0.2 | S = 440.80 − 3.15(D50) − 0.16(D21) − 0.28(D25) − 8.02(D47) | 0.80 | 0.70 | 2.57 |
| 0.3 | S = 446.21 − 0.25(D25) − 3.21(D50) − 0.14(D21) − 8.11(D47) | 0.73 | 0.54 | 3.16 |
| 0.4 | S = 578.11 − 3.85(D50) − 0.11(D21) − 0.16(D25) − 5.29(D47) | 0.75 | 0.48 | 2.45 |

TABLE 4
4-PARAMETER MODELS WITH DESCRIPTORS D20, D24, D27 AND D42

| | | | | |
|---|---|---|---|---|
| Loading | QSPR Models | R² | R²cv | s |

Set #4 with D20, D24, D27 and D42

| | | | | |
|---|---|---|---|---|
| 0.1 | S = 12.43 + 4.51(D42) − 0.15(D20) − 172.79(D24) + 6.42(D27) | 0.68 | 0.51 | 3.70 |
| 0.2 | S = 21.92 − 653.62(D24) − 0.20(D20) + 6.09(D27) + 3.60(D42) | 0.57 | 0.29 | 3.75 |
| 0.3 | S = 12.07 + 7.14(D27) − 0.18(D20) + 3.21(D42) − 386.31(D24) | 0.64 | 0.41 | 3.66 |
| 0.4 | S = 4.48 + 6.76(D27) − 0.15(D20) + 2.14(D42) − 163.23(24) | 0.64 | 0.25 | 2.96 |

TABLE 5
DESCRIPTORS INVOLVED IN 4-PARAMETER MODELS FOR
LOADING 0.1, 0.2, 0.3 AND 0.4 AFTER SELECTIONS.

| Symbol | Descriptor name |
|---|---|
| D2 | Kier flexibility index |
| D4 | Lowest normal mode vib frequency |
| D20 | Tot molecular electrostatic interaction |
| D21 | (½) X BETA polarizability (DIP) |
| D24 | HA dependent HDCA-1/TMSA (Zefirov PC) |
| D25 | HA dependent HDSA-1 (Zefirov PC) |
| D27 | Kier&Hall index (order 2) |
| D32 | Min atomic state energy for atom N |
| D37 | Min energy for bond H—C |
| D42 | Number of rings |
| D47 | Tot molecular 2-center resonance energy |
| D50 | Min n-n repulsion for bond C—N |

### SUMMARY OF THE PREDICTIONS

Model-sets #1 and #2 (Table 1-2) were derived by a similar method: only one descriptor differs in the model-sets. Also, the statistical parameters are quite similar. Experimental selectivity values decrease as the loading increases. However, using the model-set #1 for prediction, in 21 cases the selectivity values are higher in loading 0.3 than in loading 0.2, which is not realistic. Comparison of the models in set # 1 (Table 1) reveals that in models for loadings 0.3 and 0.4, the positive descriptor's coefficient for the descriptor D37 (min. exchange energy for bond H—C) is considerably higher than in respective models for loadings 0.1 and 0.2.

The most realistic results were obtained with the model-set #2 (Table 2) where there are only 9 cases when the selectivity values are higher in loading 0.3 than in loading 0.2 (Table 6).

TABLE 6
PREDICTED H₂S SELECTIVITIES WITH 4-PARAMETER MODELS BY
USING DESCRIPTIONS D2, D27, D32 AND D4 (MODEL-SET #2).

| Structure ID* | IUPAC name | 0.1 | 0.2 | 0.3 | 0.4 |
|---|---|---|---|---|---|
| S0000034 (c) | [2,2′]Bipyrrolidinyl | 19.95 | 17.24 | 18.26 | 12.70 |
| S0000035 (dd) | 2-(pyrrolidin-2-ylmethyl)pyrrolidine | 21.58 | 18.17 | 16.77 | 14.22 |
| S0000036 (c) | [2,3′]Bipyrrolidinyl | 21.21 | 17.46 | 16.59 | 13.10 |
| S0000037 (dd) | (5-Hydroxymethyl-pyrrolidin-2-yl)-methanol | 15.30 | 14.11 | 12.82 | 9.61 |
| S0000038 (dl) | (5-Hydroxymethyl-pyrrolidin-2-yl)-methanol | 14.46 | 13.00 | 10.61 | 8.96 |
| S0000039 | 2-Piperazin-1-yl-ethanol | 10.18 | 8.80 | 6.54 | 5.81 |
| S0000040 | Butyl-pyrrolidin-2-yl-amine | 15.37 | 11.67 | 9.22 | 9.72 |
| S0000041 (dd) | 3-(pyrrolidin-3-ylmethyl)pyrrolidine | 21.90 | 18.27 | 17.96 | 14.15 |
| S0000042 (c) | Octahydro-pyrrolo[3,2-b]pyrrole | 19.52 | 18.04 | 15.31 | 13.24 |
| S0000043 (t) | Octahydro-pyrrolo[3,2-b]pyrrole | 26.40 | 17.86 | 21.39 | 20.35 |
| S0000044 (c) | 1,1′-Dimethyl-[2,2′]bipyrrolidinyl | 21.15 | 14.97 | 14.37 | 13.62 |
| S0000045 (dl) | 1-methyl-2-[(1-methylpyrrolidin- | 21.36 | 16.21 | 16.02 | 13.97 |
| | 2yl)methyl]pyrrolidine | | | | |
| S0000046 (c) | 1,1′-Dimethyl-[2,3′]bipyrrolidinyl | 21.61 | 18.72 | 17.88 | 16.05 |
| S0000047 (dd) | (5-Hydroxymethyl-1-methyl-pyrrolidin-2-yl)- | 14.52 | 11.86 | 10.02 | 8.66 |
| | methanol | | | | |
| S0000048 (dl) | (5-Hydroxymethyl-1-methyl-pyrrolidin-2-yl)- | 14.32 | 12.09 | 10.16 | 9.11 |
| | methanol | | | | |
| S0000049 | 2-(4-Methyl-piperazin-1-yl)-ethanol | 13.93 | 11.71 | 9.68 | 9.13 |
| S0000050 | Butyl-methyl-pyrrolidin-2-yl)-amine | 16.54 | 12.86 | 12.03 | 9.98 |
| S0000051 (dl) | 1-methyl-3-[(1-methylpyrrolidine-3- | 25.28 | 19.20 | 18.37 | 15.55 |
| | yl)methyl]pyrrolidine | | | | |
| S0000052 (c) | 1,4-Dimethyl-octahydro-pyrrolo[3,2-b]pyrrole | 17.44 | 14.11 | 12.87 | 11.20 |
| S0000053 (t) | 1,4-Dimethyl-octahydro-pyrrolo[3,2-b]pyrrole | 23.42 | 19.81 | 17.84 | 16.23 |
| S0000054 (c) | Decahydro-[1,5]naphthyridine | 18.21 | 24.47 | 13.60 | 12.31 |
| S0000055 (t) | Decahydro-[1,5]naphthyridine | 19.01 | 16.20 | 14.39 | 12.83 |
| S0000056 (c) | Octahydro-pyrrolo[3,4-c]pyrrole | 21.38 | 19.75 | 16.94 | 14.97 |
| S0000057 (t) | Octahydro-pyrrolo[3,4-c]pyrrole | 31.30 | 30.33 | 26.10 | 24.35 |
| S0000058 (c) | Decahydro-[2,6]naphthyridine | 18.95 | 16.00 | 14.29 | 12.80 |
| S0000059 (t) | Decahydro-[2,6]naphthyridine | 17.47 | 14.42 | 12.97 | 11.24 |
| S0000060 | 2-Pyrazolidin-1-yl-ethanol | 16.34 | 13.81 | 12.25 | 11.13 |
| S0000061 | Methyl-(2-pyrazolidin-1-yl-ethyl)-amine | 10.61 | 10.85 | 8.50 | 5.50 |
| S0000062 | 2-Azetidin-1-yl-ethanol | 17.05 | 16.82 | 13.46 | 11.05 |
| S0000063 (dd) | (4-Hydroxymethyl-azetidin-2-yl)-methanol | 19.49 | 18.96 | 15.71 | 12.76 |
| S0000064 (dl) | (4-Hydroxymethyl-azetidin-2-yl)-methanol | 20.71 | 20.24 | 16.76 | 14.13 |
| S0000065 (c, c, c) | Tetradecahydro-phenazine | 25.64 | 19.64 | 19.22 | 17.80 |
| S0000066 (t, c, t) | Tetradecahydro-phenazine | 24.69 | 18.80 | 19.01 | 16.36 |
| S0000067 (c) | 2,5-Dimethyl-octahydro-pyrrolo[3,4-c]pyrrole | 21.27 | 17.64 | 16.38 | 14.20 |
| S0000068 (t) | 2,5-Dimethyl-octahydro-pyrrolo[3,4-c]pyrrole | 24.83 | 21.42 | 19.62 | 17.14 |
| S0000069 (c) | 2,6-Dimethyl-decahydro-[2,6]naphthyridine | 25.40 | 19.35 | 19.63 | 17.10 |
| S0000070 | 2-(2-Methyl-pyrazolidin-1-yl)-ethanol | 16.83 | 16.14 | 14.66 | 10.77 |
| S0000071 | Dimethyl-[2-(2-methyl-pyrazolidin-1-yl)-ethyl]- | 17.39 | 9.88 | 9.08 | 8.24 |
| | amine | | | | |
| S0000072 | 1-Methyl-azetidine | 24.50 | 25.17 | 20.22 | 18.87 |
| S0000073 (dd) | (4-Hydroxymethyl-1-methy l-azetidin-2-yl)- | 21.91 | 20.75 | 17.62 | 15.18 |
| | methanol | | | | |
| S0000074 (dl) | (4-Hydroxymethyl-1-methyl-azetidin-2-yl)- | 20.52 | 19.28 | 16.03 | 13.98 |
| | methanol | | | | |
| S0000075 (t, c, t) | 5,10-Dimethyl-tetradecahydro-phenazine | 25.06 | 17.68 | 18.90 | 16.56 |
| S0000076 (c, c, c) | 5,10-Dimethyl-tetradecahydro-phenazine | 27.42 | 20.56 | 21.07 | 17.44 |
| S0000077 | 2-Imidazolidin-1-yl-ethanol | 14.36 | 13.80 | 10.79 | 8.97 |
| S0000078 | 2-(2-Dimethylamino-ethoxy)-ethanol | 5.31 | 3.83 | 1.87 | 1.95 |
| S0000079 | 2-(2-Pyrrolidin-1-yl-ethoxy)-ethylamine | 12.91 | 10.49 | 8.86 | 7.57 |
| S0000080 (dl) | 9,10-Diaza-tricyclo[4.2.1.1-2,5]decane | 43.01 | 40.54 | 36.15 | 34.87 |
| S0000081 (dl) | (6-Hydroxymethyl-1-methyl-piperidin-2-yl)- | 14.89 | 12.05 | 10.53 | 9.39 |
| | methanol | | | | |

Predicted H₂S selectivity values for the additional isomers. Original structure ID is given in parentheses.

| | | | | | |
|---|---|---|---|---|---|
| S0000082 (34, t) | [2,2′]Bipyrrolidinyl | 20.60 | 17.90 | 15.98 | 13.89 |
| S0000083 (35, dl) | 2-(pyrrolidin-2-ylmethyl)pyrrolidine | 22.96 | 19.64 | 18.09 | 15.41 |
| S0000084 (36, t) | [2,3′]Bipyrrolidinyl | 21.81 | 19.09 | 17.12 | 14.81 |
| S0000085 (41, dl) | 3-(pyrrolidin-3-ylmethyl)pyrrolidine | 23.35 | 19.82 | 18.35 | 15.86 |
| S0000086 (44, t) | 1,1′-Dimethyl-[2,2′]bipyrrolidinyl | 20.86 | 16.43 | 15.77 | 13.70 |
| S0000087 (45, dd) | 1-methyl-2-[(1-methylpyrrolidin- | 21.89 | 16.78 | 16.59 | 14.27 |
| | 2yl)methyl]pyrrolidine | | | | |
| S0000088 (46, t) | 1,1′-Diraethyl-[2,3′]bipyrrolidinyl | 21.49 | 16.89 | 16.37 | 14.01 |
| S0000089 (51, dd) | 1-methyl-3-[(1-methylpyrrolidine-3- | 23.82 | 18.33 | 18.31 | 15.68 |
| | yl)methyl]pyrrolidine | | | | |
| S0000090 (65, c, t, t,) | Tetradecahydro-phenazine | 26.72 | 20.93 | 20.83 | 18.39 |
| S0000091 (65, t, t, c) | Tetradecahydro-phenazine | 24.71 | 18.81 | 18.97 | 16.55 |
| S0000092 (65, c, t, c) | Tetradecahydro-phenazine | 25.20 | 19.34 | 19.51 | 16.75 |
| S0000094 (69, t) | 2,6-Dimethyl-decahydro-[2,6]naphthyridine | 23.65 | 18.91 | 18.05 | 16.73 |
| S0000095 (75, c, t, t) | 5,10-Dimethyl-tetradecahydro-phenazine | 29.14 | 21.97 | 22.72 | 20.04 |
| S0000096 (75, t, t, c) | 5,10-Dimethyl-tetradecahydro-phenazine | 26.71 | 19.39 | 20.32 | 18.34 |
| S0000097 (75, c, t, c) | 5,10-Dimethyl-tetradecahydro-phenazine | 27.44 | 20.17 | 21.06 | 18.77 |
| S0000099 (80, dd) | 9,10-Diaza-tricyclo[4.2.1.1-2,5]decane | 30.57 | 27.55 | 25.18 | 22.07 |
| S0000100 (81, dd) | (6-Hydroxymethyl-1-methyl-piperidin-2-yl)- | 13.60 | 10.68 | 9.29 | 8.38 |
| | methanol | | | | |

Table 3) for the prediction of selectivities, 6 structures were found for which the selectivity is higher in loading 0.3 than in loading 0.2 and 11 structures for which the selectivity is higher in loading 0.4 than in loading 0.3.

Using the model-set #4 (Table 4) for the prediction, in 5 cases the selectivity is higher in loading 0.3 than in loading 0.2 and in 9 cases the selectivity is higher in loading 0.4 than in loading 0.3.

Those numbers were derived by taking into account all the structures, including the large number of possible geometric isomeric forms (from 50000034 to S0000100).

Because of its low statistical reliability, model-set #4 was omitted from further consideration. Looking at the structures, which are giving higher selectivity for higher loadings in model-sets #1 and 2, it becomes evident that none of the “problematic” structures contain an 0-H group, with the sole exception of S0000078, which gives a small selectivity increase in loading 0.4 with model-set #2.

### Example 2

### Molecular Fragment Approach: Approach, Fragments, New Properties Included, Models, Predictions

Ten of the most promising sets containing 4 descriptors each were selected with which to develop performance models, and these were built and added to the four previously built (Example 1).
1. Two heuristic methods proposed in the literature: (i) a “macros structures and fragment descriptors library” based BESTREG methodology (Karelson's approach), [Katritzky, A. R.; Lobanov, V. S.; Karelson, M.; Murugan, R.; Grenoze, M. P.; Toomey, J. E.; Rev. Roum. Chem. 1996, 41, 851-867.]
2. and (ii) a “substructural molecular fragments” method (Varnek's approach) [Solove, A.; Varnek, G.; Wipff, G. J. Chem. Inf. Comp. Sci. 2001, 40, 847-858.

Briefly, according to the Karelson approach, the molecules in a model set can be divided into distinct fragments as follows:

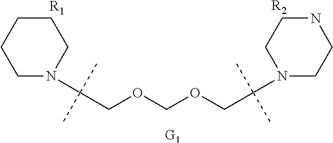

with a generic structure component G₁ and the two substituent group components R₁ and R₂. One or two components may be missing.

The strategy for the development of new molecular structures with the best-pre-determined (maximum) logS, instead of selectivity values, involved the following steps:
1. the development of QSPR between the property of interest and theoretical molecular descriptors, which consists of three different approaches: multilinear, with whole molecule descriptors, nonlinear (cross-terms), with fragmental descriptors, and neural network, with both molecule and fragment descriptors; in all cases two parameterizations were to be used: the classical Austin Method 1 (AM 1) and a modified version of that, AM1-LIQ, which describes the molecular electronic structure in the condensed (liquid) phase (a new and undergoing testing routine for refining the structures geometry and descriptors calculation newly implemented in CODESSA PRO software). Different sets of models were obtained as follows:

logS=F(Dᵢ) (a)

logS=f(dᵢ) (b)
where Dᵢ are the whole molecular descriptors and dᵢ denote the fragment descriptors. Previous experience indicates that the descriptors for molecules R₁H, R₂H, and HG₁H are also suitable for the development of relationship (b).
2. the generation of the possible substituents/fragments (Rᵢ) and generic bridge structures databases (Gₖ);
3. the calculation of the fragment descriptors as the molecular descriptors for RᵢH, and HGₖH by using CODESSA PRO;
4. the prediction of the logS values for all combinations of Rᵢ and Gₖ and the selection of the best candidates with the highest property value by a fast screening of up to 1,300,000 . . . 9,000,000 possible structures;
5. the full molecule descriptor calculations for the selected structures built from molecular fragments and having the highest target property values and chemically viable structure;
6. the target property (logS) values for those molecules are predicted using models with the whole molecular descriptors and 50 . . . 100 structures were proposed as the most probable candidates for new absorbent compounds.
7. the validation of the predictions was carried out where one or few molecules are left out in the first step of model development. However, the respective necessary structures were included in the fragment database and the predictions of logS made for them. The quality of these predictions also reflects the quality of predictions for new compounds.

It needs to be noted that the experimental data set is small (only 33 absorbents), therefore, only general information about the influence of various fragments were obtained. However, the preparation and testing of new molecule entities (predicted in step 6 above) provided feedback for refinement of the models.

### Library of Possible Fragments

A fragment database of possible substituents Rᵢ (125) and generic bridge structures Gₖ (94) were created and are given in Appendix 3 (list of substituents) and Appendix 4 (list of generic structures). Calculation of the fragment descriptors using CODESSA PRO (as the molecular descriptors for RᵢH, and HGₖH) was carried out for these 125 possible substituents and generic structures. The corresponding Codessa Pro storage was then prepared for further calculations.

Later, a reoptimization of the molecular geometries, and elimination of those fragments that contain the following sequence refined the library of substituents and generic bridges:

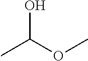

To this point, the database consisted of 116 substituent group components and 73 generic bridge components (Appendix 3 and Appendix 4). The theoretical molecular descriptors were recalculated for all the fragments (RᵢH, HGH) and for the original 33 absorbents.

New Property with Solubility and Vapor Pressure

To be effective, absorbents should have a high solubility and low volatility. Therefore, a new property for the absorbents in which the solubilities (aqueous) and volatilities of the absorbents have been taken into account was defined. The properties were calculated as shown in Eq. 1 and the respective values are listed in Table 7.

Pₙ=log (selectivity*solubility/vapor pressure), n=0.1-0.4 (1)

TABLE 7
COMBINED PROPERTY VALUE (P_{N}) THAT
INCLUDE VOLATILITY AND SOLUBILITY

| ID | P01 | P02 | P03 | P04 |
|---|---|---|---|---|
| S0000001 | 8.867989 | 8.815189 | 8.768145 | 8.735677 |
| S0000002 | 8.912114 | 8.818693 | 8.705184 | 8.499934 |
| S0000003 | 8.753321 | 8.539442 | 8.317593 | |
| S0000004 | 7.419924 | 7.354107 | 7.257197 | 7.215804 |
| S0000005 | 11.71337 | 11.68299 | 11.63653 | 11.61129 |
| S0000006 | 6.229996 | 6.158444 | 6.095797 | 5.955618 |
| S0000007 | 8.240558 | 8.232871 | 8.217076 | 8.232871 |
| S0000008 | 9.938983 | 9.854307 | 9.762271 | 9.635464 |
| S0000009 | 9.134192 | 9.051782 | 8.924677 | 8.750752 |
| S0000010 | 7.060495 | 7.009342 | 6.918422 | 6.809065 |
| S0000011 | 7.912623 | 7.821922 | 7.745533 | 7.672983 |
| S0000012 | 7.969175 | 7.931387 | 7.923418 | 7.889994 |
| 80000013 | 8.484107 | 8.437025 | 8.409659 | 8.376659 |
| S0000014 | 8.01086 | 7.969729 | 7.93688 | 7.862634 |
| S0000015 | 8.35725 | 8.328761 | 8.14054 | 7.989273 |
| S0000016 | 7.941058 | 7.915752 | 7.906978 | 7.840031 |
| S0000017 | 10.70411 | 10.31716 | 9.766255 | |
| S0000018 | | 7.53519 | 7.488334 | 7.429556 |
| S0000019 | 8.938036 | 8.703541 | 8.190423 | |
| S0000020 | 8.424798 | 8.408711 | 8.374631 | 8.2755 |
| S0000021 | | 8.006266 | 7.863304 | 7.782649 |
| S0000022 | 11.24141 | 10.2994 | | |
| S0000023 | 7.077884 | 7.027431 | 6.94825 | 6.85134 |
| S0000024 | 8.91717 | 8.83081 | 8.77857 | 8.675908 |
| S0000025 | 7.481797 | 7.412916 | 7.32274 | 7.331012 |
| S0000026 | 13.62053 | | | |
| S0000027 | 10.18385 | 9.823353 | | |
| S0000028 | | | 8.761295 | 8.741092 |
| S0000029 | 8.889408 | | | |
| S0000030 | 11.30921 | 11.18952 | 11.07558 | |
| S0000031 | 10.70648 | 10.50765 | | |
| S0000032 | | | 10.54847 | 10.42902 |
| S0000033 | 10.1171 | 9.982904 | 9.882234 | 9.821536 |

### Vapor Pressure

A preliminary collection of the vapor pressure values were assembled for 29 out of 33 initial absorbents calculated using Advanced Chemistry Development (ACD) Software Solaris V4.67 (Ó 1994-2004 ACD, http://www.acdlabs.com/) available under the SciFinder Scholar 2002 Software, http://www.cas.org/SCIFINDER. (see Table 8).

TABLE 8
COLLECTED AND CALCULATED VAPOR
PRESSURE AND SOLUBILITY DATA.

| | | | VP | LogVP | |
|---|---|---|---|---|---|
| Absorbent | VP (exp) | Log VP | (predicted, | (predicted, | Log L_{w} |
| ID | (25C/torr) | (exp) | Table 8) | Table 8) | (calc) |
| 1 | 6.81E−03 | −2.166853 | 0.012711 | −1.89582 | 5.22838 |
| 2 | 2.06E−03 | −2.686133 | 0.005253 | −2.27959 | 5.13256 |
| 3 | 5.98E−03 | −2.223299 | 0.005808 | −2.23599 | 5.57578 |
| 4 | 0.0936 | −1.028724 | 0.110257 | −0.957592 | 5.28399 |
| 5 | 9.25E−04 | −3.033858 | 0.000822 | −3.08492 | 7.50925 |
| 6 | 0.651 | −0.186419 | 0.938628 | −0.0275067 | 5.14595 |
| 7 | 0.0147 | −1.832683 | 0.014614 | −1.83523 | 5.35097 |
| 8 | 0.000605* | −3.21846* | 0.000605 | −3.21846 | 5.4777 |
| 9 | 3.98E−03 | −2.400117 | 0.003176 | −2.4981 | 5.52456 |
| 10 | 0.311 | −0.507240 | 0.14797 | −0.829827 | 5.34374 |
| 11 | 0.068055* | −1.16714* | 0.068055 | −1.16714 | 5.46445 |
| 12 | 0.0196 | −1.707744 | 0.016205 | −1.79035 | 5.18225 |
| 13 | 8.04E−03 | −2.094744 | 0.007751 | −2.11063 | 5.22501 |
| 14 | 0.0293 | −1.533132 | 0.049898 | −1.30192 | 5.25762 |
| 15 | 7.77E−03 | −2.109579 | 0.011654 | −1.93351 | 5.1473 |
| 16 | 0.023 | −1.638272 | 0.011358 | −1.94468 | 5.57851 |
| 17 | 4.31E−03 | −2.365523 | 0.009858 | −2.00623 | 7.44649 |
| 18 | 0.0459 | −1.338187 | 0.022247 | −1.65272 | 5.25252 |
| 19 | 5.98E−03 | −2.223299 | 0.00929 | −2.03197 | 5.53576 |
| 20 | 0.005956* | −2.22506* | 0.005956 | −2.22506 | 5.45939 |
| 21 | 0.0447 | −1.349692 | 0.039155 | −1.40721 | 5.44173 |
| 22 | 1.28E−03 | −2.892790 | 0.000731 | −3.13588 | 7.50352 |
| 23 | 0.332 | −0.478862 | 0.276523 | −0.558269 | 5.40869 |
| 24 | 0.0101 | −1.995679 | 0.008241 | −2.08403 | 5.65904 |
| 25 | 0.107 | −0.970616 | 0.085141 | −1.06986 | 5.33509 |
| 26 | 9.72E−08* | −7.01243* | 9.72E−08 | −7.01243 | 5.29013 |
| 27 | 1.14E−04 | −3.943095 | 8.62E−05 | −4.06444 | 4.91647 |
| 28 | 1.47E−03 | −2.832683 | 0.00114 | −2.94302 | 5.28516 |
| 29 | 3.39E−03 | −2.469800 | 0.003386 | −2.47029 | 5.05788 |
| 30 | 6.90E−06 | −5.161151 | 8.76E−06 | −5.05758 | 4.71031 |
| 31 | 1.11E−05 | −4.954677 | 1.28E−05 | −4.89408 | 4.58449 |
| 32 | 3.08E−04 | −3.511449 | 0.000306 | −3.51428 | 5.61872 |
| 33 | 1.98E−04 | −3.703335 | 0.000189 | −3.72412 | 5.03902 |

*Missing VP values calculated by using 4-parameter model in

Since the experimental vapor pressure values were missing for the 4 compounds (8, 11, 20 and 26) a QSPR model was built for their vapor pressures by using the 29 experimental values as a property and then to predict the missing values.

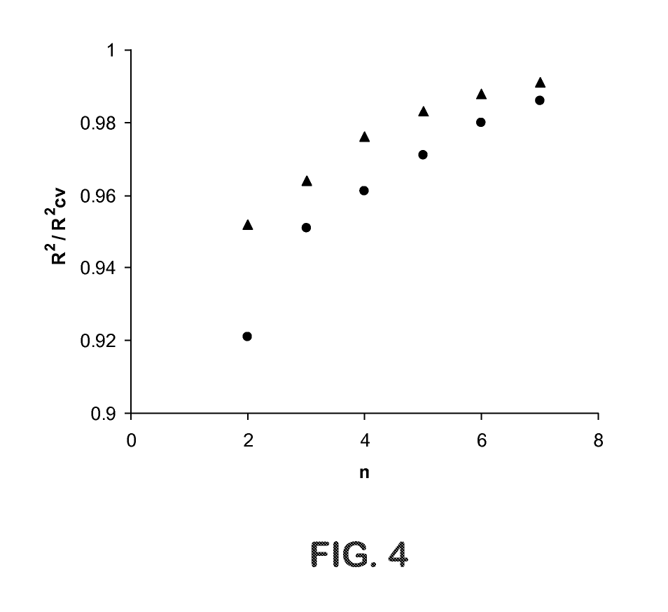

Multi-parameter correlations for the vapor pressure containing up to 7 descriptors were analyzed. FIG. 4 shows the relationships of R² and R²ₑᵥ with the number of descriptors. In order to avoid the “over-parameterization” of the model, an increase of the R² value of less than 0.01 was chosen as the breakpoint criterion.

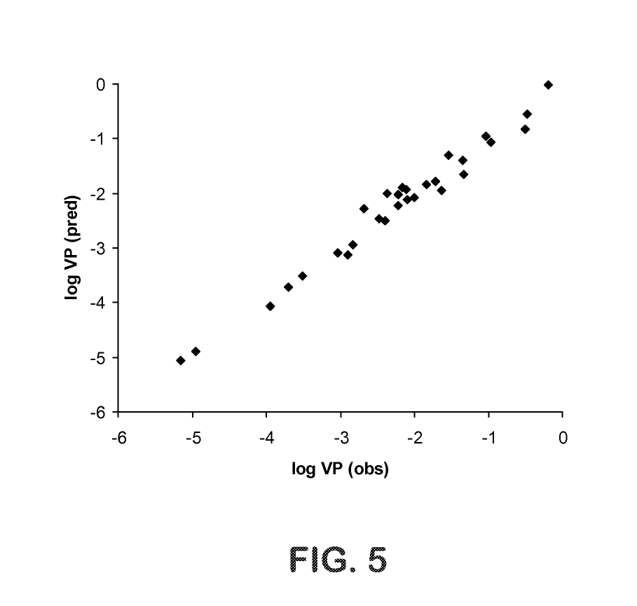

The logarithmic values of the vapor pressure were considered for developing a 4-parameter QSPR model that is given in Table 9; the respective plot of observed vs. predicted log VP values is presented in FIG. 5.

TABLE 9
4-PARAMETER QSPR MODEL FOR THE VAPOR PRESSURE (LOGARITHMIC VALUES).
R² = 0.976 R²_{cv} = 0.9612 F = 247.274 s² = 0.0401

| # | Coefficient | s | Descriptor |
|---|---|---|---|
| 0 | −36.639 | ±7.613 | Intercept |
| 1 | −0.861 | ±0.030 | Randic index (order 1) |
| 2 | −2.042 | ±0.351 | HA dependent HDCA-2 (Zefirov PC) |
| 3 | 46.878 | ±8.872 | Avg valency for atom H |
| 4 | 36.132 | ±9.310 | Relative number of N atoms |

In the case of logarithmic VP values, all data points showed a good fit on the scale (FIG. 5). Thus, log VP values for the missing structures were predicted and then the anti-logarithmic values were calculated. The respective VP values are presented in Table 8.

### Solubility

No available experimental solubility values for these 33 absorbents were found searching both SciFinder Scholar 2002 and the Sigma-Aldrich database. As an alternative, we studied the the Ostwald solubility coefficient.

The property (Pₙ) to be investigated by fragment descriptor based QSPR approach, is defined as follows (Equation 2):

$${P}_{n} = log \frac{S \cdot {L}_{W}^{X}}{{VP}^{Y}} , X = 1 , Y = 1 \qquad ( 2 )$$

where S denotes the selectivity of the compound to separate CO₂ and H₂S in the gas mixture, L_{W} is the aqueous solubility of the compound, VP is the vapor pressure of the compound, and X, Y are the exponents of solubility and vapor pressure, respectively.

Note: The solubility in water and vapor pressure are both “saturation” properties, i.e., they are measurements of the maximum capacity which a phase has for the dissolved compound in solution. Although water/air partition coefficients (L_{w}) are not constant over the whole concentration range in aqueous solution, here L_{w} means the water/air partition coefficient for a saturated solution. Parameter L_{w}, also named the Ostwald solubility coefficient, is defined as the ratio of the solubility of a compound in the aqueous solution to its equilibrium concentration in the gas phase (Eq. 2)

L_{w}=solubility of solute in aqueous solution/equilibrium conc. of solute in gas phase).

Experimental water solubility values were not found for the original absorbents. Thus, a 5-parameter QSPR model for the Ostwald solubility coefficients (L_{w},) that we developed was used (Table 10) by using 179 experimental values for log L_{w} values for absorbents considered are presented in

TABLE 10
Table 10 5-parameter model for the Ostwald solubility (log L_{w})
R² = 0.929 R²_{cv} = 0.923 F = 453.23 s² = 0.36 N = 179

| # | Coefficient | s | Descriptor |
|---|---|---|---|
| 0 | −0.416 | ±0.111 | Intercept |
| 1 | 1.848 | ±0.097 | count of H-acceptor |
| | | | sites (MOPAC PC) |
| 2 | −0.0078 | ±0.00048 | Difference (Pos − |
| | | | Neg) in Charged Surface |
| | | | Areas (MOPAC PC) |
| 3 | −16.280 | ±0.982 | Min partial charge |
| | | | (Zefirov) for all |
| | | | atom types |
| 4 | −0.172 | ±0.0147 | WNSA-3 Weighted PNSA |
| | | | (PNSA3*TMSA/1000) |
| | | | (MOPAC PC) |
| 5 | 0.182 | ±0.023 | Difference (Pos − |
| | | | Neg) in Charged |
| | | | Part of Charged Surface |
| | | | Area (Zefirov's PC) |

Those three properties (selectivity, vapor pressure and solubility coefficients) were then combined into one function (property) and then the respective QSPR models were calculated.

### The 2, 3- and 4-Parameter QSPR Models for the New Combined Property

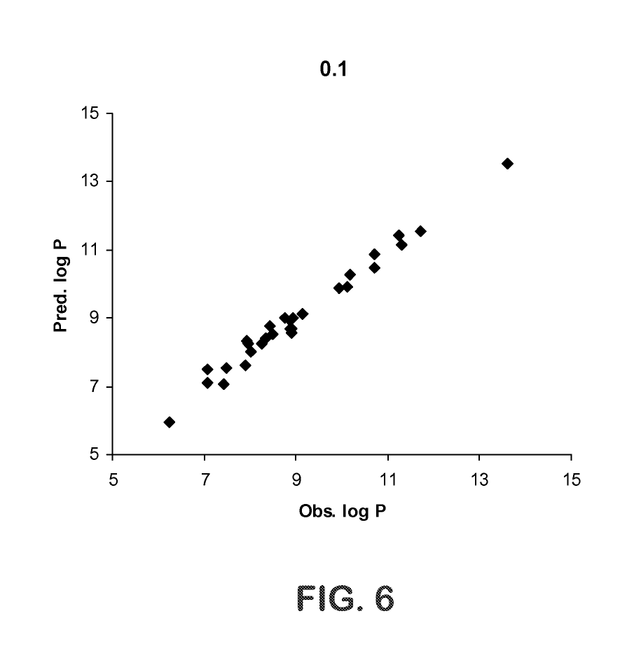

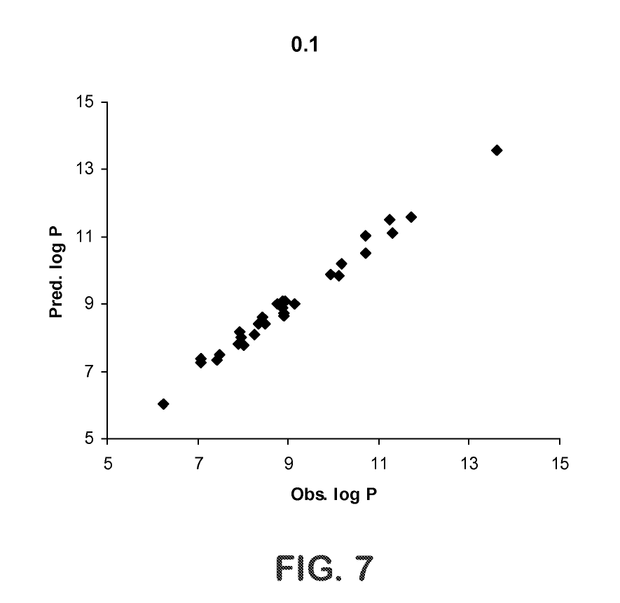

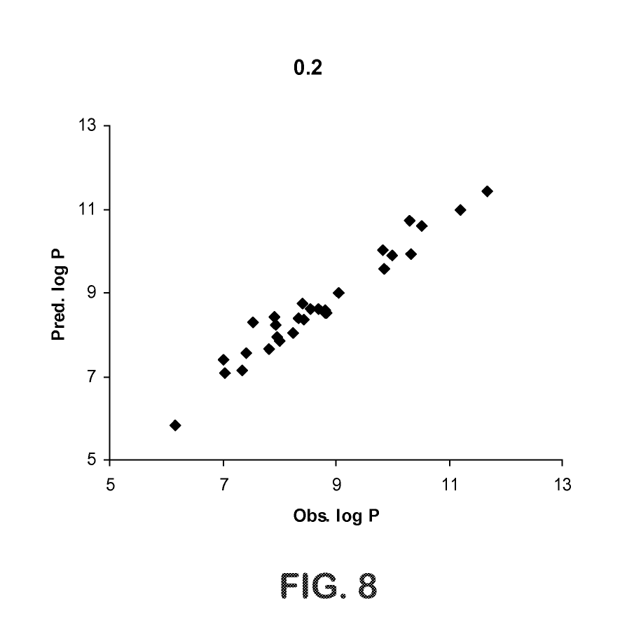

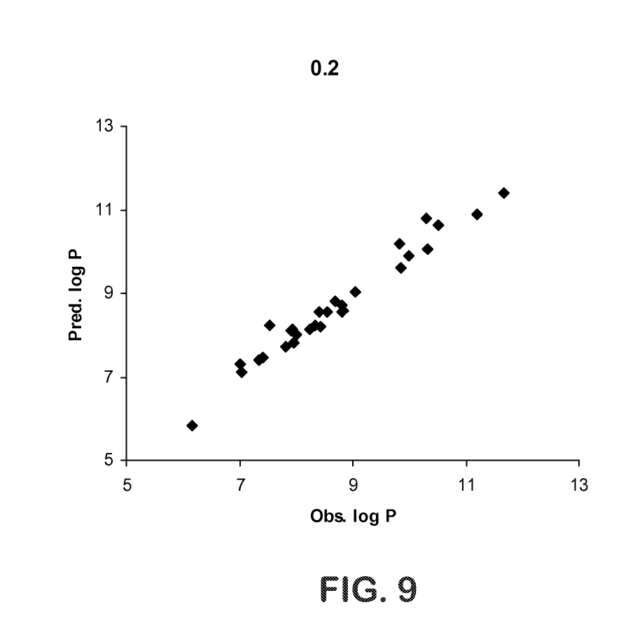

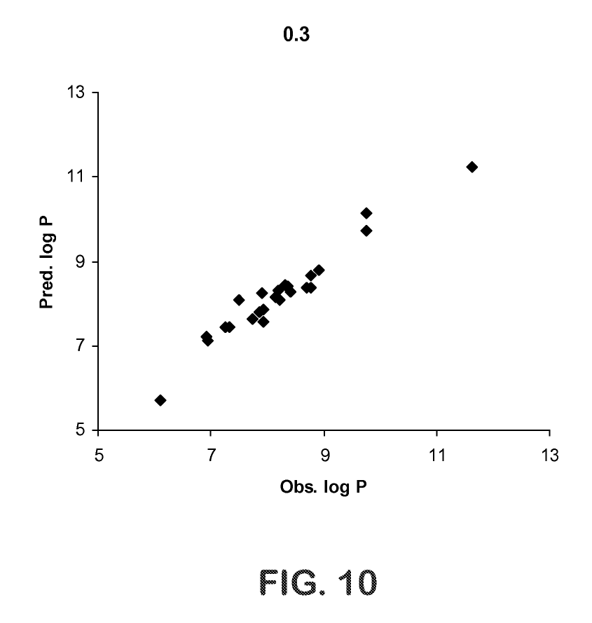

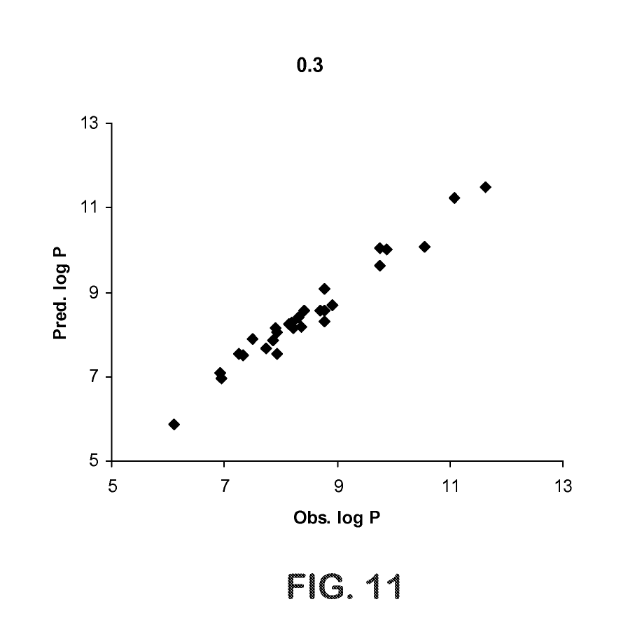

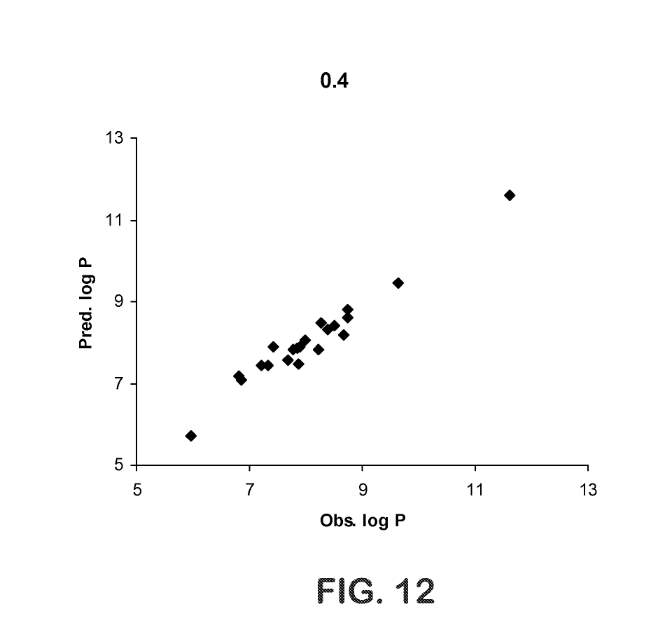

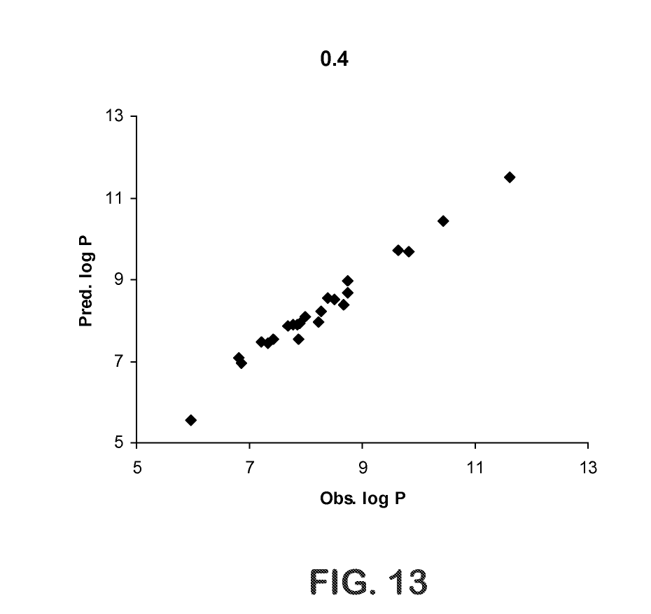

The squared correlation coefficient is better than 0.95 for all the 3-parameter models at all loadings. Next, the models with common descriptors for all loadings were built. Such a restriction is expected to decrease R², especially for the 3-parameter models. Therefore, 4-parameter models are also presented. The corresponding models (1-8) and plots (FIGS. 6-13) are presented below.

### Loading 0.1

### Model #1

N = 29 n = 3 R2 = 0.981683 R2cv = 0.975359 F = 446.608 s2 = 0.0544545

| # | B | s | t | IC | Name of descriptor |
|---|---|---|---|---|---|
| 0 | −6.59148 | 0.972 | −6.78136 | | Intercept |
| 1 | 57.1422 | 2.63918 | 21.6515 | 0.564213 | HA dependent HDCA-2/SQRT (TMSA) |
| | | | | | (MOPAC PC) |
| 2 | 0.00480489 | 0.000134279 | 35.7828 | 0.390934 | Tot molecular 1-center E-E repulsion |
| 3 | 19.3585 | 2.91326 | 6.64498 | 0.407954 | Relative number of C atoms Outliers are |
| | | | | | selected. Number of outliers is 0. |

### Model #2

N = 29 n = 4 R2 = 0.987012 R2cv = 0.9806 F = 455.964 s2 = 0.04022

| # | B | s | t | IC | Name of descriptor |
|---|---|---|---|---|---|
| 0 | 1.59462 | 0.378654 | 4.21128 | | Intercept |
| 1 | 2.99738 | 0.1154 | 25.9738 | 0.416669 | HA dependent HDCA-2 (MOPAC PC) |
| 2 | 0.00540985 | 0.000160308 | 33.7467 | 0.684367 | Tot molecular 1-center E-E repulsion |
| 3 | −0.0195707 | 0.002061 | −9.49569 | 0.536448 | Vib enthalpy (300 K)/natoms |
| 4 | 13.405 | 3.79494 | 3.53233 | 0.172955 | Partial Surface Area for atom C |
| | | | | | Outliers are selected. Number of |
| | | | | | outliers is 0. |

### Loading 0.2

### Model #3

N = 29 n = 3 R2 = 0.953015 R2cv = 0.935786 F = 169.028 s2 = 0.0909793

| # | B | s | t | IC | Name of descriptor |
|---|---|---|---|---|---|
| 0 | 17.2332 | 2.7802 | 6.19853 | | Intercept |
| 1 | 3.22789 | 0.182499 | 17.6872 | 0.362159 | FPSA-2 Fractional PPSA (PPSA- |
| | | | | | 2/TMSA) (MOPAC PC) |
| 2 | 2.61716 | 0.167724 | 15.6039 | 0.305762 | HA dependent HDCA-2 (MOPAC PC) |
| 3 | −27.2753 | 4.18602 | −6.5158 | 0.0971424 | Relative number of H atoms Outliers |
| | | | | | are selected. Number of outliers is 1, |

### Model #4

N = 29 n = 4 R2 = 0.963511 R2cv = 0.943558 F = 158.431 s2 = 0.0736004

| # | B | s | t | IC | Name of descriptor |
|---|---|---|---|---|---|
| 0 | −17.3062 | 2.20205 | −7.85913 | | Intercept |
| 1 | 3.25766 | 0.162223 | 20.0814 | 0.346946 | FPSA-2 Fractional PPSA (PPSA- |
| | | | | | 2/TMSA) (MOPAC PC) |
| 2 | 2.68545 | 0.158529 | 16.9398 | 0.371333 | HA dependent HDCA-2 (MOPAC PC) |
| 3 | 3.49391 | 0.458931 | 7.61315 | 0.114858 | Tot molecular electrostatic interaction |
| 4 | 47.9096 | 16.4862 | 2.90604 | 0.187615 | Square root of Partial Surface Area for |
| | | | | | atom C Outliers are selected. Number |
| | | | | | of outliers is 1. |

### Loading 0.3

### Model #5

N = 28 n = 3 R2 = 0.954641 R2cv = 0.928546 F = 168.37 s2 = 0.0816329

| # | B | s | t | IC | Name of descriptor |
|---|---|---|---|---|---|
| 0 | 44.2559 | 9.43925 | 4.6885 | | Intercept |
| 1 | 0.00243728 | 0.000121421 | 20.073 | 0.475102 | Gravitation index (all atoms' pairs) |
| 2 | 2.27741 | 0.211075 | 10.7896 | 0.455476 | HA dependent HDCA-2 (MOPAC PC) |
| 3 | −52.4607 | 11.3083 | −4.63912 | 0.625034 | Avg. valency for atom H Outliers are |
| | | | | | selected. Number of outliers is 1. |

### Model #6

N = 28 n = 4 R2 = 0.965407 R2cv = 0.943944 F = 160.468 s2 = 0.0649639

| # | B | s | t | IC | Name of descriptor |
|---|---|---|---|---|---|
| 0 | 61.6165 | 7.72435 | 7.97691 | | Intercept |
| 1 | 0.604794 | 0.0370359 | 16.3299 | 0.741193 | Number of C atoms |
| 2 | 6.53494 | 0.442707 | 14.7613 | 0.480178 | HA dependent HDCA-2 (Zefirov PC) |
| 3 | −73.694 | 9.41291 | −7.82904 | 0.569327 | Avg. valency for atom H |
| 4 | −0.200763 | 0.0562376 | −3.56992 | 0.64731 | RPCS Relative positive charged SA |
| | | | | | (SAMPOS*RPCG) (Zefirov PC) |
| | | | | | Outliers are selected. Number of |
| | | | | | outliers is 0. |

### Loading 0.4

### Model #7

N = 24 n = 3 R2 = 0.959352 R2cv = 0.944806 F = 157.342 s2 = 0.0698503

| # | B | s | t | IC | Name of descriptor |
|---|---|---|---|---|---|
| 0 | −137.382 | 23.8301 | −5.76509 | | Intercept |
| 1 | 0.639481 | 0.0339675 | 18.8262 | 0.464053 | Number of C atoms |
| 2 | 67.0161 | 4.2122 | 15.91 | 0.432401 | HA dependent HDCA-2/SQRT |
| | | | | | (TMSA) (MOPAC PC) |
| 3 | 36.4546 | 6.43049 | 5.66901 | 0.0922693 | Max coulombic interaction for bond |
| | | | | | H—C Outliers are selected. Number of |
| | | | | | outliers is 0. |

### Model #8

N = 24 n = 4 R2 = 0.977487 R2cv = 0.95433 F = 206.236 s2 = 0.0407233

| # | B | s | t | IC | Name of descriptor |
|---|---|---|---|---|---|
| 0 | −197.734 | 23.855 | −8.28901 | | Intercept |
| 1 | 0.727879 | 0.0343984 | 21.1603 | 0.695316 | Number of C atoms |
| 2 | 69.4795 | 3.27728 | 21.2003 | 0.453354 | HA dependent HDCA-2/SQRT |
| | | | | | (TMSA) (MOPAC PC) |
| 3 | 52.191 | 6.34731 | 8.22254 | 0.456825 | Max coulombic interaction for bond |
| | | | | | H—C |
| 4 | 0.855019 | 0.218555 | 3.91214 | 0.70151 | Tot point-charge comp. of the |
| | | | | | molecular dipole Outliers are |
| | | | | | selected. Number of outliers is 0. |

Models 1-8 all contain the HDCA-2 (Area-weighted surface charge of hydrogen bonding donor atoms) related descriptor. In all models, this descriptor has a relatively high t-test value, which demonstrates its significance. The HDCA-2 descriptor is defined by Eq 3.

$$HDCA 2 = {\sum }_{D}^{ } \frac{{q}_{D} \sqrt{{S}_{D}}}{\sqrt{{S}_{tot}}} D ∈ {H}_{H - donor} \qquad ( 3 )$$

S_{D}-solvent-accessible surface area of H-bonding donor H atoms, selected by threshold charge q_{D}-partial charge on H-bonding donor H atoms, selected by threshold charge
Sₜₒₜ-total solvent-accessible molecular surface area.

Table 11 lists the preliminary property P values predicted for the 25 molecule entities (Appendix 5) using models 1-8. All the predicted results are in reasonable range. There are no predicted values that are unrealistically high.

As shown, the reported models for the “new property, P” where solubility and vapor pressure are included, have very good statistical characteristics.

TABLE 11
PREDICTED LOG P (COMBINED PROPERTY) VALUES
USING 3 AND 4-PARAMETER MODELS.

| | Loading | | | | | | | |
|---|---|---|---|---|---|---|---|---|
| | 0.1 | | 0.2 | | 0.3 | | 0.4 | |
| ID | Model #1 | Model #2 | Model #3 | Model #4 | Model #5 | Model #6 | Model #7 | Model #8 |
| S2000029 | 9.27877 | 9.44905 | 9.71386 | 9.94921 | 10.0069 | 10.0458 | 8.91021 | 9.20971 |
| S2000051 | 10.1424 | 10.237 | 10.9176 | 11.3299 | 11.7606 | 11.9774 | 10.7899 | 10.4136 |
| S2000052 | 13.5397 | 13.7645 | 12.7178 | 14.6006 | 16.6727 | 18.0298 | 19.1468 | 21.6616 |
| S2000053 | 8.40204 | 8.3664 | 9.03761 | 9.42663 | 9.67284 | 9.8353 | 8.21852 | 7.30742 |
| S2000054 | 13.0794 | 14.0574 | 12.1865 | 14.3838 | 15.8034 | 17.5092 | 17.9572 | 20.3003 |
| S2000068 | 9.14378 | 9.1811 | 9.63205 | 10.0394 | 10.3504 | 10.3218 | 9.13372 | 8.55938 |
| S2000069 | 12.453 | 12.8174 | 11.5621 | 13.6861 | 15.4012 | 17.2952 | 16.8157 | 19.0112 |
| S2000070 | 9.63218 | 9.90967 | 10.277 | 10.5569 | 10.9317 | 10.9251 | 9.69364 | 8.85907 |
| S2000071 | 13.4892 | 14.3563 | 12.6796 | 14.6656 | 16.1938 | 17.7505 | 18.8886 | 21.2562 |
| S2000072 | 4.93663 | 5.21377 | 4.95633 | 5.32729 | 4.78933 | 4.6312 | 5.50348 | 4.91641 |
| S2000073 | 7.44472 | 8.06022 | 7.44704 | 9.19627 | 8.63973 | 10.4902 | 10.317 | 11.8374 |
| S2000083 | 8.06454 | 7.8433 | 8.84632 | 9.2256 | 9.74776 | 10.5446 | 8.19603 | 7.7312 |
| S2000084 | 12.0535 | 12.2449 | 11.3122 | 13.0957 | 14.8355 | 17.2108 | 17.6402 | 20.7735 |
| S2000085 | 8.5314 | 8.34638 | 9.33508 | 9.60812 | 10.0578 | 10.7882 | 8.32164 | 7.65098 |
| S2000086 | 12.2882 | 12.8767 | 11.287 | 13.2371 | 15.0814 | 17.2251 | 17.7771 | 20.7743 |
| S2900001 | 12.9749 | 13.6266 | 13.5104 | 13.9832 | 16.1516 | 15.8223 | 15.98 | 16.9249 |
| S2900005 | 15.5177 | 16.0311 | 15.0143 | 15.4621 | 19.9963 | 17.5685 | 17.1431 | 19.1508 |
| S3000001 | 20.0015 | 21.4408 | 16.7416 | 17.296 | 21.7317 | 17.1781 | 19.9839 | 24.4081 |
| S3000005 | 10.0433 | 9.72478 | 9.70276 | 9.76673 | 10.1707 | 10.0087 | 14.2048 | 17.1287 |
| S3900001 | 21.9931 | 24.0149 | 18.9051 | 19.3572 | 25.0608 | 20.2057 | 24.0167 | 27.6773 |
| S3900005 | 10.3517 | 10.3222 | 10.0229 | 10.3801 | 11.3759 | 11.0141 | 12.9023 | 14.8552 |
| S4000004 | 16.8164 | 18.3983 | 17.1339 | 17.5981 | 19.403 | 18.898 | 17.5077 | 18.8178 |
| S4000012 | 18.0654 | 20.0357 | 18.501 | 18.5308 | 20.6809 | 19.1261 | 19.2345 | 21.405 |
| S4900003 | 17.6691 | 19.5797 | 18.0786 | 18.4934 | 20.0436 | 18.2877 | 18.1458 | 19.6955 |
| S4900012 | 16.6869 | 17.8905 | 16.6411 | 16.7866 | 19.4494 | 18.2686 | 17.2679 | 19.1055 |

### Predictive Power of the Property P_{N}

We decided that it would be worthwhile to study the predictive power of other different exponential combinations of vapor pressure and solubility. Consequently, the general equation 4, based on equation 2, was defined as follows:

$${P}_{n} = log \frac{S \cdot {L}_{W}^{X}}{{VP}^{Y}} , X = \{ 0.5 , 1 , 2 \} , Y = \{ 0.5 , 1 , 2 \} \qquad ( 4 )$$

where S—the selectivity, L_{W}—the solubility, VP—the vapor pressure of the compounds, and X, Y—the exponents of solubility and vapor pressure, respectively.

All 8 QSPR models were used to predict the Pₙ values for the original 33 absorbents and for 15 secondary amine structures (Table 12).

TABLE 12
PREDICTED VALUES OF P_{N} USING THE MODELS 1-8

| | Property Pn values | | | | | | | | | | | | | | | |
|---|---|---|---|---|---|---|---|---|---|---|---|---|---|---|---|---|
| | loading 0.1 | | | | loading 0.2 | | | | loading 0.3 | | | | loading 0.4 | | | |
| | exp. | | pred. | | exp. | | pred. | | exp. | | pred. | | exp. | | pred. | |
| | mod. | mod. | mod. | mod. | mod. | mod. | mod. | mod. | mod. | mod. | mod. | mod. | mod. | mod. | mod. | mod. |
| ID | 1 | 5 | 1 | 5 | 2 | 6 | 2 | 6 | 3 | 7 | 3 | 7 | 4 | 8 | 4 | 8 |
| S0000001 | 8.87 | 16.26 | 8.64 | 16.02 | 8.82 | 16.21 | 8.52 | 15.83 | 8.77 | 16.16 | 8.47 | 15.87 | 8.74 | 16.13 | 8.34 | 16.12 |
| S0000002 | 8.91 | 16.73 | 8.73 | 16.37 | 8.82 | 16.64 | 8.57 | 16.20 | 8.71 | 16.52 | 8.45 | 16.15 | 8.50 | 16.32 | 8.39 | 16.30 |
| S0000003 | 8.75 | 16.55 | 8.76 | 17.68 | 8.54 | 16.34 | 8.60 | 17.41 | 8.32 | 16.12 | 8.47 | 17.40 | n/a | n/a | 8.41 | 17.62 |
| S0000004 | 7.42 | 13.73 | 7.12 | 13.73 | 7.35 | 13.67 | 7.13 | 13.74 | 7.26 | 13.57 | 6.99 | 13.64 | 7.22 | 13.53 | 6.95 | 13.65 |
| S0000005 | 11.71 | 22.26 | 11.96 | 20.72 | 11.68 | 22.23 | 11.44 | 20.23 | 11.64 | 22.18 | 11.31 | 20.54 | 11.61 | 22.15 | 11.37 | 21.81 |
| S0000006 | 6.23 | 11.56 | 5.64 | 11.28 | 6.16 | 11.49 | 5.82 | 11.50 | 6.10 | 11.43 | 5.70 | 11.22 | 5.96 | 11.29 | 5.65 | 10.84 |
| S0000007 | 8.24 | 15.42 | 8.13 | 15.38 | 8.23 | 15.42 | 8.05 | 15.24 | 8.22 | 15.40 | 7.94 | 15.27 | 8.23 | 15.42 | 7.87 | 15.54 |
| S0000008 | 9.94 | 18.63 | 9.86 | 18.74 | 9.85 | 18.55 | 9.59 | 18.38 | 9.76 | 18.46 | 9.48 | 18.41 | 9.64 | 18.33 | 9.39 | 18.66 |
| S0000009 | 9.13 | 17.06 | 9.20 | 16.76 | 9.05 | 16.98 | 9.01 | 16.56 | 8.92 | 16.85 | 8.94 | 16.55 | 8.75 | 16.68 | 8.84 | 16.78 |
| S0000010 | 7.06 | 12.91 | 7.39 | 13.05 | 7.01 | 12.86 | 7.40 | 13.20 | 6.92 | 12.77 | 7.33 | 12.91 | 6.81 | 12.66 | 7.26 | 12.69 |
| S0000011 | 7.91 | 14.54 | 7.66 | 14.14 | 7.82 | 14.45 | 7.64 | 14.11 | 7.75 | 14.38 | 7.57 | 14.12 | 7.67 | 14.30 | 7.51 | 14.49 |
| S0000012 | 7.97 | 14.86 | 8.32 | 15.10 | 7.93 | 14.82 | 8.22 | 15.05 | 7.92 | 14.81 | 8.11 | 14.91 | 7.89 | 14.78 | 8.05 | 14.93 |
| S0000013 | 8.48 | 15.80 | 8.50 | 16.04 | 8.44 | 15.76 | 8.38 | 15.90 | 8.41 | 15.73 | 8.26 | 15.81 | 8.38 | 15.70 | 8.19 | 15.85 |
| S0000014 | 8.01 | 14.80 | 8.00 | 14.36 | 7.97 | 14.76 | 7.93 | 14.39 | 7.94 | 14.73 | 7.85 | 14.19 | 7.86 | 14.65 | 7.79 | 14.15 |
| S0000015 | 8.36 | 15.61 | 8.52 | 15.50 | 8.33 | 15.59 | 8.39 | 15.42 | 8.14 | 15.40 | 8.28 | 15.31 | 7.99 | 15.25 | 8.22 | 15.39 |
| S0000016 | 7.94 | 15.16 | 8.55 | 15.30 | 7.92 | 15.13 | 8.42 | 15.25 | 7.91 | 15.12 | 8.31 | 15.09 | 7.84 | 15.06 | 8.26 | 15.12 |
| S0000017 | 10.70 | 20.52 | 10.25 | 20.59 | 10.32 | 20.13 | 9.93 | 20.07 | 9.77 | 19.58 | 9.85 | 20.56 | n/a | n/a | 9.89 | 22.30 |
| S0000018 | n/a | n/a | 8.41 | 17.76 | 7.54 | 14.13 | 8.30 | 14.99 | 7.49 | 14.08 | 8.19 | 14.82 | 7.43 | 14.02 | 8.14 | 14.75 |
| S0000019 | 8.94 | 14.36 | 8.78 | 15.04 | 8.70 | 16.46 | 8.62 | 17.47 | 8.19 | 15.95 | 8.49 | 17.49 | n/a | n/a | 8.43 | 17.76 |
| S0000020 | 8.42 | 16.11 | 8.93 | 15.79 | 8.41 | 16.09 | 8.75 | 15.66 | 8.37 | 16.06 | 8.63 | 15.59 | 8.28 | 15.96 | 8.58 | 15.71 |
| S0000021 | n/a | n/a | 7.91 | 14.91 | 8.01 | 14.80 | 7.83 | 14.89 | 7.86 | 14.65 | 7.68 | 14.70 | 7.78 | 14.57 | 7.66 | 14.63 |
| S0000022 | 11.24 | 21.64 | 11.15 | 23.02 | 10.30 | 20.70 | 10.72 | 22.28 | n/a | n/a | 10.59 | 22.87 | n/a | n/a | 10.62 | 24.65 |
| S0000023 | 7.08 | 12.97 | 7.06 | 13.15 | 7.03 | 12.92 | 7.08 | 13.29 | 6.95 | 12.84 | 6.95 | 13.00 | 6.85 | 12.74 | 6.94 | 12.82 |
| S0000024 | 8.92 | 16.57 | 8.68 | 15.85 | 8.83 | 16.49 | 8.53 | 15.75 | 8.78 | 16.43 | 8.41 | 15.61 | 8.68 | 16.33 | 8.35 | 15.61 |
| S0000025 | 7.48 | 13.79 | 7.60 | 13.97 | 7.41 | 13.72 | 7.56 | 14.04 | 7.32 | 13.63 | 7.41 | 13.80 | 7.33 | 13.64 | 7.40 | 13.68 |
| S0000026 | 13.62 | 25.92 | 12.78 | 24.69 | n/a | n/a | 12.20 | 23.74 | n/a | n/a | 12.05 | 24.02 | n/a | n/a | 11.79 | 24.07 |
| S0000027 | 10.18 | 19.04 | 10.34 | 19.31 | 9.82 | 18.68 | 10.02 | 18.83 | n/a | n/a | 9.90 | 18.83 | n/a | n/a | 9.70 | 18.54 |
| S0000028 | n/a | n/a | 10.07 | 17.98 | n/a | n/a | 9.76 | 17.64 | 8.76 | 16.88 | 9.59 | 17.62 | 8.74 | 16.86 | 9.46 | 17.53 |
| S0000029 | 8.89 | 16.42 | 9.35 | 17.10 | n/a | n/a | 9.14 | 16.83 | n/a | n/a | 9.02 | 16.71 | n/a | n/a | 8.85 | 16.33 |
| S0000030 | 11.31 | 21.18 | 11.44 | 21.16 | 11.19 | 21.06 | 10.99 | 20.54 | 11.08 | 20.95 | 10.84 | 20.62 | n/a | n/a | 10.63 | 20.49 |
| S0000031 | 10.71 | 20.25 | 10.99 | 21.12 | 10.51 | 20.05 | 10.60 | 20.47 | n/a | n/a | 10.44 | 20.56 | n/a | n/a | 10.23 | 20.33 |
| S0000032 | n/a | n/a | 11.00 | 20.12 | n/a | n/a | 10.59 | 19.60 | 10.55 | 19.68 | 10.39 | 19.64 | 10.43 | 19.56 | 10.26 | 19.59 |
| S0000033 | 10.12 | 18.86 | 10.22 | 18.57 | 9.98 | 18.73 | 9.91 | 18.14 | 9.88 | 18.62 | 9.75 | 18.14 | 9.82 | 18.56 | 9.56 | 17.86 |
| S2000029 | n/a | n/a | 9.98 | 17.79 | n/a | n/a | 9.72 | 17.48 | n/a | n/a | 9.56 | 17.39 | n/a | n/a | 9.35 | 17.15 |
| S2000051 | n/a | n/a | 11.47 | 22.62 | n/a | n/a | 10.97 | 21.83 | n/a | n/a | 10.74 | 22.11 | n/a | n/a | 10.56 | 22.31 |
| S2000052 | n/a | n/a | 13.78 | 28.62 | n/a | n/a | 13.20 | 27.19 | n/a | n/a | 13.12 | 28.09 | n/a | n/a | 12.69 | 29.29 |
| S2000053 | n/a | n/a | 9.18 | 17.70 | n/a | n/a | 8.98 | 17.34 | n/a | n/a | 8.76 | 17.29 | n/a | n/a | 8.43 | 16.89 |
| S2000054 | n/a | n/a | 12.63 | 24.92 | n/a | n/a | 12.25 | 23.83 | n/a | n/a | 12.25 | 24.56 | n/a | n/a | 11.79 | 25.66 |
| S2000068 | n/a | n/a | 9.94 | 19.94 | n/a | n/a | 9.64 | 19.38 | n/a | n/a | 9.45 | 19.54 | n/a | n/a | 9.26 | 19.64 |
| S2000069 | n/a | n/a | 12.62 | 24.09 | n/a | n/a | 12.25 | 23.21 | n/a | n/a | 12.25 | 23.53 | n/a | n/a | 11.81 | 23.93 |
| S2000070 | n/a | n/a | 10.70 | 20.89 | n/a | n/a | 10.30 | 20.29 | n/a | n/a | 10.08 | 20.36 | n/a | n/a | 9.87 | 20.22 |
| S2000071 | n/a | n/a | 13.63 | 29.14 | n/a | n/a | 13.08 | 27.62 | n/a | n/a | 13.06 | 28.81 | n/a | n/a | 12.76 | 30.76 |
| S2000072 | n/a | n/a | 4.39 | 8.56 | n/a | n/a | 4.77 | 9.02 | n/a | n/a | 4.60 | 8.45 | n/a | n/a | 4.24 | 7.34 |
| S2000073 | n/a | n/a | 7.39 | 13.64 | n/a | n/a | 7.64 | 13.32 | n/a | n/a | 7.63 | 14.00 | n/a | n/a | 6.96 | 15.08 |
| S2000083 | n/a | n/a | 8.84 | 16.40 | n/a | n/a | 8.68 | 16.12 | n/a | n/a | 8.38 | 15.85 | n/a | n/a | 7.78 | 14.62 |
| S2000084 | n/a | n/a | 13.12 | 26.21 | n/a | n/a | 12.62 | 25.06 | n/a | n/a | 12.55 | 25.65 | n/a | n/a | 12.13 | 26.37 |
| S2000085 | n/a | n/a | 9.49 | 17.66 | n/a | n/a | 9.24 | 17.30 | n/a | n/a | 8.99 | 17.15 | n/a | n/a | 8.55 | 16.38 |
| S2000086 | n/a | n/a | 12.76 | 24.74 | n/a | n/a | 12.33 | 23.77 | n/a | n/a | 12.27 | 24.15 | n/a | n/a | 11.81 | 24.50 |

The results show that the new defined property, that combines selectivity, solubility and vapor pressure, is provides an in-depth analysis of the absorbents behavior.

A “new dataset” consisting of 22 compounds from different chemical classes: electroneutral molecules, salts and zwitterions were all used to build the 2D-QSPR models (Appendix 6). The models included 2, 3 and 4 descriptors as independent variables and are shown in Table 13. The descriptors are shown in Table 14. The experimental values for S (selectivity) at different loadings and the predicted LogS values based on Table 13 are in Table 15.

TABLE 13
2D-QSAR MODELS FOR LOGS

| | | | | | Number of |
|---|---|---|---|---|---|
| QSPR Models | | R² | R²cv | s² | descriptors |
| 1. | LogS = 2.52 × 10⁻³D₁ + | 0.80 | 0.73 | 0.13 | 2 |
| | 1.54D₂ + 0.27 | | | | |
| 2. | LogS = −1.24D₃ − 1.73D₄ − | 0.89 | 0.86 | 0.07 | 3 |
| | 0.94D₅ + 10.72 | | | | |
| 3. | LogS = −1.34D₃ − 2.22D₄ − | 0.94 | 0.91 | 0.04 | 4 |
| | 1.22D₅ − 0.13D₆ + 13.06 | | | | |

TABLE 14
DESCRIPTOR NAMES OF THE MODELS IN THE TABLE 13

| Symbol | Descriptor name |
|---|---|
| D₁ | 1X BETA polarizability (DIP) |
| D₂ | Min (>0.1) bond order of a H atom |
| D₃ | Average Information content (order 1) |
| D₄ | Max valency of a N atom |
| D₅ | Number of N atoms |
| D₆ | RPCS Relative positive charged SA (SAMPOS*RPCG) |
| | [Zefirov's PC] |

TABLE 15
NEW DATASET: COMPOUNDS AND (I) EXPERIMENTAL VALUES FOR S (SELECTIVITY) AT LOADINGS
INDICATED; (II) EXTRAPOLATED SELECTIVITY VALUES FOR LOADINGS OF 20% AND 10% AND (III)
EXPERIMENTAL AND PREDICTED LOGS VALUES BASED ON MODEL (SEE TABLE 13 FOR THIS DATASET)

| | | | | Extra- | Extra- | | Predicted |
|---|---|---|---|---|---|---|---|
| | | | | polated | polated | | log |
| | | Experimental | | Selectivity | Selectivity | Log | Selectiv- |
| | | Selectivity | Loadings | at 20% | at 10% | Selec- | ity for |
| | Compound structure | values | in % | loading | loading | tivity | Model 3 |
| 1 | 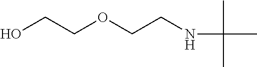 | 15.4 | 16.3 | 14.29 | 17.29 | 1.19 | 1.61 |
| 2 | 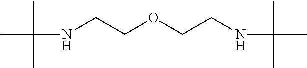 | 16.7 | 28.2 | 18.34 | 20.34 | 1.22 | 1.20 |
| 3 | 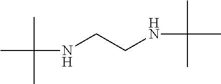 | 26.2 | 9.8 | 23.14 | 26.14 | 1.42 | 1.44 |
| 4 | 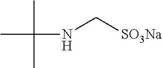 | 14.4 | 5.4 | 10.02 | 13.02 | 1.16 | 1.35 |
| 5 | 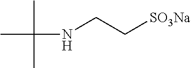 | 34.9 | 13.3 | 32.89 | 35.89 | 1.54 | 1.26 |
| 6 | 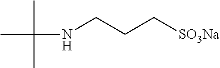 | 20.4 | 14.9 | 18.87 | 21.87 | 1.31 | 1.36 |
| 7 | 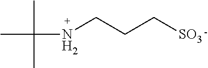 | 1.2 | 0.2 | −4.74 | −1.74 | 0.08 | 0.17 |
| 8 | 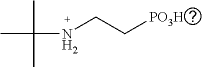 | 0.6 | 25.1 | 1.62 | 3.62 | −0.22 | −0.28 |
| 9 | 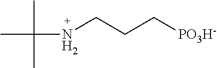 | 0.4 | 25.7 | 1.54 | 3.54 | −0.40 | −0.22 |
| 10 | 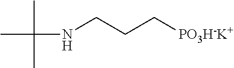 | 84.5 | 20.4 | 84.58 | 86.58 | 1.93 | 1.72 |
| 11 | 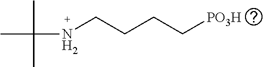 | 0.8 | (25) | 1.80 | 3.80 | −0.10 | 0.23 |
| 12 | 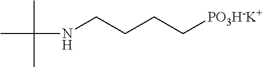 | 37.9 | 6.67 | 33.90 | 36.90 | 1.58 | 1.78 |
| 13 | N—Me₄⁺ OH⁻ | 107.5 | 7.4 | 103.72 | 106.72 | 2.03 | 1.99 |
| 14 | N—Et₄⁺ OH⁻ | 70.7 | 6.5 | 66.65 | 69.65 | 1.85 | 1.85 |
| 15 | N—Pr₄⁺ OH⁻ | 78.7 | 6.0 | 74.50 | 77.50 | 1.90 | 1.69 |
| 16 | N—Bu₄⁺ OH⁻ | 35.9 | 8.3 | 32.39 | 35.39 | 1.56 | 1.74 |
| 17 | 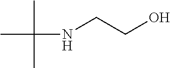 | 26.7 | 11 | 24.00 | 27.00 | 1.43 | 1.44 |
| 18 | 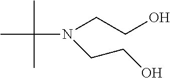 | 49.8 | 3.7 | 44.91 | 47.91 | 1.70 | 1.68 |

| | | | | | | | |
|---|---|---|---|---|---|---|---|
| 19 | 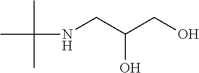 | 78.9 | 4.8 | 74.34 | 77.34 | 1.90 | 1.51 |
| 20 | 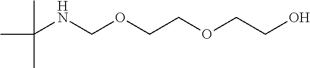 | 56.01 | 21.57 | 56.32 | 58.32 | 1.75 | 1.74 |
| 21 | 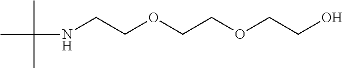 | 75.4 | 13.1 | 73.33 | 76.33 | 1.88 | 1.81 |
| 22 | 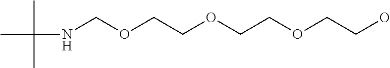 | 64.4 | 24.2 | 65.24 | 67.24 | 1.81 | 1.90 |

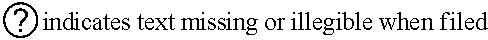

NEW DATASET: COMPOUNDS AND (I) EXPERIMENTAL VALUES FOR S (SELECTIVITY) AT LOADINGS INDICATED;
(II) EXTRAPOLATED SELECTIVITY VALUES FOR LOADINGS OF 20% AND 10% AND
(III) EXPERIMENTAL AND PREDICTED LOGS VALUES BASED ON MODEL (SEE TABLE 13 FOR THIS DATASET)

### APPENDIX 1

### List of Original 33 Structures

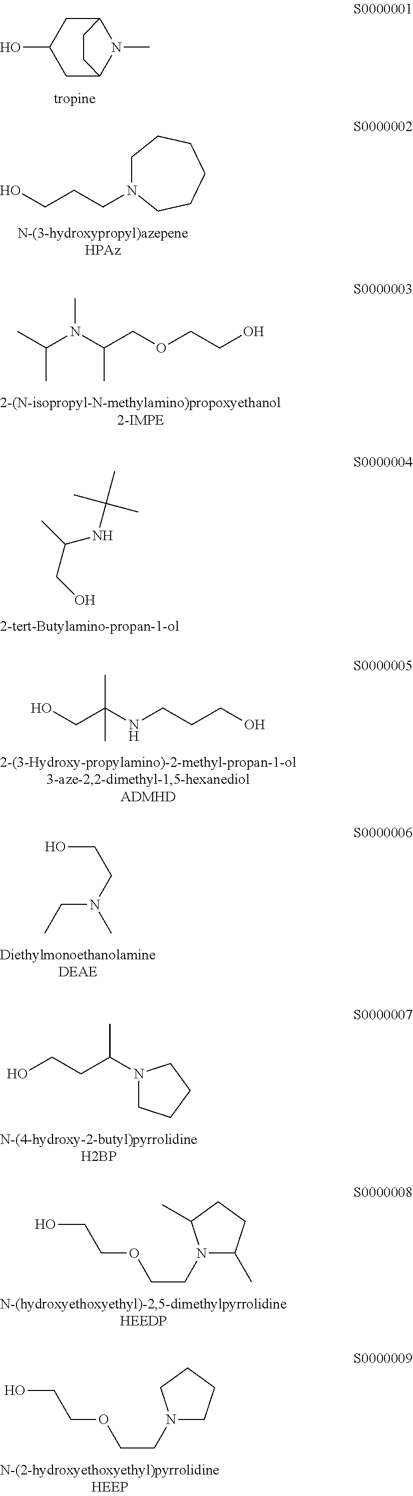

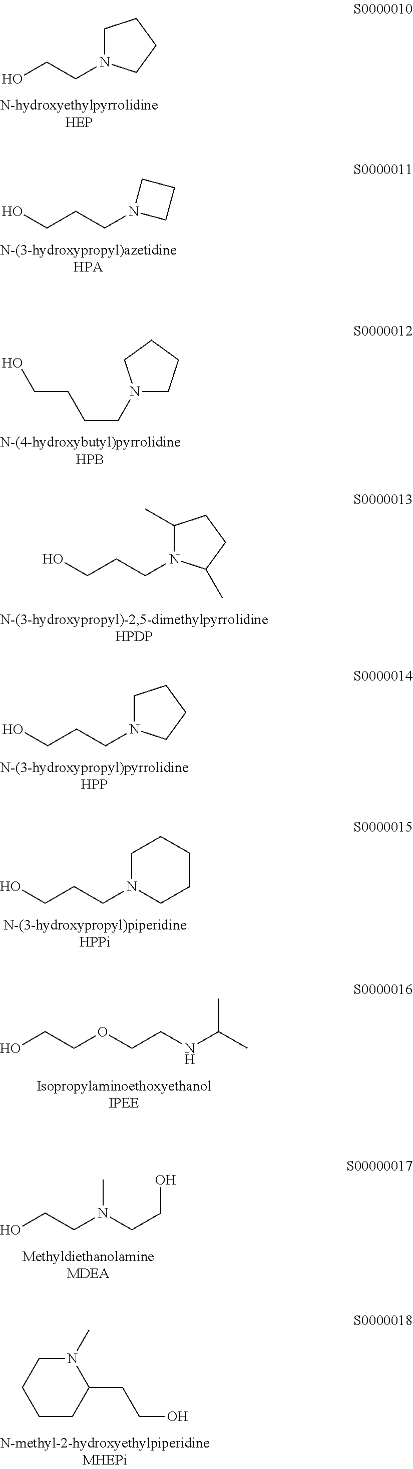

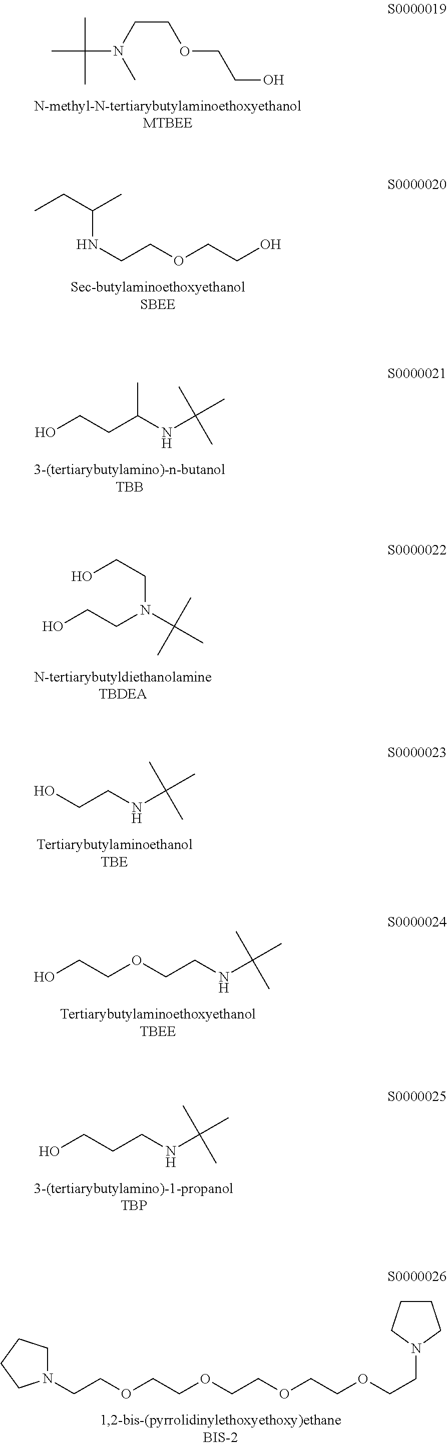

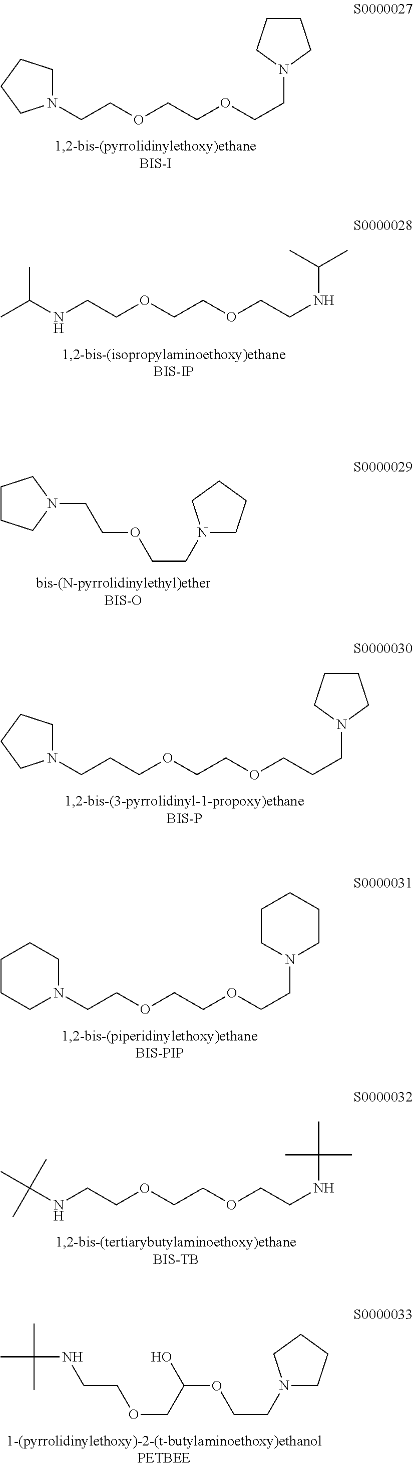

The experimental data for the original 33 structures were collected from the plots of—“Selectivity of amine solutions for H₂S vs. loading of the solution with H₂S and CO₂ (moles per mole of amine)” available from the following ExxonMobil U.S. Pat. Nos. 4,405,580; 4,405,585; 4,405,581; 4,762,934; 4,417,075; 4,405,583; 4,405,582; 4,405,811; 4,483833; 4,892,674; 4,895,670; 4,618,481; 4,471,138.

### APPENDIX 2

### List of the New Structures Proposed as Possible Absorbents

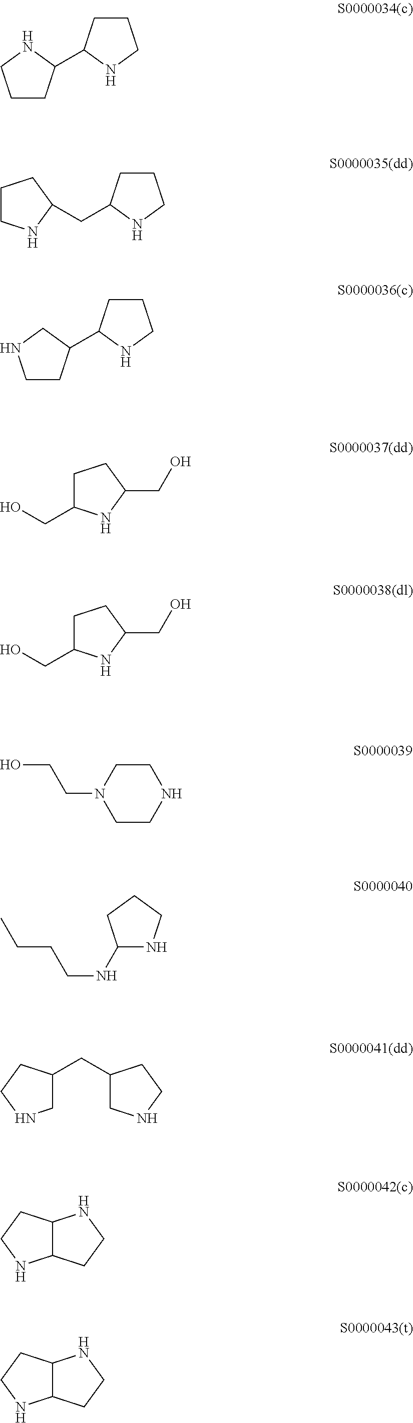

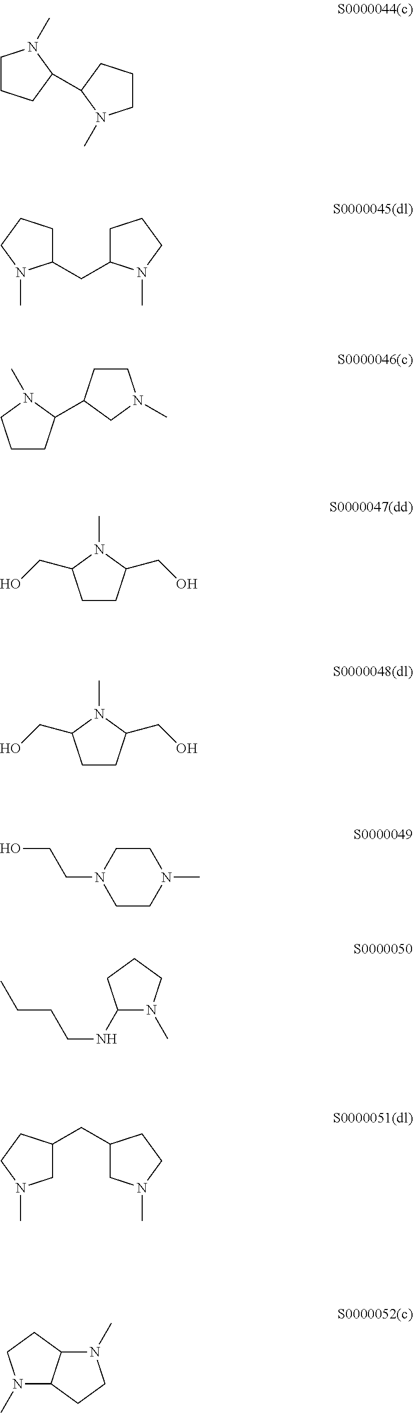

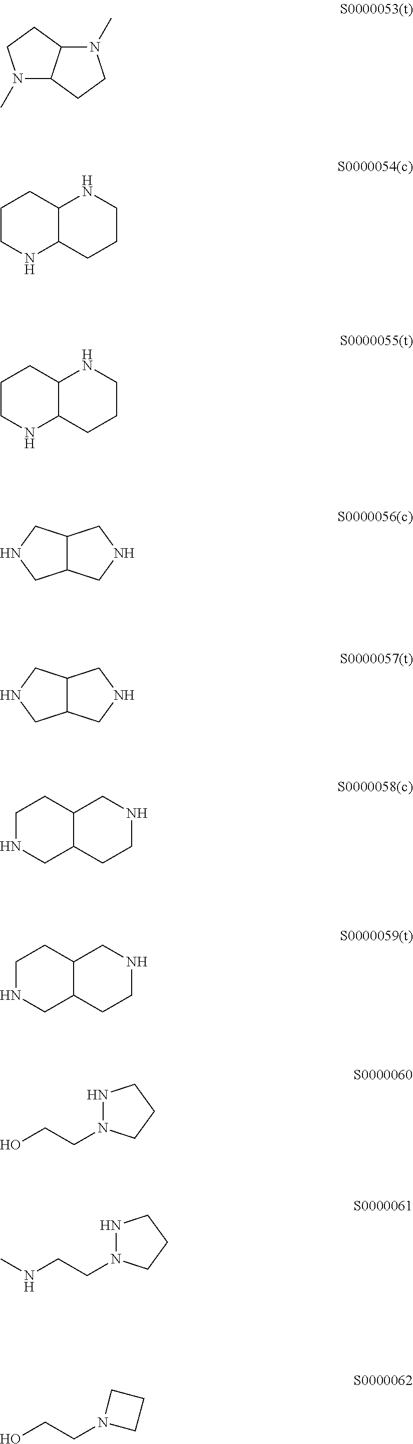

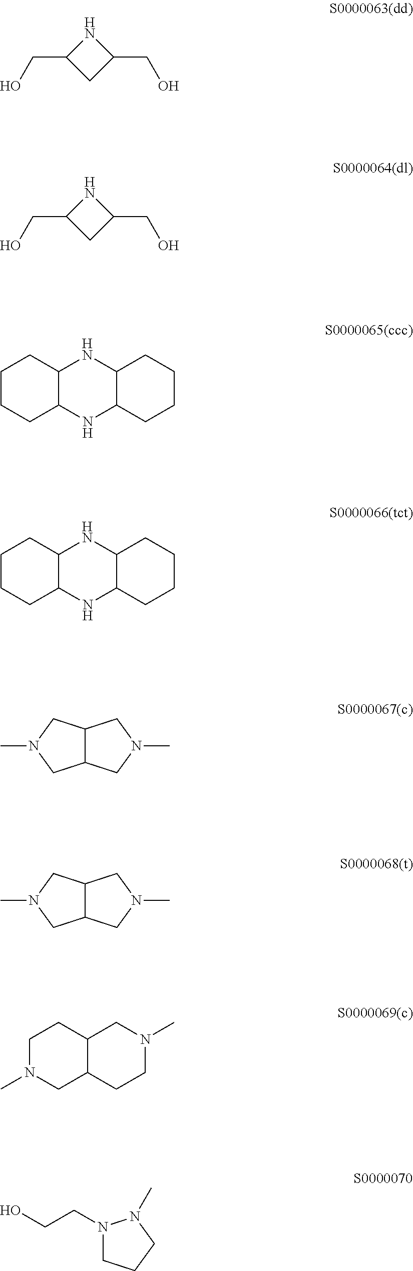

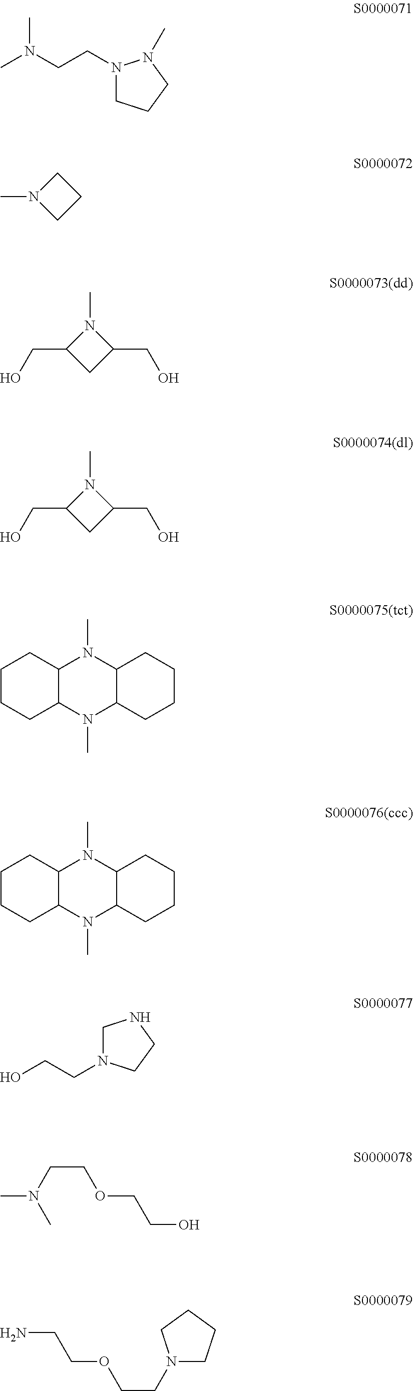

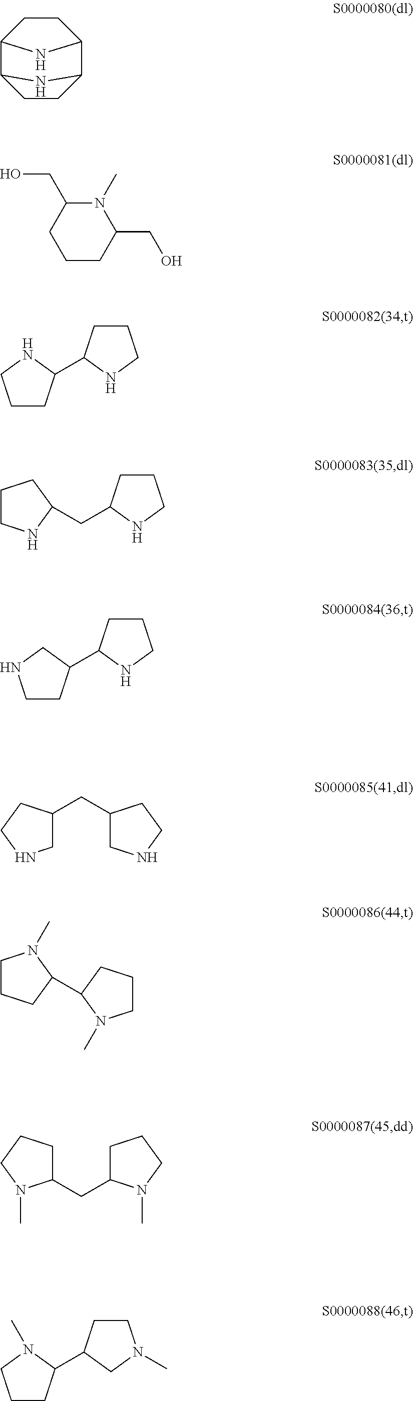

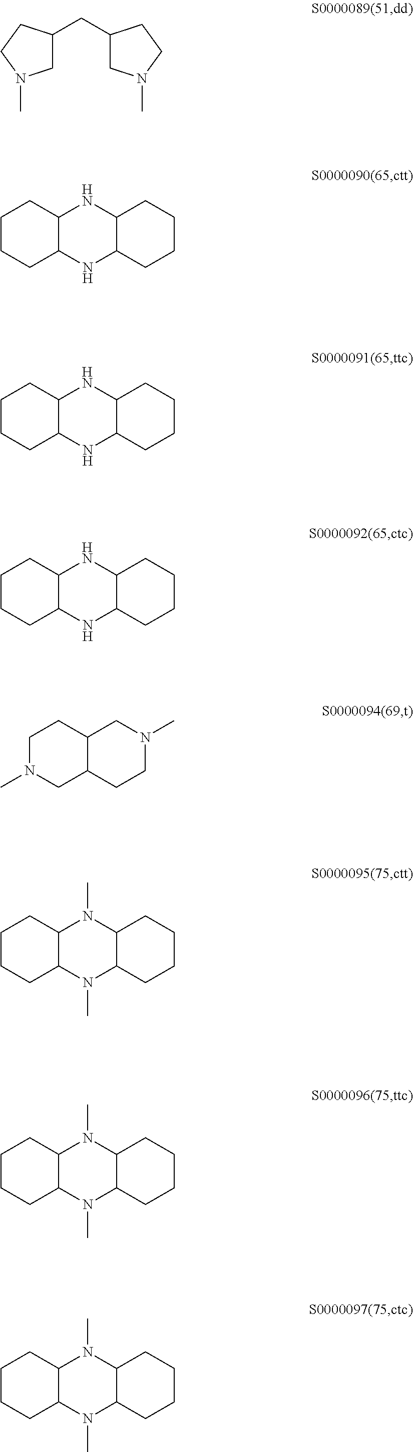

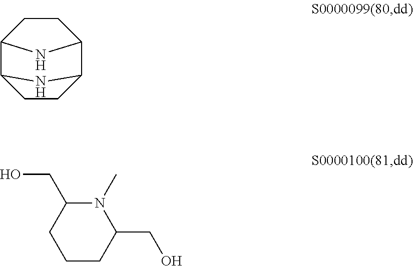

### APPENDIX 3

### List of Substituent Group Fragment Components (R₁H and R₂)

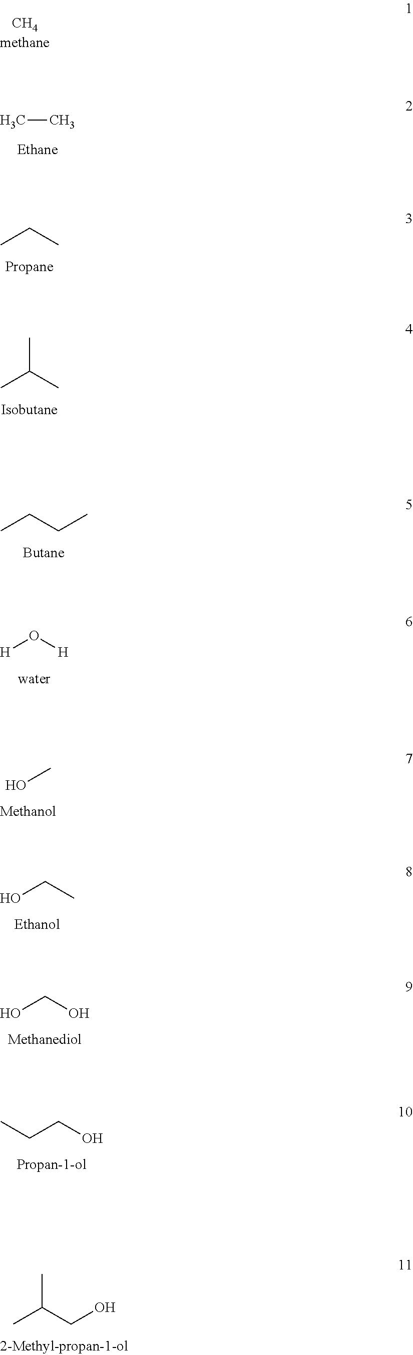

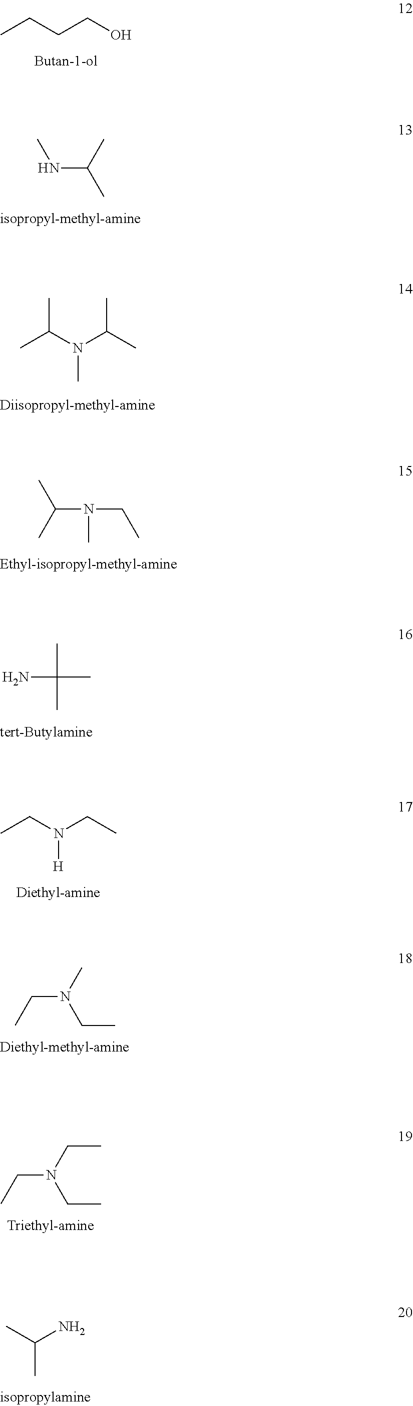

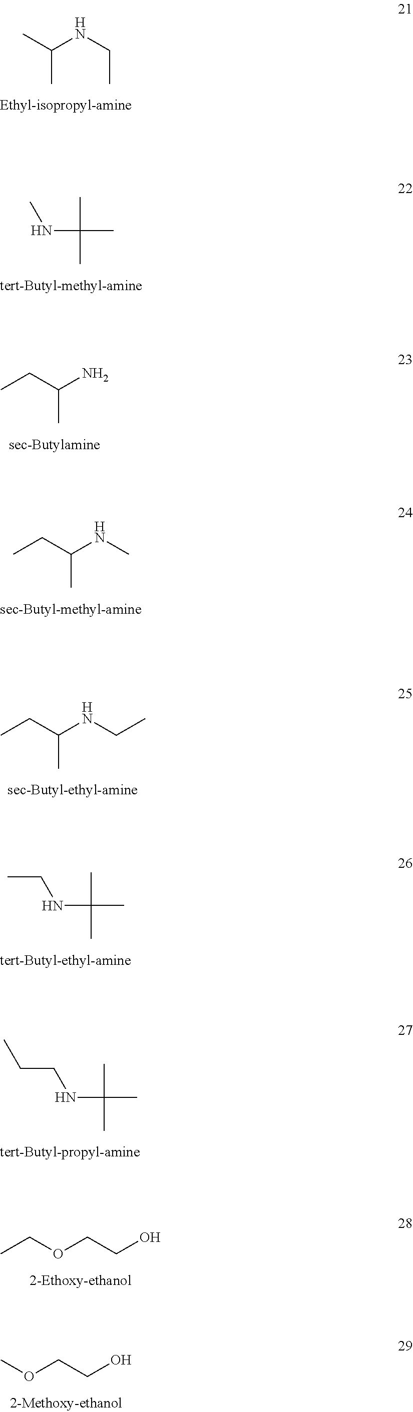

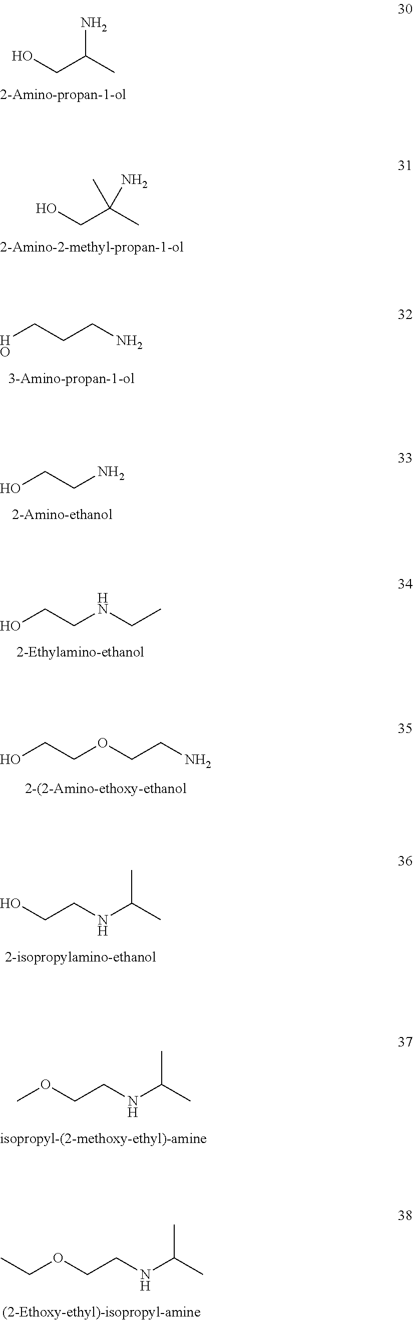

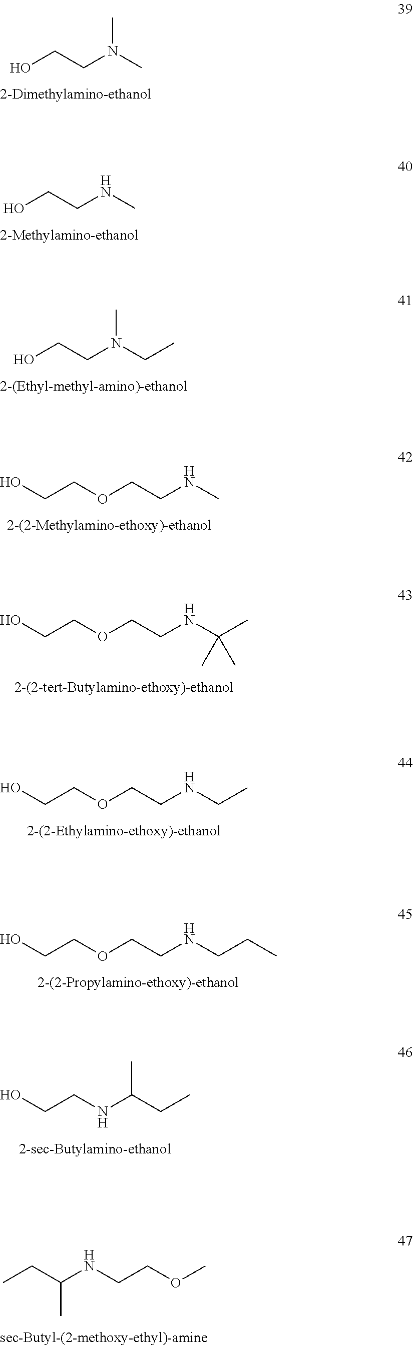

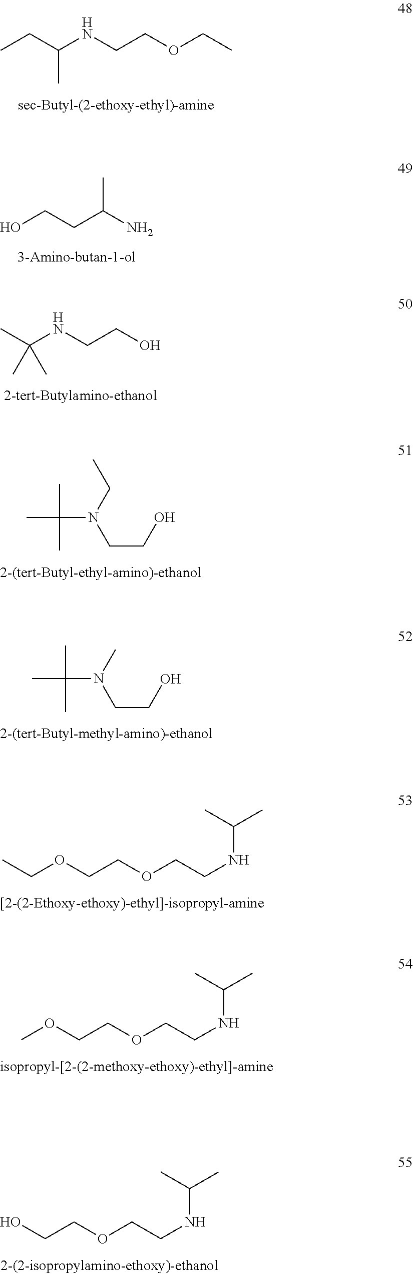

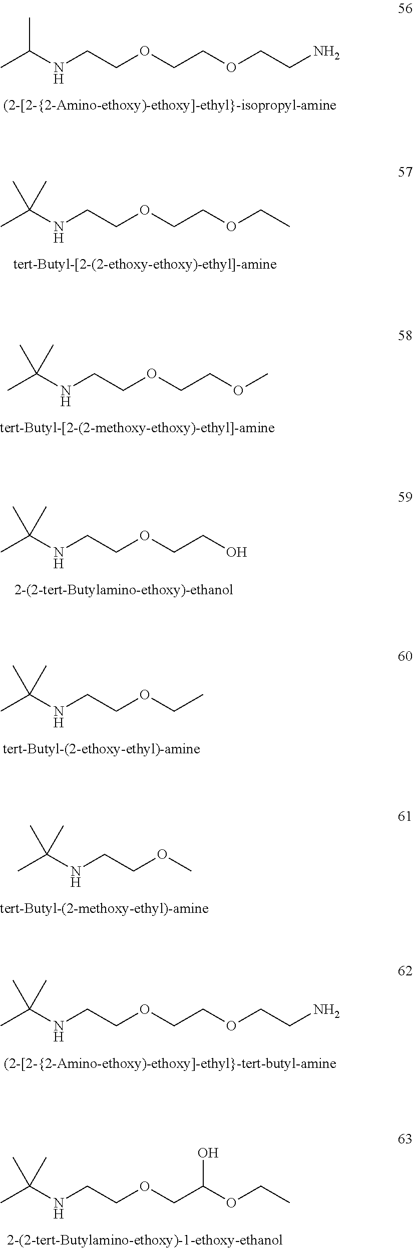

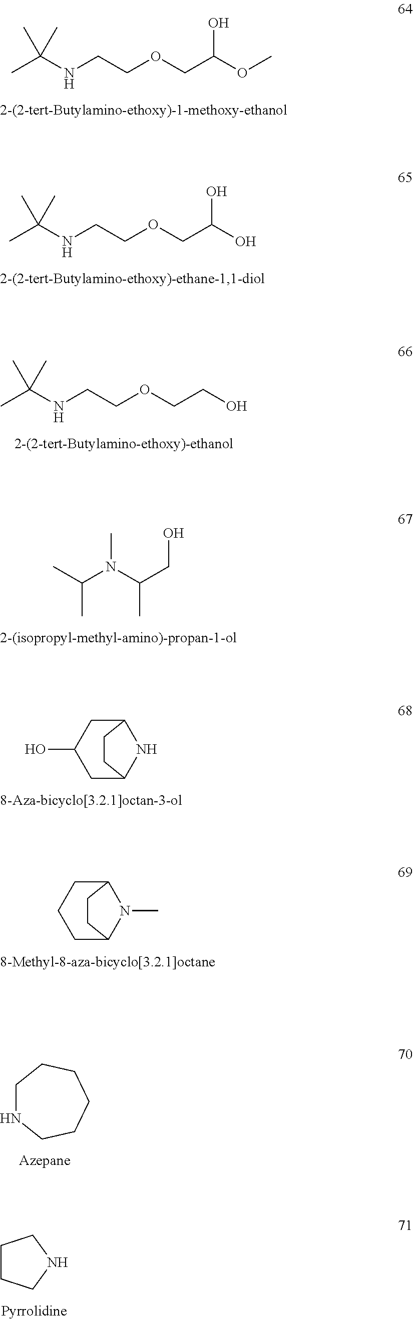

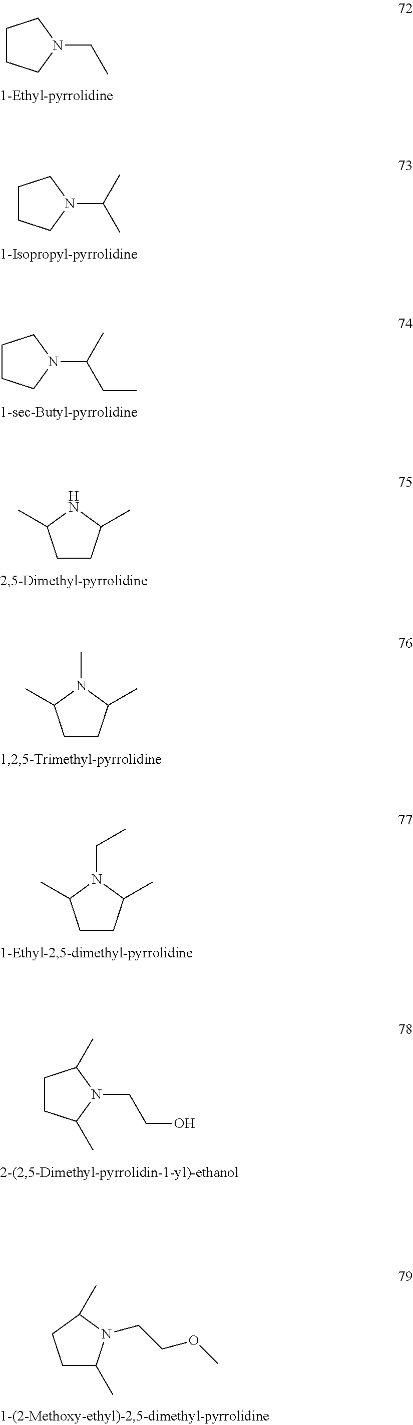

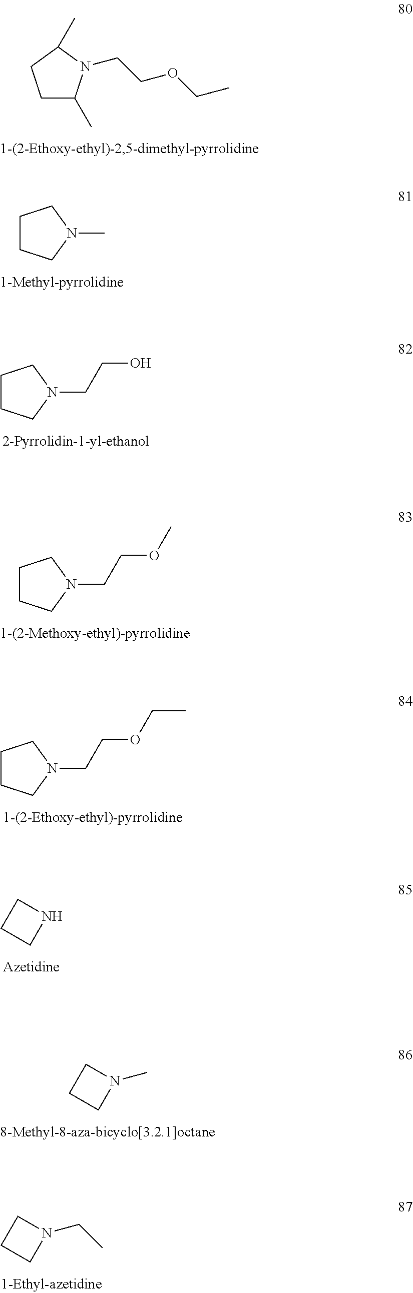

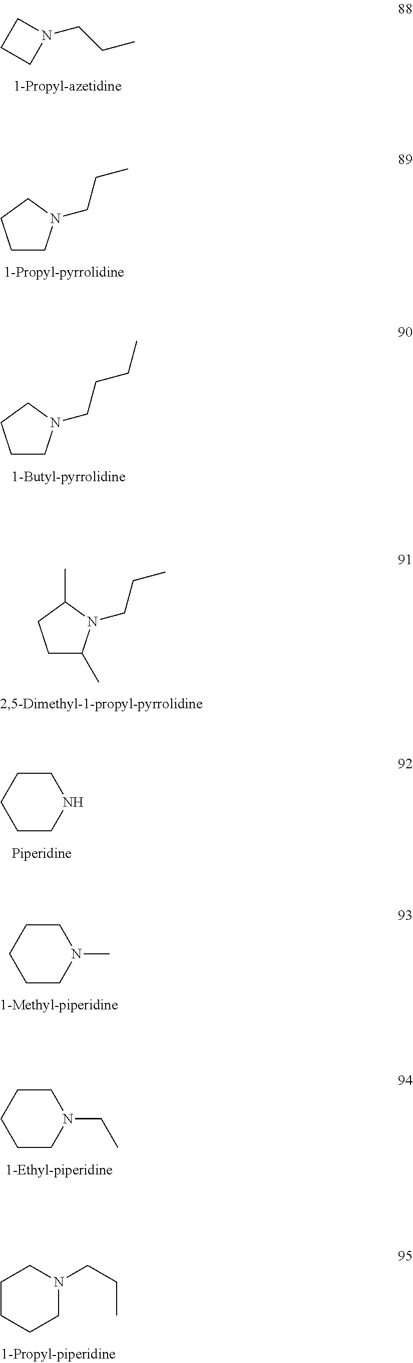

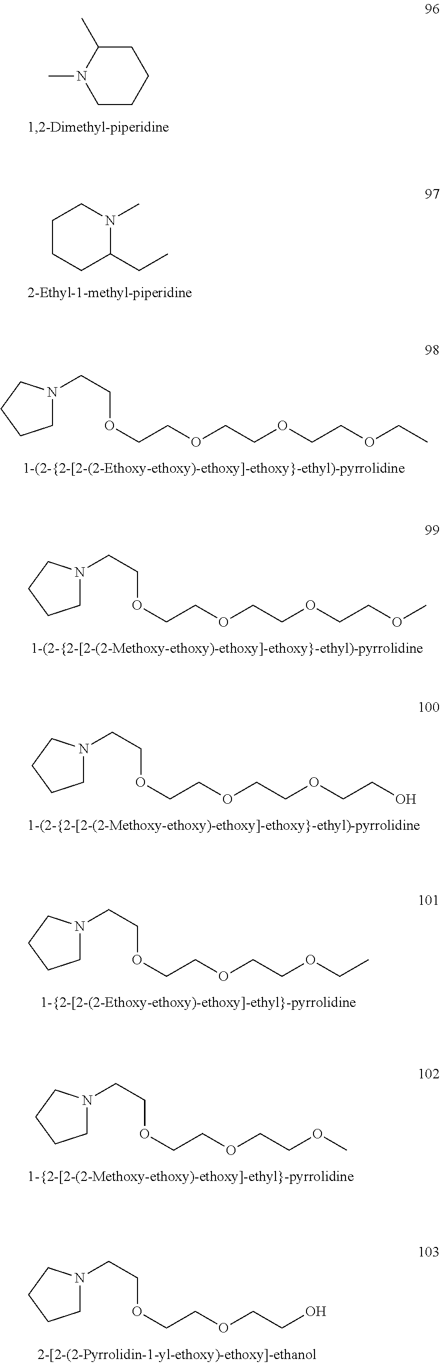

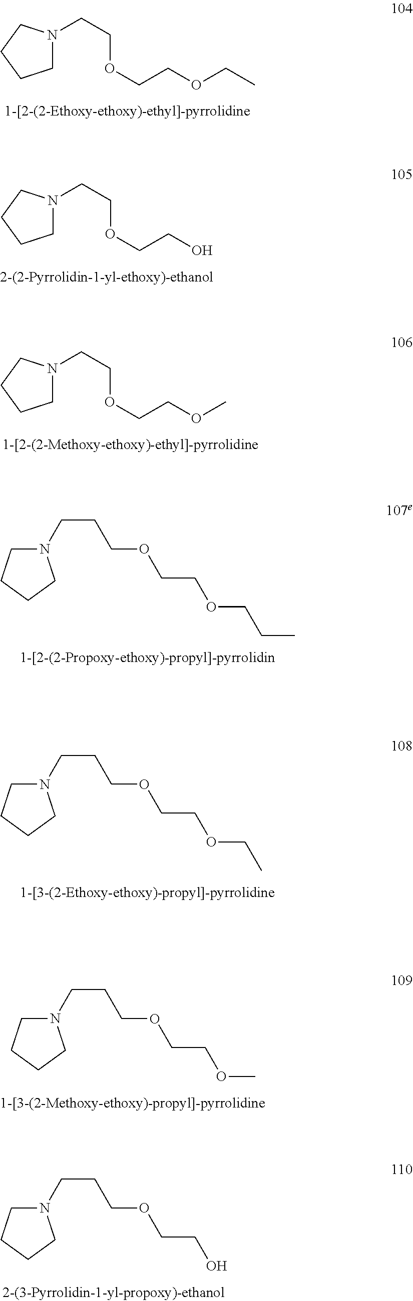

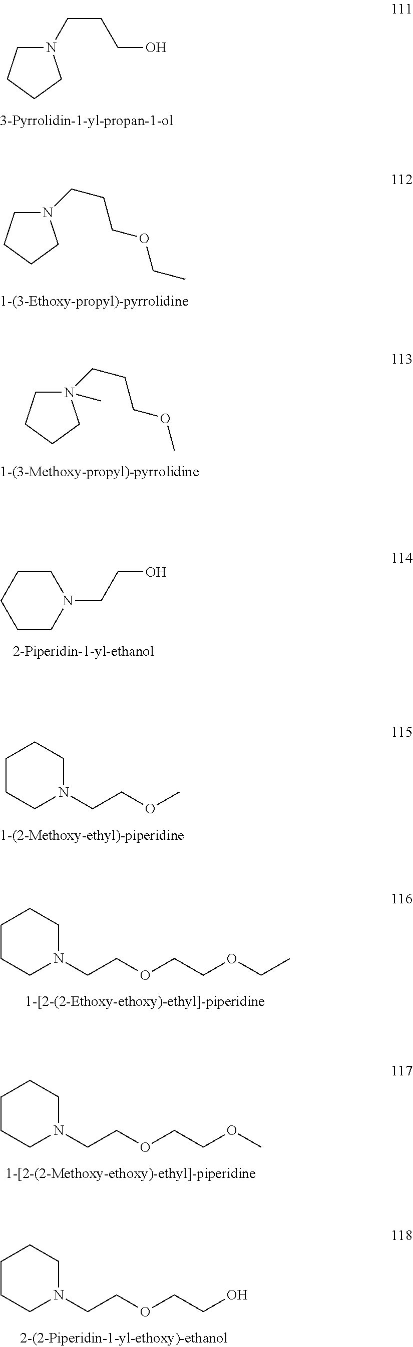

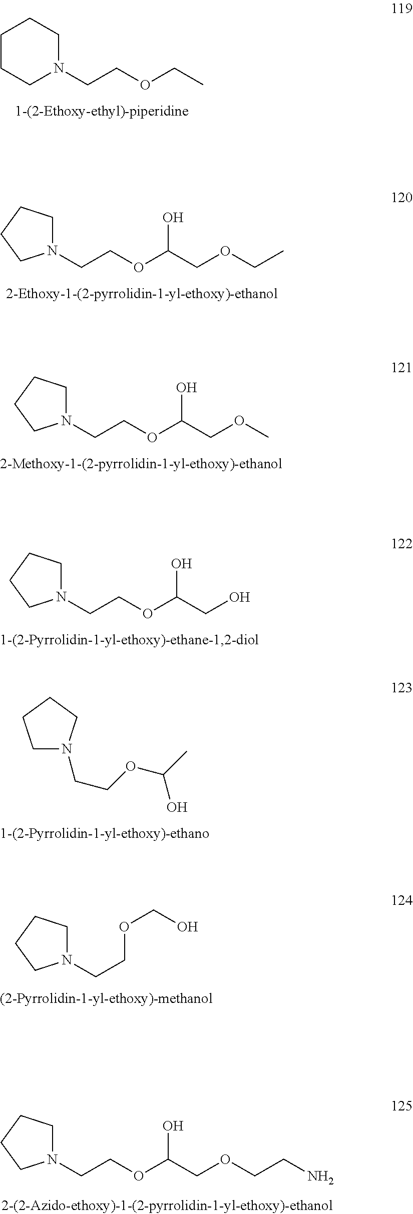

### APPENDIX 4

### List of Generic Bridge Fragment Structure Components (HG₁H)

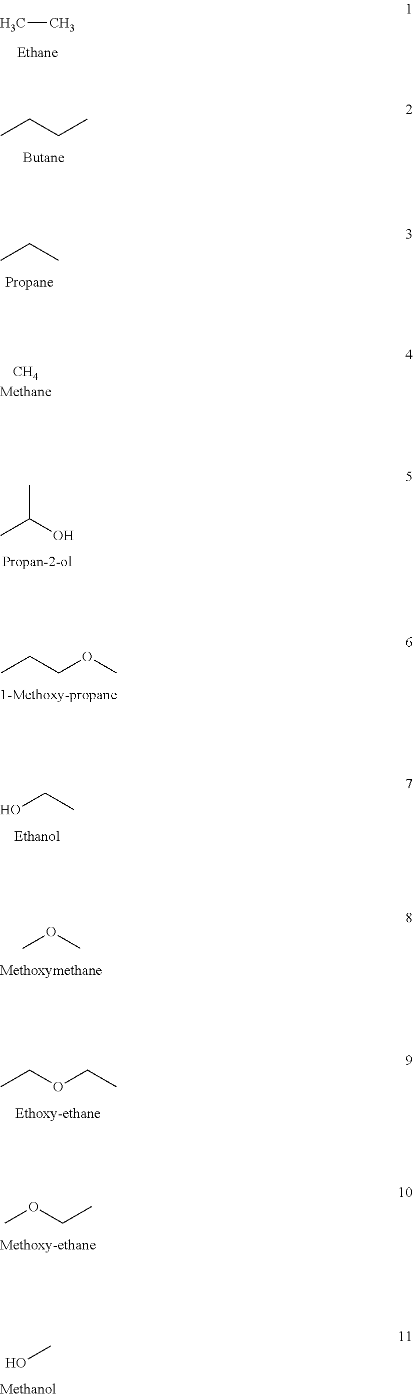

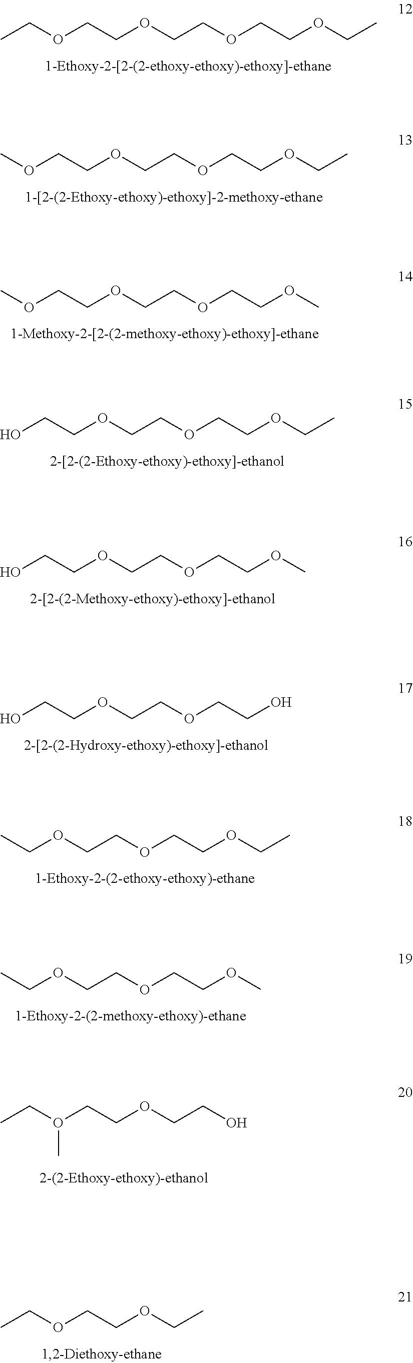

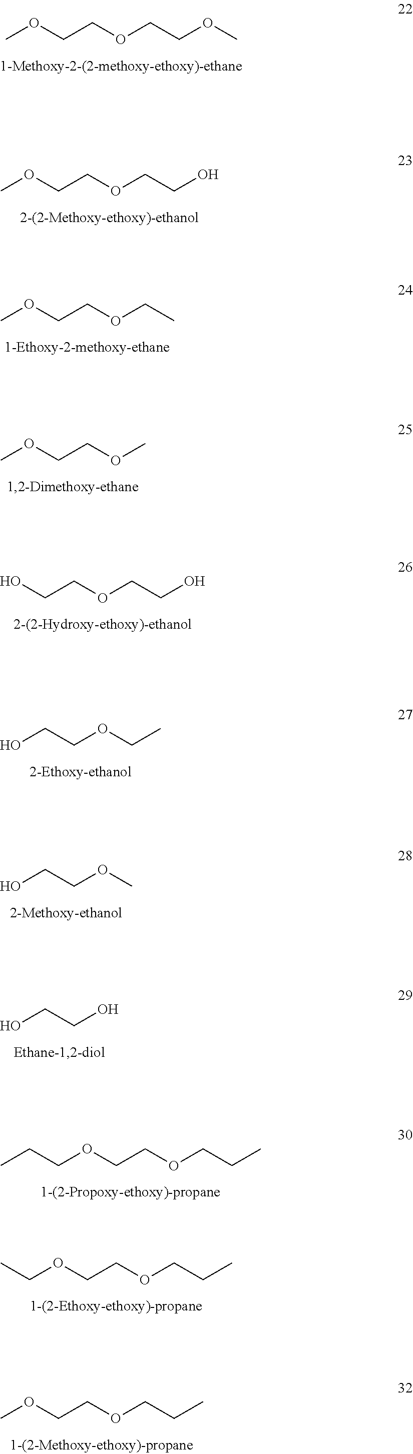

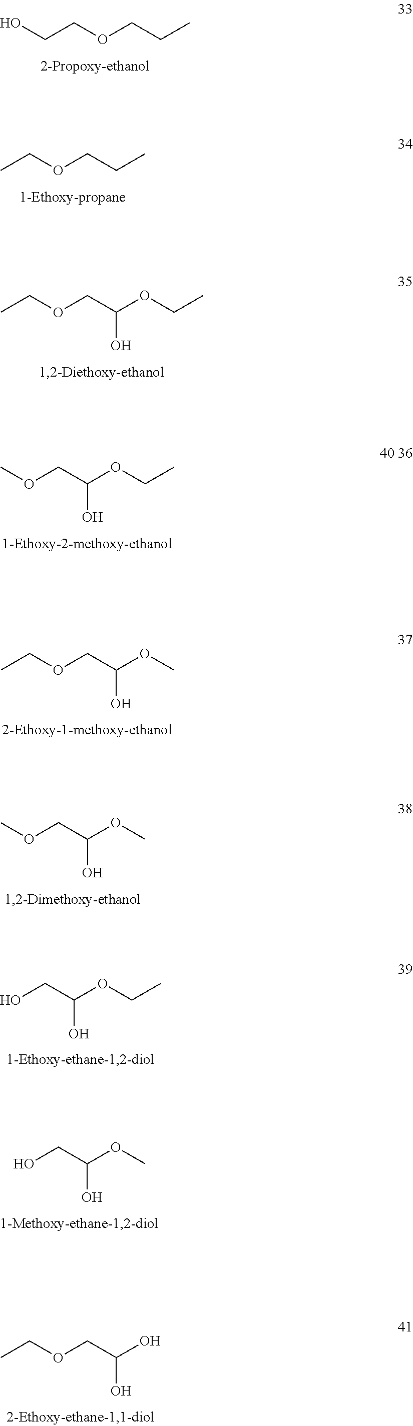

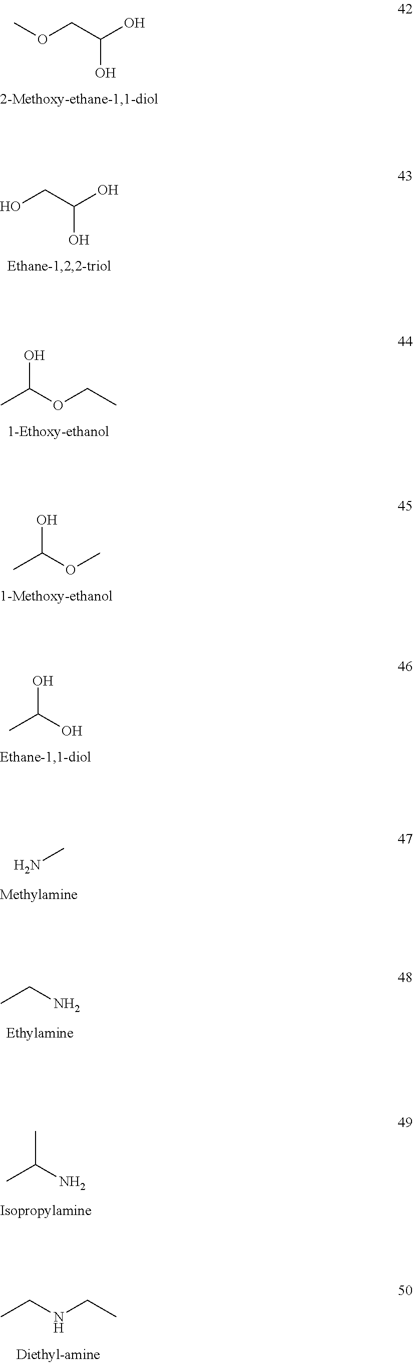

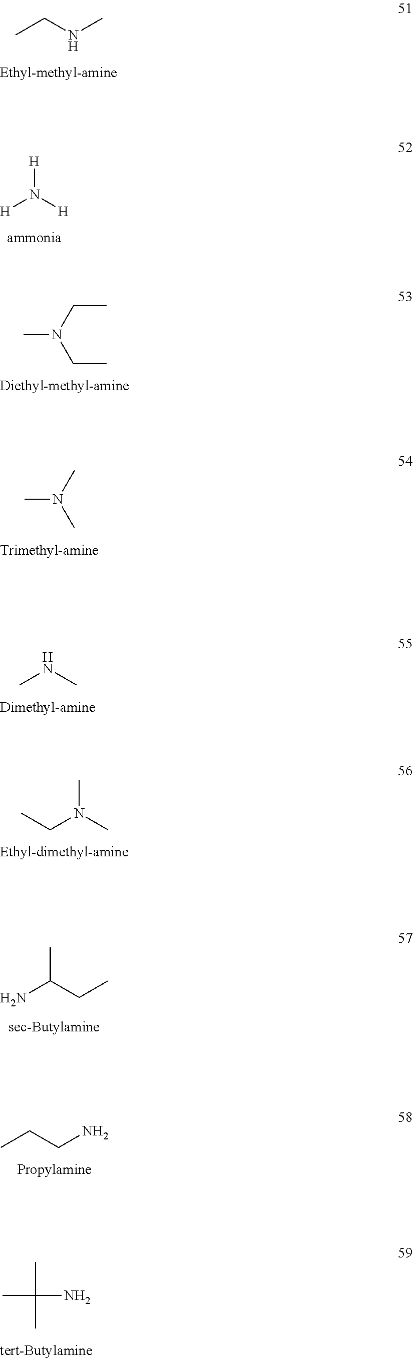

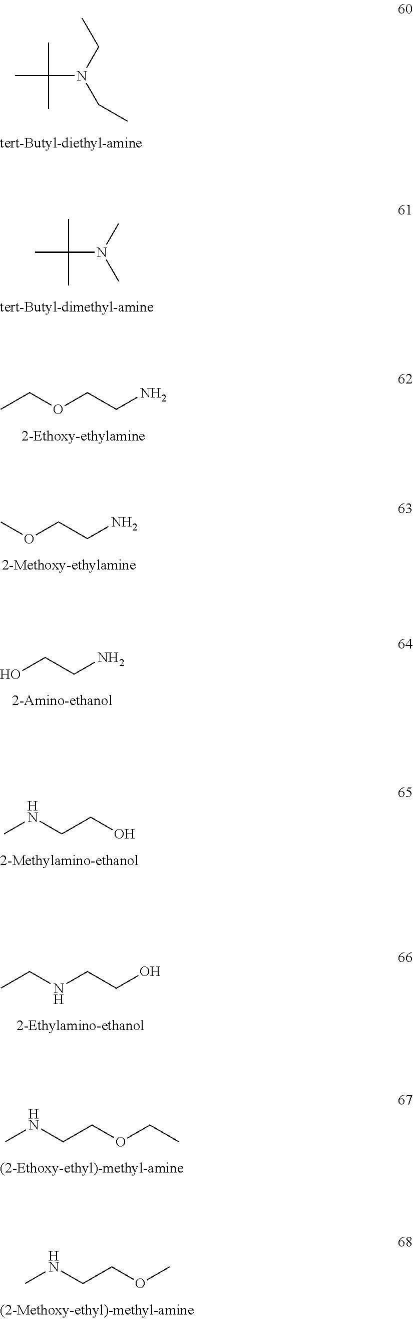

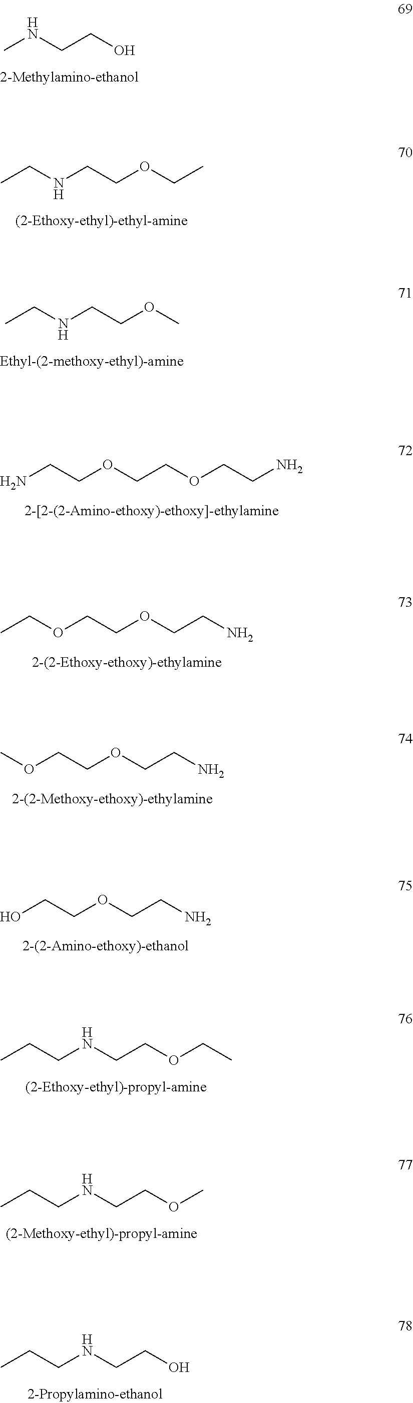

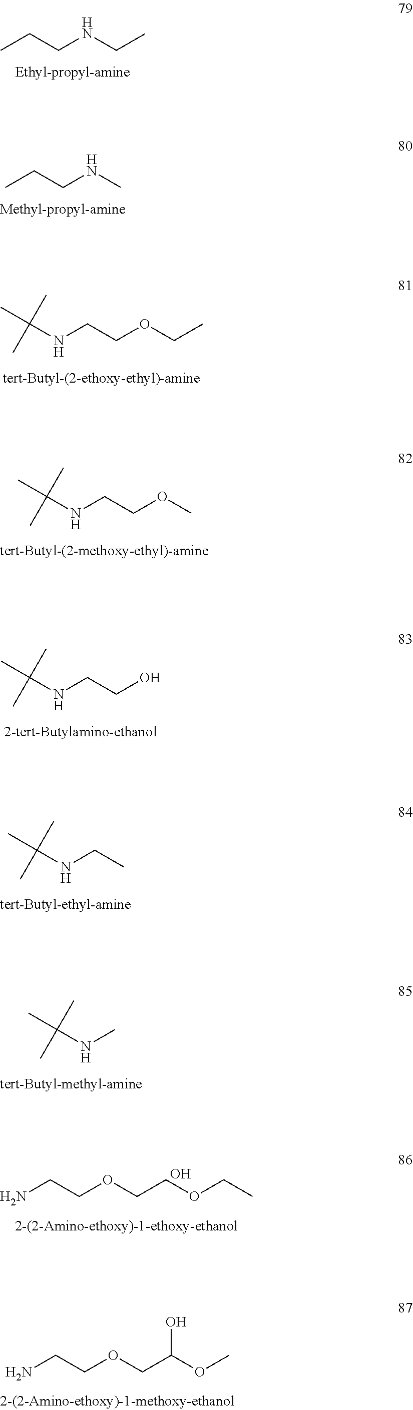

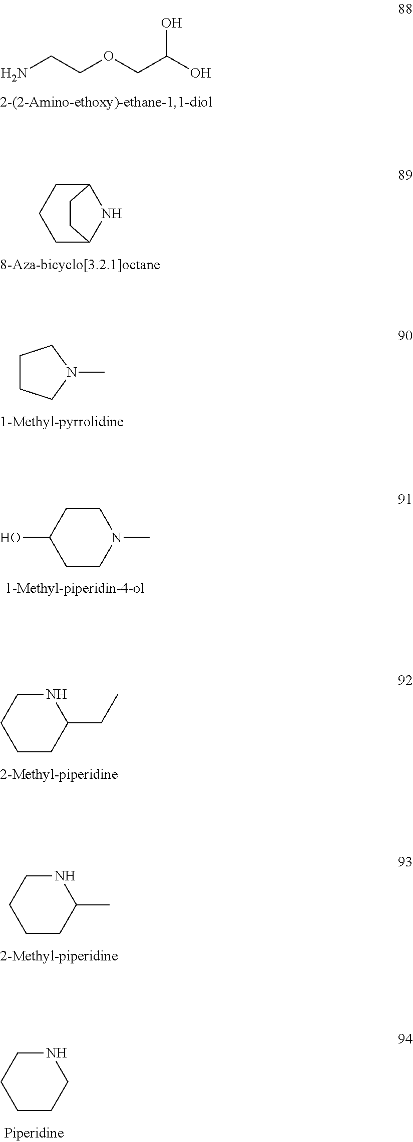

### APPENDIX 5

### Absorbents 2D Structures

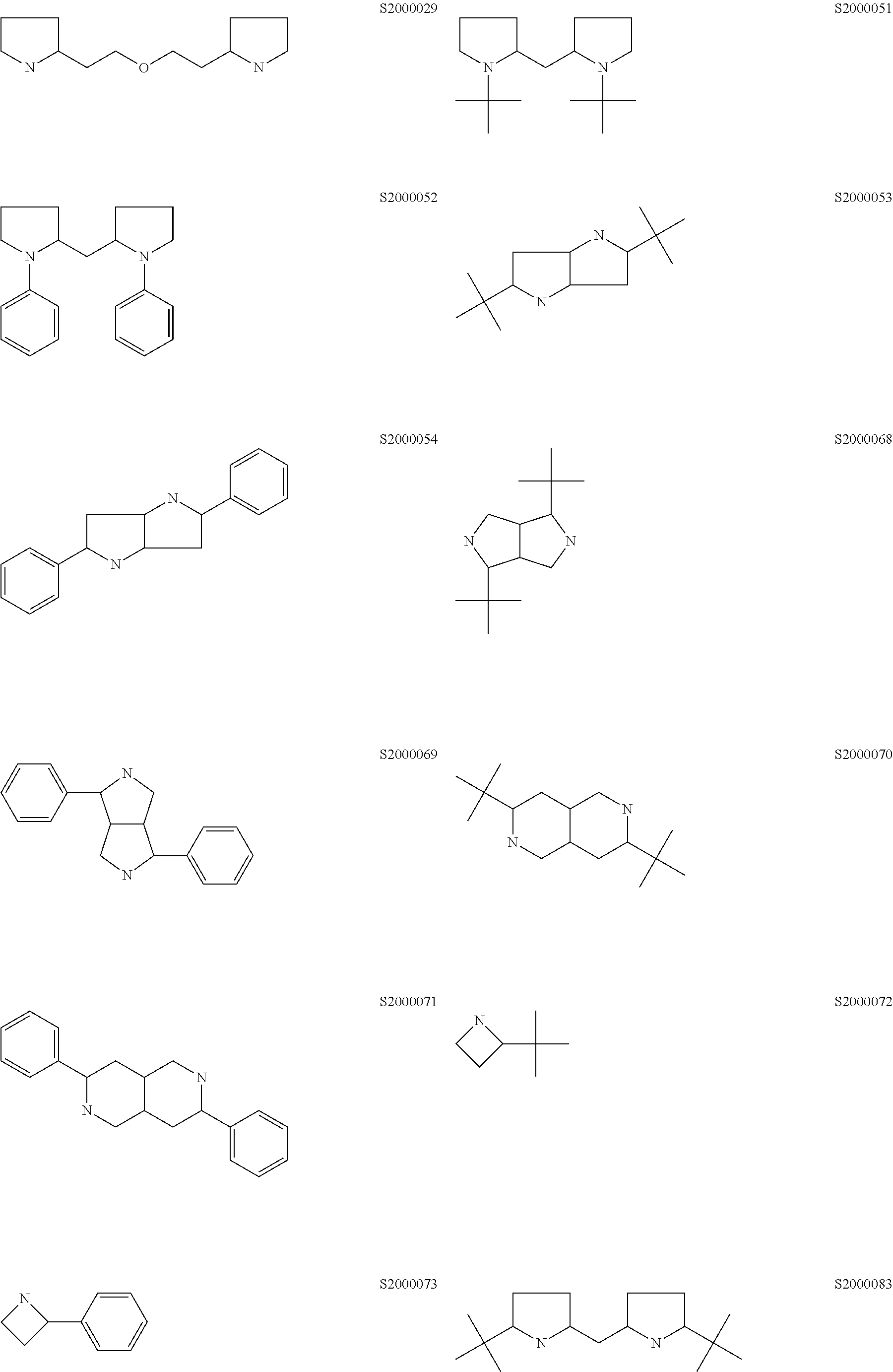

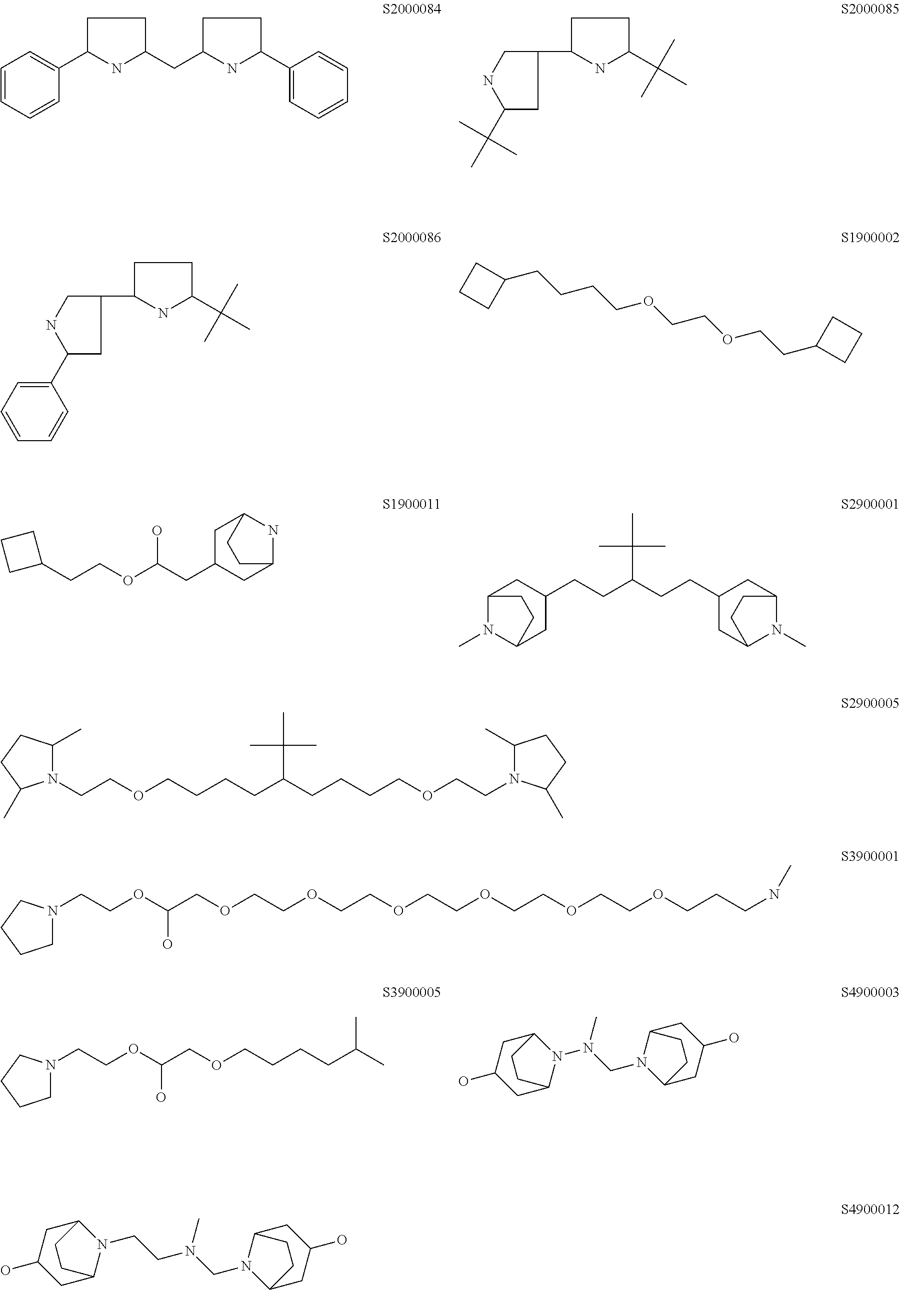

### APPENDIX 6

### Absorbents 2D Structures of 22 Compounds in “New Dataset”

| # | Compound structure |
|---|---|
| 1 | 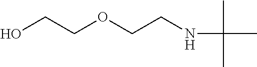 |
| 2 | 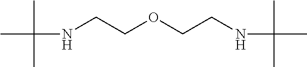 |
| 3 | 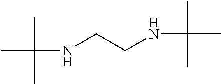 |
| 4 | 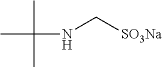 |
| 5 | 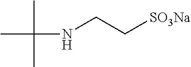 |
| 6 | 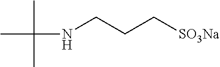 |
| 7 | 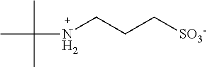 |
| 8 | 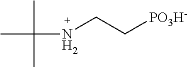 |
| 9 | 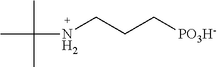 |
| 10 | 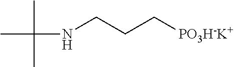 |
| 11 | 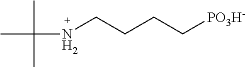 |
| 12 | 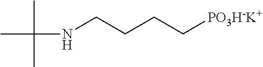 |
| 13 | N—Me₄⁺ OH⁻ |
| 14 | N—Et₄⁺ OH⁻ |
| 15 | N—Pr₄⁺ OH⁻ |
| 16 | N—Bu₄⁺ OH⁻ |
| 17 | 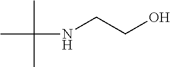 |
| 18 | 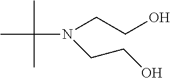 |
| 19 | 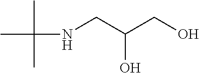 |
| 20 | 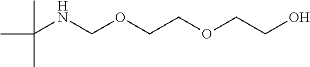 |
| 21 | 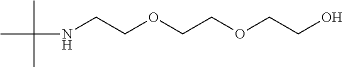 |
| 22 | 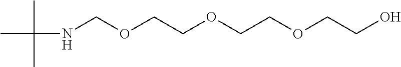 |

Wang, F. C.; Siskin, M. “Tetraorganoammonium and Tetraorganophosphonium Salts for Acid Gas Scrubbing Process,” U.S. Ser. No. 60/706,616, Aug. 9, 2005.
Wang, F. C.; Siskin, “Polyalkyleneimines and Polyalkyleneacrylamide Salt for Acid Gas Scrubbing Process,” U.S. Ser. No. 60/706,617, Aug. 9, 2005.
Siskin, M.; Mozeleski, E. J.; Fedich, R. B. “Alkylamino Alkoxy (Alcohol) Monoalkyl Ether for Acid Gas Scrubbing Process,” U.S. Ser. No. 60/706,614, Aug. 9, 2005.
Siskin, M.; Katritzky, A. R.; Wang, F. C. “Absorbent Composition Containing Molecules With a Hindered Amine and a Metal Sulfonate, Phosphonate or Carboxylate Structure for Acid Gas Scrubbing Process,” U.S. Ser. No. 60/706,615, Aug. 9, 2005.
Siskin, M.; Katritzky, A. R.; Mozeleski, E. J.; Wang, F. C. “Hindered Cyclic Polyamines and Their Salts for Acid Gas Scrubbing Process”, U.S. Ser. No. 60/706,618, Aug. 9, 2005.

### APPENDIX 7

### Whole Molecule Approach—Best Mode of Practice

The particular general form of the correlation of descriptors to P (or selectivity) can be described as follows. Let set M represent the set of known molecules and let set J represent the complete set of descriptors. A smaller subset of descriptors for inclusion in the QSPR whole molecule correlation equation is designated as J′ and is a subset of J. A linear regression technique is used to best fit the P data for molecules in set M using the descriptors of set J′ in the whole molecule QSPR equation expressed below. Pₘ represents the value of P for each of the known molecules indexed by m in set M. Dⱼₘ represents the known value of descriptor j in set J for each of the known molecules indexed by m in set M.

$$log {P}_{m} = log {P}_{0} + {\sum }_{j = {J}^{′}}^{ } {α}_{j} {D}_{jm}$$

$$∀ m ∈ M$$

A linear regression method is used to calculate the best fit values for the unknowns log P₀ and coefficient αⱼ for each of the descriptors considered. Using these coefficients, and the descriptor values for the set of defined unknown molecules, a correlated value for P can then be calculated. Molecules with attractive correlated values for P can then be tested experimentally to validate the prediction.

The search for the multiparameter regression with the maximum predicting power among a huge space of independent variables is not a trivial task. The calculation of all possible combinations of descriptors and the comparison of their statistical characteristics quickly becomes impractical with an increasing number of descriptors under consideration. The following strategy is used to choose the descriptors for consideration in set J′.
1. All orthogonal pairs that have overlapping or similar correlative properties of descriptors (i,j) are found in the complete descriptor set defined as those with a pair correlation coefficient Rᵢⱼ²<0.5. Two-parameter regression equations involving all orthogonal pairs of descriptors are calculated. Some predefined number of pairs with the highest linear regression coefficients are chosen as descriptor subsets for consideration.
2. For each of the significant descriptor subsets obtained in the previous step, an additional noncollinear descriptor is added to each, and the corresponding regression treatment performed. When a new correlation equation is found with a Fisher criterion at a given probability level, F, that is smaller than for the best correlation with one less descriptor, the best equation is chosen from the set with one less descriptor. Otherwise, the new equations with the highest regression correlation coefficients are considered further.
3. By repeating the last step we are able to continue obtaining ever higher order multilinear correlation equations.
   Therefore, the results have the maximum value of the Fisher criterion and a high value of the coefficient of determination.

Let set M represent the set of known molecules and let set J represent the complete set of descriptors. Pₘ represents the value of P for each of the known molecules indexed by m in set M.

The Molecular Fragment Approach procedure for QSPR is as follows:
1. Create two sets of molecular fragments which may be combined to form potential absorbent molecules. Set R represents substituent group fragments, and set G represents generic structure or bridge fragments that may be combined in the form of R₁-G-R₂. Considering the structural similarities of the molecules in the known molecule set, all of them were divided into distinct fragments according to the following general scheme:

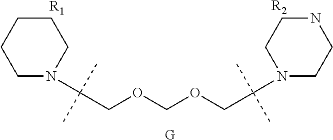

One or two components may be missing when combined to form molecules. Altogether, up to 3 fragments are applicable for each molecule potentially generated using the model. The fragments under consideration are determined by dividing the set of known molecules into parts.
2. Let the triplet (r, g, r′) represent some molecule created by combining any fragments r, r′ ∈ R and g ∈ G. Let set T be composed of all triplets that are allowed for consideration, and let tₘ be the triplet for a specific known molecule m∈M. Beginning with all combinations of (r, g, r′), triplets are removed from T if any of the following apply:
   a) There are no oxygen atoms in the molecule defined by the triplet
   b) There are no nitrogen atoms in the molecule defined by the triplet
3. Draw each of the original molecules in set M of known molecules, and each protonated fragment of sets R and G (i.e. R—H and H-G-H) and calculate the values for their molecular descriptors. These descriptor values are designated as dⱼᵣₘ^{R1}, d_{jgm}^{G}, d_{jr′m}^{R2} ∀r ∈ R,r′ ∈ R,g ∈ G,9r,g,r′)=tₘ, m ∈ M for the molecular fragments of the original known molecules and dⱼₖ ∀k ∈ R∪ G for the general set of molecular fragment values where the index j represents a descriptor.
4. Screen the set of all molecular descriptors for those that are common among all molecules of set M with known data for selectivity, vapor pressure and solubility. This set is designated as J.
5. Classify each descriptor in set J as either additive, cross product, minimum or maximum in order to designate how it will be treated in the QSPR equation. Place each descriptor into its appropriate corresponding subset J^{ADD}, J^{CP}, J^{MIN}, or J^{MAX}.
6. Use some methodology to decide on a small set of descriptors for inclusion in the QSPR fragment correlation equation. This subset of the descriptor set is designated as J′ ⊂ J. Two heuristic methods were proposed in the literature, and a new optimization method is proposed in this document.
   a) “macros structures and fragment descriptors library” based BESTREG methodology (Karelson's approach): A. R. Katritzky, V. S. Lobanov, M. Karelson, R. Murugan, M. P. Grendze, J. E. Toomey, “Comprehensive Descriptors for Structural and Statistical Analysis”, Revue Roumaine de Chimie, 1996, 41, 851-867.
   b) “substructural molecular fragments” method (Varnek's approach): V. P. Solov'ev, A. Varnek, G. Wipff, “Modeling of Ion Complexation and Extraction Using Substructural Molecular Fragments”, Journal of Chemical Information and Computer Sciences, 2000, 40(3), 847-858.
   c) A global optimization approach not previously discussed in the literatures is presented in the following section “Optimization Model for Choosing the Descriptor Set”.
7. Use a linear regression technique to best fit the P data for molecules in set M using the descriptors of set J′ in the fragment QSPR equation expressed below.

$$log {P}_{m} = log {P}_{0} + {\sum }_{j ∈ {J}^{′} ⋂ {J}^{A}}^{ } {α}_{j} {D}_{jm}^{ADD} + {\sum }_{j ∈ {J}^{′} ⋂ {J}^{CP}}^{ } {β}_{j} {D}_{jm}^{CP} + {\sum }_{j ∈ {J}^{′} ⋂ {J}^{MIN}}^{ } {γ}_{j} {D}_{jm}^{MIN} + {\sum }_{j ∈ {J}^{′} ⋂ {J}^{MAX}}^{ } {λ}_{j} {D}_{jm}^{MAX} ∀ m ∈ M$$

The derived descriptor values for the linear regression are determined from the following expressions:

Dⱼₘ^{ADD}=dⱼᵣₘ^{R1}+d_{jgm}^{G}+d_{jr′m}^{R2} ∀j ∈ J′ ∩ J^{ADD}, (r, g,r′)=tₘ,m ∈ M

Dⱼₘ^{CP}=dⱼᵣₘ^{R1}d_{jgm}^{G}+d_{jgm}^{G}d_{jr′m}^{R2} ∀j ∈ J′ ∩ J^{CP},(r,g,r′)=tₘ,m ∈ M

Dⱼₘ^{MIN}=min{dⱼᵣₘ^{R1}, d_{jgm}^{G}, d_{jr′m}^{R2}} ∀j ∈ J′ ∩ J^{MIN},(r,g,r′)=tₘ,m ∈ M

Dⱼₘ^{MAX}=max{dⱼᵣₘ^{R1}, dⱼᵣₘ^{G}, d_{jr′m}^{R2}} ∀j ∈ J′ ∩ J^{MAX},(r,g,r′)=tₘ,m ∈ M
This generates the best fit values for the unknowns log P₀ and either αⱼ, βⱼ, γⱼ, or λⱼ for each descriptor j chosen to be considered. Thus the equation for prediction of P for any given triplet t ∈ T is as follows:

$$log {\hat{P}}_{t} = log {P}_{0} + {\sum }_{j ∈ {J}^{′} ⋂ {J}^{A}}^{ } {α}_{j} ( {d}_{jr} + {d}_{jg} + {d}_{{jr}^{′}} ) + {\sum }_{j ∈ {J}^{′} ⋂ {J}^{CP}}^{ } {β}_{j} ( {d}_{jr} {d}_{jg} + {d}_{jg} {d}_{{jr}^{′}} ) + {\sum }_{j ∈ {J}^{′} ⋂ {J}^{MIN}}^{ } {γ}_{j} ( {d}_{jr} , {d}_{jg} , {d}_{{jr}^{′}} ) + {\sum }_{j ∈ {J}^{′} ⋂ {J}^{MAX}}^{ } {λ}_{j} ( {d}_{jr} , {d}_{jg} , {d}_{{jr}^{′}} ) ∀ ( r , g , {r}^{′} ) = t ∈ T$$

8. Finally, promising molecules are found by searching for the triplets with the highest value of P predicted from the equation above through explicit enumeration.

### Molecular Fragment Approach—Best Mode of Practice—Optimization Model for Choosing the Descriptor Set

Since a complete exhaustive enumeration of all possible descriptor combinations is computationally infeasible, the BESTREG and other heuristics were developed in the literature to provide methods for choosing the descriptor combinations to use in the QSPR. However, with the use of advanced mathematical programming techniques, the combination of descriptors that provides the absolute best correlation should be computationally tractable. Steps (6) and (7) of the detailed procedure outlined in the previous section would be replaced with the following process.

### Given:

Set M of molecules of known P
Values Pₘ for each molecule m∈ M
Sets R and G of all molecule fragment groups
Set T of potential molecular triplets
Triplet tₘ, for each m ∈ M
Set J of all useful molecular descriptors
Subsets J^{ADD}, J^{CP}, J^{MIN} and J^{MAX} of descriptors for treatment in the QSPR
Descriptor values
dⱼᵣₘ^{R1}, d_{jgm}^{G}, d_{jr′m}^{R2} ∀j ∈ J,r ∈ R,r′ ∈ R,g ∈ G,(r,g,r′)=tₘ,m ∈ M for the original molecules
Descriptor values dⱼₖ ∀j ∈ J,k ∈ R∪ G for the complete set of molecular fragments
Hypothesized QSPR function form

$$\to log {P}_{m} = log {P}_{0} + {\sum }_{j ∈ {J}^{′} ⋂ {J}^{A}}^{ } {α}_{j} {D}_{jm}^{ADD} + {\sum }_{j ∈ {J}^{′} ⋂ {J}^{CP}}^{ } {β}_{j} {D}_{jm}^{CP} + {\sum }_{j ∈ {J}^{′} ⋂ {J}^{MIN}}^{ } {γ}_{j} {D}_{jm}^{MIN} + {\sum }_{j ∈ {J}^{′} ⋂ {J}^{MAX}}^{ } {λ}_{j} {D}_{jm}^{MAX}$$

Find the best descriptor set J′ of size N for minimizing the least squares error for the hypothesized QSPR function.

As before, the derived descriptor values for the original molecules of set M are determined by the following expressions:

Dⱼₘ^{ADD}=dⱼᵣₘ^{R1}+d_{jgm}^{G}+d_{jr′m}^{R2} ∀j ∈ J′ ∩ J^{ADD},(r,g, r′)=tₘ,m ∈ M

Dⱼₘ^{CP}=dⱼᵣₘ^{R1}d_{jgm}^{G}+d_{jgm}^{G}d_{jr′m}^{R2} ∀j ∈ J′ ∩ J^{CP},(r,g,r′)=tₘ,m ∈ M

Dⱼₘ^{MIN}=min{dⱼᵣₘ^{R1}, d_{jgm}^{G}, d_{jr′m}^{R2}} ∀j ∈ J′ ∩ J^{MIN},(r,g,r′)=tₘ,m ∈ M

Dⱼₘ^{MAX}=max{dⱼᵣₘ^{R1}, d_{jgm}^{G}, d_{jr′m}^{R2}} ∀j ∈ J′ ∩ J^{MAX},(r,g,r′)=tₘ,m ∈ M

In the search for the highest impact combination of descriptors, the development of a least-squares error combinatorial optimization approach is proposed. The model for determining the correlation parameters of the QSPR with the N best descriptors is the following:

$$min {\sum }_{m ∈ M}^{ } {( log {P}_{m} = log {\hat{P}}_{m} )}^{2}$$

$$s . t . log {\hat{P}}_{m} = log {P}_{0} + {\sum }_{j ∈ {J}^{A}}^{ } {α}_{j} {D}_{jm}^{ADD} + {\sum }_{j ∈ {J}^{CP}}^{ } {β}_{j} {D}_{jm}^{CP} + {\sum }_{j ∈ {J}^{MIN}}^{ } {γ}_{j} {D}_{jm}^{MIN} + {\sum }_{j ∈ {J}^{MAX}}^{ } {λ}_{j} {D}_{jm}^{MAX} ∀ m ∈ M$$

$${\sum }_{j ∈ J}^{ } {z}_{j} = N$$

$${A}^{LB} {z}_{j} \leq {α}_{j} \leq {A}^{UB} {z}_{j} {∀}_{j} ∈ {J}^{ADD}$$

$${B}^{LB} {z}_{j} \leq {β}_{j} \leq {B}^{UB} {z}_{j} {∀}_{j} ∈ {J}^{CP}$$

$${Γ}^{LB} {z}_{j} \leq {γ}_{j} \leq {Γ}^{UB} {z}_{j} {∀}_{j} ∈ {J}^{MIN}$$

$${Λ}^{LB} {z}_{j} \leq {λ}_{j} \leq {Λ}^{UB} {z}_{j} {∀}_{j} ∈ {J}^{MAX}$$

$${z}_{j} ∈ \{ 0 , 1 \} {∀}_{j} ∈ J$$

This model is a convex mixed-integer quadratic programming (MIQP) problem. Commercial optimization algorithms such as CPLEX or Xpress^{MP} can be used to solve such MIQP problems, usually within a reasonable run-time since the number of binary variables is limited to the number of descriptors utilized. This approach would not only determine the optimum values for the correlation parameters for the QSPR model, but would also determine the N best descriptors that most impact the reduction of error in fitting the model to the actual data. Any descriptor j in which zⱼ=1 would be a member of the QSPR descriptor set J′.

Then a sensitivity analysis is possible with a plot of globally minimum error versus N, providing not only a “best” set of descriptors, but also a basis for evaluating whether a model is being overfit. If as N is changed the descriptors within set J′ change radically from one globally minimized solution to another, this may indicate that the proposed QSPR equation form is not a good measure for predicting selectivity and should be re-evaluated.

If the set of descriptors chosen for use by the model corresponds to the descriptor set(s) chosen using the heuristic methods such as BESTREG, these calculations would serve to provide strong mathematical evidence of the validity of those methods.

With the optimal descriptor set J′ and the values for the unknowns log P₀ and either αⱼ, βⱼ, γⱼ, or λⱼ for each descriptor j∈J, the equation for prediction of P for any given triplet t∈T is the same as in the previous section.

$log {\hat{P}}_{t} = \begin{matrix}log {P}_{0} + {\sum }_{j ∈ {J}^{′} ⋂ {J}^{A}} {α}_{j} ( {d}_{jr} + {d}_{jg} + {d}_{{jr}^{′}} ) + {\sum }_{j ∈ {J}^{′} ⋂ {J}^{CP}} {β}_{j} ( {d}_{jr} {d}_{jg} + {d}_{jg} {d}_{{jr}^{′}} ) + \\ {\sum }_{j ∈ {J}^{′} ⋂ {J}^{MIN}} {γ}_{j} \cdot min \{ {d}_{jr} , {d}_{jg} , {d}_{{jr}^{′}} \} + {\sum }_{j ∈ {J}^{′} ⋂ {J}^{MAX}} {λ}_{j} \cdot max \{ {d}_{jr} , {d}_{jg} , {d}_{{jr}^{′}} \}\end{matrix} ∀ ( r , g , {r}^{′} ) = t ∈ T$

| Mathematical Symbol | Description |
|---|---|
| ∈ | Is an element of |
| ∉ | Is not an element of |
| \ | Refers to subtraction from a set |
| ∪ | Refers to the union of sets |
| ∩ | Refers to the intersection of sets |
| Σ | Summation |
| ∀ | For all |
| = | Equal to |
| ≠ | Not equal to |
| ≦ | Less than or equal to |
| ≧ | Greater than or equal to |

### APPENDIX 8

### DESCRIPTORS Representative of Those Used in the Present Invention

0001000000 Total number of atoms
0002000000 Number of C atoms
0003000000 Number of H atoms
0004000000 Number of O atoms
0005000000 Number of N atoms
0006000000 Number of S atoms
0007000000 Number of F atoms
0008000000 Number of Cl atoms
0009000000 Number of Br atoms
0010000000 Number of I atoms
0011000000 Number of P atoms
0012000000 Number of other atoms
0013000000 Relative number of C atoms
0014000000 Relative number of H atoms
0015000000 Relative number of O atoms
0016000000 Relative number of N atoms
0017000000 Relative number of S atoms
0018000000 Relative number of F atoms
0019000000 Relative number of Cl atoms
0020000000 Relative number of Br atoms
0021000000 Relative number of I atoms
0022000000 Relative number of P atoms
0023000000 Relative number of others atoms
0024000000 Total number of bonds
0025000000 Number of single bonds
0026000000 Number of double bonds
0027000000 Number of triple bonds
0028000000 Number of aromatic bonds
0029000000 Relative number of single bonds
0030000000 Relative number of double bonds
0031000000 Relative number of triple bonds
0032000000 Relative number of aromatic bonds
0033000000 Number of rings
0034000000 Number of benzene rings
0035000000 Relative number of rings
0036000000 Relative number of benzene rings
0037000000 Molecular weight
0038000000 Average atom weight
0039000000 Wiener index
0040000000 Randic index (order 0)
0041000000 Randic index (order 1)
0042000000 Randic index (order 2)
0043000000 Randic index (order 3)
0044000000 Kier&Hall index (order 0)
0045000000 Kier&Hall index (order 1)
0046000000 Kier&Hall index (order 2)
0047000000 Kier&Hall index (order 3)
0048000000 Information content (order 0)
0049000000 Information content (order 1)
0050000000 Information content (order 2)
0051000000 Average Information content (order 0)
0052000000 Average Information content (order 1)
0053000000 Average Information content (order 2)
0054000000 Structural Information content (order 0)
0055000000 Structural Information content (order 1)
0056000000 Structural Information content (order 2)
0057000000 Average Structural Information content (order 0)
0058000000 Average Structural Information content (order 1)
0059000000 Average Structural Information content (order 2)
0060000000 Complementary Information content (order 0)
0061000000 Complementary Information content (order 1)
0062000000 Complementary Information content (order 2)
0063000000 Average Complementary Information content (order 0)
0064000000 Average Complementary Information content (order 1)
0065000000 Average Complementary Information content (order 2) to
0066000000 Bonding Information content (order 0)
0067000000 Bonding Information content (order 1)
0068000000 Bonding Information content (order 2)
0069000000 Average Bonding Information content (order 0)
0070000000 Average Bonding Information content (order 1)
0071000000 Average Bonding Information content (order 2)
0072000000 Kier shape index (order 1)
0073000000 Kier shape index (order 2)
0074000000 Kier shape index (order 3)
0075000000 Kier flexibility index
0076000000 Balaban index
0077000000 Gravitation index (all bonds)
0078000000 Gravitation index (all atoms' pairs)
0079000000 Moments of inertia A
0080000000 Moments of inertia B
0081000000 Moments of inertia C
0082000000 Shadow plane XY
0083000000 Shadow plane YZ
0084000000 Shadow plane ZX
0085000000 XY Shadow/XY Rectangle
0086000000 YZ Shadow/YZ Rectangle
0087000000 ZX Shadow/ZX Rectangle
0088000000 Molecular volume
0089000000 Molecular volume/XYZ Box
0090000000 Molecular surface area
0091001000 Max partial charge (Zefirov) for atoms for atom H
0091006000 Max partial charge (Zefirov) for atoms for atom C
0091007000 Max partial charge (Zefirov) for atoms for atom N
0091008000 Max partial charge (Zefirov) for atoms for atom O
0092001000 Min partial charge (Zefirov) for atoms for atom H
0092006000 Min partial charge (Zefirov) for atoms for atom C
0092007000 Min partial charge (Zefirov) for atoms for atom N
0092008000 Min partial charge (Zefirov) for atoms for atom O
0093000000 Max partial charge (Zefirov) for all atom types
0094000000 Min partial charge (Zefirov) for all atom types
0095000000 Polarity parameter (Zefirov)
0096000000 Polarity parameter/square distance (Zefirov)
0097000000 Topographic electronic index (all pairs)
0098000000 Topographic electronic index (all bonds)
0099000000 TMSA Total molecular surface area (Zefirov PC)
0100000000 PPSA1 Partial positive surface area (Zefirov PC)
0101000000 PPSA2 Total charge weighted PPSA (Zefirov PC)
0102000000 PPSA3 Atomic charge weighted PPSA (Zefirov PC)
0103000000 PNSA1 Partial negative surface area (Zefirov PC)
0104000000 PNSA2 Total charge weighted PNSA (Zefirov PC)
0105000000 PNSA3 Atomic charge weighted PNSA (Zefirov PC)
0106000000 DPSA1 Difference in CPSAs (PPSA1-PNSA1) (Zefirov PC)
0107000000 DPSA2 Difference in CPSAs (PPSA2-PNSA2) (Zefirov PC)
0108000000 DPSA3 Difference in CPSAs (PPSA3-PNSA3) (Zefirov PC)
0109000000 FPSA1 Fractional PPSA (PPSA-1/TMSA) (Zefirov PC)
0110000000 FPSA2 Fractional PPSA (PPSA-2/TMSA) (Zefirov PC)
0111000000 FPSA3 Fractional PPSA (PPSA-3/TMSA) (Zefirov PC)
0112000000 FNSA1 Fractional PNSA (PNSA-1/TMSA) (Zefirov PC)
0113000000 FNSA2 Fractional PNSA (PNSA-2/TMSA) (Zefirov PC)
0114000000 FNSA3 Fractional PNSA (PNSA-3/TMSA) (Zefirov PC)
0115000000 WPSA1 Weighted PPSA (PPSA1*TMSA/1000) (Zefirov PC)
0116000000 WPSA2 Weighted PPSA (PPSA2*TMSA/1000) (Zefirov PC)
0117000000 WPSA3 Weighted PPSA (PPSA3*TMSA/1000) (Zefirov PC)
0118000000 WNSA1 Weighted PNSA (PNSA1*TMSA/1000) (Zefirov PC)
0119000000 WNSA2 Weighted PNSA (PNSA2*TMSA/1000) (Zefirov PC)
0120000000 WNSA3 Weighted PNSA (PNSA3*TMSA/1000) (Zefirov PC)
0121000000 RPCG Relative positive charge (QMPOS/QTPLUS) (Zefirov PC)
0122000000 RNCG Relative negative charge (QMNEG/QTMINUS) (Zefirov PC)
0123000000 RPCS Relative positive charged SA (SAMPOS*RPCG) (Zefirov PC)
0124000000 RNCS Relative negative charged SA (SAMNEG*RNCG) (Zefirov PC)
0125000000 HDSA H-donors surface area (Zefirov PC)
0126000000 HDCA H-donors charged surface area (Zefirov PC)
0127000000 FHDSA Fractional HDSA (HDSA/TMSA) (Zefirov PC)
0128000000 FHDCA Fractional HDCA (HDCA/TMSA) (Zefirov PC)
0129000000 HASA H-acceptors surface area (Zefirov PC)
0130000000 HACA H-acceptors charged surface area (Zefirov PC)
0131000000 FHASA Fractional HASA (HASA/TMSA) (Zefirov PC)
0132000000 FHACA Fractional HACA (HACA/TMSA) (Zefirov PC)
0133000000 HBSA H-bonding surface area (Zefirov PC)
0134000000 HBCA H-bonding charged surface area (Zefirov PC)
0135000000 FHBSA Fractional HBSA (HBSA/TMSA) (Zefirov PC)
0136000000 FHBCA Fractional HBSA (HBSA/TMSA) (Zefirov PC)
0137000000 min(#HA, #HD) (Zefirov PC)
0138000000 count of H-acceptor sites (Zefirov PC)
0139000000 count of H-donors sites (Zefirov PC)
0140000000 HA dependent HDSA-1 (Zefirov PC)
0141000000 HA dependent HDSA-1/TMSA (Zefirov PC)
0142000000 HA dependent HDSA-2 (Zefirov PC)
0143000000 HA dependent HDSA-2/TMSA (Zefirov PC)
0144000000 HA dependent HDSA-2/SQRT(TMSA) (Zefirov PC)
0145000000 HA dependent HDCA-1 (Zefirov PC)
0146000000 HA dependent HDCA-1/TMSA (Zefirov PC)
0147000000 HA dependent HDCA-2 (Zefirov PC)
0148000000 HA dependent HDCA-2/TMSA (Zefirov PC)
0149000000 HA dependent HDCA-2/SQRT(TMSA) (Zefirov PC)
0150000000 HASA-1 (Zefirov PC)
0151000000 HASA-1/TMSA (Zefirov PC)
0152000000 HASA-2 (Zefirov PC)
0153000000 HASA-2/TMSA (Zefirov PC)
0154000000 HASA-2/SQRT(TMSA) (Zefirov PC)
0155000000 HACA-1 (Zefirov PC)
0156000000 HACA-1/TMSA (Zefirov PC)
0157000000 HACA-2 (Zefirov PC)
0158000000 HACA-2/TMSA (Zefirov PC)
0159000000 HACA-2/SQRT(TMSA) (Zefirov PC)
0161000000 PPSA-1 Partial positive surface area (MOPAC PC)
0162000000 PPSA-2 Total charge weighted PPSA (MOPAC PC)
0163000000 PPSA-3 Atomic charge weighted PPSA (MOPAC PC)
0164000000 PNSA-1 Partial negative surface area (MOPAC PC)
0165000000 PNSA-2 Total charge weighted PNSA (MOPAC PC)
0166000000 PNSA-3 Atomic charge weighted PNSA (MOPAC PC)
0167000000 DPSA-1 Difference in CPSAs (PPSA1-PNSA1) (MOPAC PC)
0168000000 DPSA-2 Difference in CPSAs (PPSA2-PNSA2) (MOPAC PC)
0169000000 DPSA-3 Difference in CPSAs (PPSA3-PNSA3) (MOPAC PC)
0170000000 FPSA-1 Fractional PPSA (PPSA-1/TMSA) (MOPAC PC)
0171000000 FPSA-2 Fractional PPSA (PPSA-2/TMSA) (MOPAC PC)
0172000000 FPSA-3 Fractional PPSA (PPSA-3/TMSA) (MOPAC PC)
0173000000 FNSA-1 Fractional PNSA (PNSA-1/TMSA) (MOPAC PC)
0174000000 FNSA-2 Fractional PNSA (PNSA-2/TMSA) (MOPAC PC)
0175000000 FNSA-3 Fractional PNSA (PNSA-3/TMSA) (MOPAC PC)
0176000000 WPSA-1 Weighted PPSA (PPSA1*TMSA/1000) (MOPAC PC)
0177000000 WPSA-2 Weighted PPSA (PPSA2*TMSA/1000) (MOPAC PC)
0178000000 WPSA-3 Weighted PPSA (PPSA3*TMSA/1000) (MOPAC PC)
0179000000 WNSA-1 Weighted PNSA (PNSA1*TMSA/1000) (MOPAC PC)
0180000000 WNSA-2 Weighted PNSA (PNSA2*TMSA/1000) (MOPAC PC)
0181000000 WNSA-3 Weighted PNSA (PNSA3*TMSA/1000) (MOPAC PC)
0182000000 RPCG Relative positive charge (QMPOS/QTPLUS) (MOPAC C)
0183000000 RNCG Relative negative charge (QMNEG/QTMINUS) (MOPAC PC)
0184000000 RPCS Relative positive charged SA (SAMPOS*RPCG) (MOPAC PC)
0185000000 RNCS Relative negative charged SA (SAMNEG*RNCG) (MOPAC PC)
0186000000 HDSA H-donors surface area (MOPAC PC)
0187000000 HDCA H-donors charged surface area (MOPAC PC)
0188000000 FHDSA Fractional HDSA (HDSA/TMSA) (MOPAC PC)
0189000000 FHDCA Fractional HDCA (HDCA/TMSA) (MOPAC PC)
0190000000 HASA H-acceptors surface area (MOPAC PC)
0191000000 HACA H-acceptors charged surface area (MOPAC PC)
0192000000 FHASA Fractional HASA (HASA/TMSA) (MOPAC PC)
0193000000 FHACA Fractional HACA (HACA/TMSA) (MOPAC PC)
0194000000 HBSA H-bonding surface area (MOPAC PC)
0195000000 HBCA H-bonding charged surface area (MOPAC PC)
0196000000 FHBSA Fractional HBSA (HBSA/TMSA) (MOPAC PC)
0197000000 FHBCA Fractional HBSA (HBSA/TMSA) (MOPAC PC)
0198000000 min(#HA, #HD) (MOPAC PC)
0199000000 count of H-acceptor sites (MOPAC PC)
0200000000 count of H-donors sites (MOPAC PC)
0201000000 HA dependent HDSA-1 (MOPAC PC)
0202000000 HA dependent HDSA-1/TMSA (MOPAC PC)
0203000000 HA dependent HDSA-2 (MOPAC PC)
0204000000 HA dependent HDSA-2/TMSA (MOPAC PC)
0205000000 HA dependent HDSA-2/SQRT(TMSA) (MOPAC PC)
0206000000 HA dependent HDCA-1 (MOPAC PC)
0207000000 HA dependent HDCA-1/TMSA (MOPAC PC)
0208000000 HA dependent HDCA-2 (MOPAC PC)
0209000000 HA dependent HDCA-2/TMSA (MOPAC PC)
0210000000 HA dependent HDCA-2/SQRT(TMSA) (MOPAC PC)
0211000000 HASA-1 (MOPAC PC)
0212000000 HASA-1/TMSA (MOPAC PC)
0213000000 HASA-2 (MOPAC PC)
0214000000 HASA-2/TMSA (MOPAC PC)
0215000000 HASA-2/SQRT(TMSA) (MOPAC PC)
0216000000 HACA-1 (MOPAC PC)
0217000000 HACA-1/TMSA (MOPAC PC)
0218000000 HACA-2 (MOPAC PC)
0219000000 HACA-2/TMSA (MOPAC PC)
0220000000 HACA-2/SQRT(TMSA) (MOPAC PC)
0283000000 Final heat of formation
0284000000 Final heat of formation/#atoms
0285000000 No. of occupied electronic levels
0286000000 No. of occupied electronic levels/#atoms
0287000000 HOMO-1 energy
0288000000 HOMO energy
0289000000 LUMO energy
0290000000 LUMO+1 energy
0291000000 HOMO−LUMO energy gap
0292006000 Min nucleoph. react. index for atom C
0292007000 Min nucleoph. react. index for atom N
0292008000 Min nucleoph. react. index for atom O
0293006000 Max nucleoph. react. index for atom C
0293007000 Max nucleoph. react. index for atom N
0293008000 Max nucleoph. react. index for atom O
0294006000 Avg nucleoph. react. index for atom C
0294007000 Avg nucleoph. react. index for atom N
0294008000 Avg nucleoph. react. index for atom O
0295006000 Min electroph. react. index for atom C
0295007000 Min electroph. react. index for atom N
0295008000 Min electroph. react. index for atom O
0296006000 Max electroph. react. index for atom C
0296007000 Max electroph. react. index for atom N
0296008000 Max electroph. react. index for atom O
0297006000 Avg electroph. react, index for atom C
0297007000 Avg electroph. react. index for atom N
0297008000 Avg electroph. react. index for atom O
0298006000 Min 1-electron react. index for atom C
0298007000 Min 1-electron react. index for atom N
0298008000 Min 1-electron react. index for atom O
0299006000 Max 1-electron react. index for atom C
0299007000 Max 1-electron react. index for atom N
0299008000 Max 1-electron react. index for atom O
0300006000 Avg 1-electron react. index for atom C
0300007000 Avg 1-electron react. index for atom N
0300008000 Avg 1-electron react. index for atom O
0301000000 Tot point-charge comp. of the molecular dipole
0302000000 Tot hybridization comp. of the molecular dipole
0303000000 Tot dipole of the molecule
0305000000 Image of the Onsager-Kirkwood solvation energy
0306000000 Min atomic orbital electronic population
0307000000 Max atomic orbital electronic population
0308000000 Max SIGMA-SIGMA bond order
0309000000 Max SIGMA-PI bond order
0310000000 Max PI—PI bond order
0311000000 Max bonding contribution of one MO
0312000000 Max antibonding contribution of one MO
0313001000 Min valency for atom H
0313006000 Min valency for atom C
0313007000 Min valency for atom N
0313008000 Min valency for atom O
0314001000 Max valency for atom H
0314006000 Max valency for atom C
0314007000 Max valency for atom N
0314008000 Max valency for atom O
0315001000 Avg valency for atom H
0315006000 Avg valency for atom C
0315007000 Avg valency for atom N
0315008000 Avg valency for atom O
0316001000 Min (>0.1) bond order for atom H
0316006000 Min (>0.1) bond order for atom C
0316007000 Min (>0.1) bond order for atom N
0316008000 Min (>0.1) bond order for atom O
0317001000 Max bond order for atom H
0317006000 Max bond order for atom C
0317007000 Max bond order for atom N
0317008000 Max bond order for atom O
0318001000 Avg bond order for atom H
0318006000 Avg bond order for atom C
0318007000 Avg bond order for atom N
0318008000 Avg bond order for atom O
0319001000 Min e-e repulsion for atom H
0319006000 Min e-e repulsion for atom C
0319007000 Min e-e repulsion for atom N
0319008000 Min e-e repulsion for atom O
0320001000 Max e-e repulsion for atom H
0320006000 Max e-e repulsion for atom C
0320007000 Max e-e repulsion for atom N
0320008000 Max e-e repulsion for atom O
0321001000 Min e-n attraction for atom H
0321006000 Min e-n attraction for atom C
0321007000 Min e-n attraction for atom N
0321008000 Min e-n attraction for atom O
0322001000 Max e-n attraction for atom H
0322006000 Max e-n attraction for atom C
0322007000 Max e-n attraction for atom N
0322008000 Max e-n attraction for atom O
0323001000 Min atomic state energy for atom H
0323006000 Min atomic state energy for atom C
0323007000 Min atomic state energy for atom N
0323008000 Min atomic state energy for atom O
0324001000 Max atomic state energy for atom H
0324006000 Max atomic state energy for atom C
0324007000 Max atomic state energy for atom N
0324008000 Max atomic state energy for atom O
0325001006 Min resonance energy for bond H—C
0325001007 Min resonance energy for bond H—N
0325001008 Min resonance energy for bond H—O
0325006006 Min resonance energy for bond C—C
0325006007 Min resonance energy for bond C—N
0325006008 Min resonance energy for bond C—O
0326001006 Max resonance energy for bond H—C
0326001007 Max resonance energy for bond H—N
0326001008 Max resonance energy for bond H—O
0326006006 Max resonance energy for bond C—C
0326006007 Max resonance energy for bond C—N
0326006008 Max resonance energy for bond C—O
0327001006 Min exchange energy for bond H—C
0327001007 Min exchange energy for bond H—N
0327001008 Min exchange energy for bond H—O
0327006006 Min exchange energy for bond C—C
0327006007 Min exchange energy for bond C—N
0327006008 Min exchange energy for bond C—O
0328001006 Max exchange energy for bond H—C
0328001007 Max exchange energy for bond H—N
0328001008 Max exchange energy for bond H—O
0328006006 Max exchange energy for bond C—C
0328006007 Max exchange energy for bond C—N
0328006008 Max exchange energy for bond C—O
0329001006 Min e-e repulsion for bond H—C
0329001007 Min e-e repulsion for bond H—N
0329001008 Min e-e repulsion for bond H—O
0329006006 Min e-e repulsion for bond C—C
0329006007 Min e-e repulsion for bond C'N
0329006008 Min e-e repulsion for bond C—O
0330001006 Max e-e repulsion for bond H—C
0330001007 Max e-e repulsion for bond H—N
0330001008 Max e-e repulsion for bond H—O
0330006006 Max e-e repulsion for bond C—C
0330006007 Max e-e repulsion for bond C—N
0330006008 Max e-e repulsion for bond C—O
0331001006 Min e-n attraction for bond H—C
0331001007 Min e-n attraction for bond H—N
0331001008 Min e-n attraction for bond H—O
0331006006 Min e-n attraction for bond C—C
0331006007 Min e-n attraction for bond C—N
0331006008 Min e-n attraction for bond C—O
0332001006 Max e-n attraction for bond H—C
0332001007 Max e-n attraction for bond H—N
0332001008 Max e-n attraction for bond H—O
0332006006 Max e-n attraction for bond C—C
0332006007 Max e-n attraction for bond C—N
0332006008 Max e-n attraction for bond C—O
0333001006 Min n-n repulsion for bond H—C
0333001007 Min n-n repulsion for bond H—N
0333001008 Min n-n repulsion for bond H—O
0333006006 Min n-n repulsion for bond C—C
0333006007 Min n-n repulsion for bond C—N
0333006008 Min n-n repulsion for bond C—O
0334001006 Max n-n repulsion for bond H—C
0334001007 Max n-n repulsion for bond H—N
0334001008 Max n-n repulsion for bond H—O
0334006006 Max n-n repulsion for bond C—C
0334006007 Max n-n repulsion for bond C—N
0334006008 Max n-n repulsion for bond C—O
0335001006 Min coulombic interaction for bond H—C
0335001007 Min coulombic interaction for bond H—N
0335001008 Min coulombic interaction for bond H—O
0335006006 Min coulombic interaction for bond C—C
0335006007 Min coulombic interaction for bond C—N
0335006008 Min coulombic interaction for bond C—O
0336001006 Max coulombic interaction for bond H—C
0336001007 Max coulombic interaction for bond H—N
0336001008 Max coulombic interaction for bond H—O
0336006006 Max coulombic interaction for bond C—C
0336006007 Max coulombic interaction for bond C—N
0336006008 Max coulombic interaction for bond C—O
0337001006 Min total interaction for bond H—C
0337001007 Min total interaction for bond H—N
0337001008 Min total interaction for bond H—O
0337006006 Min total interaction for bond C—C
0337006007 Min total interaction for bond C—N
0337006008 Min total interaction for bond C—O
0338001006 Max total interaction for bond H—C
0338001007 Max total interaction for bond H—N
0338001008 Max total interaction for bond H—O
0338006006 Max total interaction for bond C—C
0338006007 Max total interaction for bond C—N
0338006008 Max total interaction for bond C—O
0339000000 Tot molecular 1-center E-N attraction
0340000000 Tot molecular 1-center E-N attraction/# of atoms
0341000000 Tot molecular 1-center E-E repulsion
0342000000 Tot molecular 1-center E-E repulsion/# of atoms
0343000000 Tot molecular 2-center resonance energy
0344000000 Tot molecular 2-center resonance energy/# of atoms
0345000000 Tot molecular 2-center exchange energy
0346000000 Tot molecular 2-center exchange energy/# of atoms
0347000000 Tot molecular electrostatic interaction
0348000000 Tot molecular electrostatic interaction/# of atoms
0349000000 Principal moment of inertia A
0350000000 Relative principal moment of inertia A
0351000000 Principal moment of inertia B
0352000000 Relative principal moment of inertia B
0353000000 Principal moment of inertia C
0354000000 Relative principal moment of inertia C
0355000000 Max atomic force constant
0356000000 Zero point vibrational energy
0357000000 Zero point vibrational energy/natoms
0358000000 Lowest normal mode vib frequency
0359000000 Highest normal mode vib frequency
0360000000 Highest normal mode vib transition dipole
0361000000 Thermodynamic heat of formation of the molecule at 300K
0362000000 Thermodynamic heat of formation of the molecule at 300K/natoms
0363000000 Vib enthalpy (300K)
0364000000 Vib enthalpy (300K)/natoms
0365000000 Vib heat capacity (300K)
0366000000 Vib heat capacity (300K)/natoms
0367000000 Vib entropy (300K)
0368000000 Vib entropy (300K)/natoms
0369000000 Rot enthalpy (300K)
0370000000 Rot enthalpy (300K)/natoms
0371000000 Rot heat capacity (300K)
0372000000 Rot heat capacity (300K)/natoms
0373000000 Rot entropy (300K)
0374000000 Rot entropy (300K)/natoms
0375000000 Internal enthalpy (300K)
0376000000 Internal enthalpy (300K)/natoms
0377000000 Internal heat capacity (300K)
0378000000 Internal heat capacity (300K)/natoms
0379000000 Internal entropy (300K)
0380000000 Internal entropy (300K)/natoms
0381000000 Translational enthalpy (300K)
0382000000 Translational enthalpy (300K)/natoms
0383000000 Translational heat capacity (300K)
0384000000 Translational heat capacity (300K)/natoms
0385000000 Translational entropy (300K)
0386000000 Translational entropy (300K)/natoms
0387000000 Tot enthalpy (300K)
0388000000 Tot enthalpy (300K)/natoms
0389000000 Tot heat capacity (300K)
0390000000 Tot heat capacity (300K)/natoms
0391000000 Tot entropy (300K)
0392000000 Tot entropy (300K)/natoms
0393000000 ALFA polarizability (DIP)
0394000000 1× BETA polarizability (DIP)
0395000000 (½)× BETA polarizability (DIP)
0396000000 1× GAMMA polarizability (DIP)
0397000000 (⅙)× GAMMA polarizability (DIP)
0398001000 Min net atomic charge (typed) for atom H
0398006000 Min net atomic charge (typed) for atom C
0398007000 Min net atomic charge (typed) for atom N
0398008000 Min net atomic charge (typed) for atom O
0399001000 Max net atomic charge (typed) for atom H
0399006000 Max net atomic charge (typed) for atom C
0399007000 Max net atomic charge (typed) for atom N
0399008000 Max net atomic charge (typed) for atom O
0402000000 Min net atomic charge
0403000000 Max net atomic charge
0404000000 H-acceptors PSA (version 2)
0405000000 H-acceptors CPSA (version 2)
0406000000 H-acceptors FPSA (version 2)
0407000000 H-acceptors FCPSA (version 2)
0408000000 H-donors PSA (version 2)
0409000000 H-donors CPSA (version 2)
0410000000 H-donors FPSA (version 2)
0411000000 H-donors FCPSA (version 2)
0412000000 Positively Charged Surface Area (Zefirov's PC)
0413000000 Positively Charged Partial Surface Area (Zefirov's PC)
0414000000 Positively Charged Part of Charged Surface Area (Zefirov's PC)
0415000000 Positively Charged Part of Partial Charged Surface Area (Zefirov's PC)
0416000000 Negatively Charged Surface Area (Zefirov's PC)
0417000000 Negatively Charged Partial Surface Area (Zefirov's PC)
0418000000 Negatively Charged Part of Charged Surface Area (Zefirov's PC)
0419000000 Negatively Charged Part of Partial Charged Surface Area (Zefirov's PC)
0420000000 Difference (Pos−Neg) in Charged Surface Areas (Zefirov's PC)
0421000000 Difference (Pos−Neg) in Charged Partial Surface Area (Zefirov's PC)
0422000000 Difference (Pos−Neg) in Charged Part of Charged Surface Area (Zefirov's PC)
0423000000 Difference (Pos−Neg) in Charged Part of Partial Charged Surface Area (Zefirov's PC)
0424001000 Surface Area for atom H
0424006000 Surface Area for atom C
0424007000 Surface Area for atom N
0424008000 Surface Area for atom O
0425001000 Partial Surface Area for atom H
0425006000 Partial Surface Area for atom C
0425007000 Partial Surface Area for atom N
0425008000 Partial Surface Area for atom O
0426001000 Charged Surface Area for atom H
0426006000 Charged Surface Area for atom C
0426007000 Charged Surface Area for atom N
0426008000 Charged Surface Area for atom O
0427001000 Partial Charged Surface Area for atom H
0427006000 Partial Charged Surface Area for atom C
0427007000 Partial Charged Surface Area for atom N
0427008000 Partial Charged Surface Area for atom O
0428001000 Square root of Surface Area for atom H
0428006000 Square root of Surface Area for atom C
0428007000 Square root of Surface Area for atom N
0428008000 Square root of Surface Area for atom O
0429001000 Square root of Partial Surface Area for atom H
0429006000 Square root of Partial Surface Area for atom C
0429007000 Square root of Partial Surface Area for atom N
0429008000 Square root of Partial Surface Area for atom O
0430001000 Square root of Charged Surface Area for atom H
0430006000 Square root of Charged Surface Area for atom C
0430007000 Square root of Charged Surface Area for atom N
0430008000 Square root of Charged Surface Area for atom O
0431001000 Square root of Partial Charged Surface Area for atom H
0431006000 Square root of Partial Charged Surface Area for atom C
0431007000 Square root of Partial Charged Surface Area for atom N
0431008000 Square root of Partial Charged Surface Area for atom O
0432000000 Positively Charged Surface Area (MOPAC PC)
0433000000 Positively Charged Partial Surface Area (MOPAC PC)
0434000000 Positively Charged Part of Charged Surface Area (MOPAC PC)
0435000000 Positively Charged Part of Partial Charged Surface Area (MOPAC PC)
0436000000 Negatively Charged Surface Area (MOPAC PC)
0437000000 Negatively Charged Partial Surface Area (MOPAC PC)
0438000000 Negatively Charged Part of Charged Surface Area (MOPAC PC)
0439000000 Negatively Charged Part of Partial Charged Surface Area (MOPAC PC)
0440000000 Difference (Pos−Neg) in Charged Surface Areas (MOPAC PC)
0441000000 Difference (Pos−Neg) in Charged Partial Surface Area (MOPAC PC)
0442000000 Difference (Pos−Neg) in Charged Part of Charged Surface Area (MOPAC PC)
0443000000 Difference (Pos−Neg) in Charged Part of Partial Charged Surface Area (MOPAC PC)
0444001000 Surface Area (MOPAC PC) for atom H
0444006000 Surface Area (MOPAC PC) for atom C
0444007000 Surface Area (MOPAC PC) for atom N
0444008000 Surface Area (MOPAC PC) for atom O
0445001000 Partial Surface Area (MOPAC PC) for atom H
0445006000 Partial Surface Area (MOPAC PC) for atom C
0445007000 Partial Surface Area (MOPAC PC) for atom N
0445008000 Partial Surface Area (MOPAC PC) for atom O
0446001000 Charged Surface Area (MOPAC PC) for atom H
0446006000 Charged Surface Area (MOPAC PC) for atom C
0446007000 Charged Surface Area (MOPAC PC) for atom N
0446008000 Charged Surface Area (MOPAC PC) for atom O
0447001000 Partial Charged Surface Area (MOPAC PC) for atom H
0447006000 Partial Charged Surface Area (MOPAC PC) for atom C
0447007000 Partial Charged Surface Area (MOPAC PC) for atom N
0447008000 Partial Charged Surface Area (MOPAC PC) for atom O
0448001000 Square root of Surface Area (MOPAC PC) for atom H
0448006000 Square root of Surface Area (MOPAC PC) for atom C
0448007000 Square root of Surface Area (MOPAC PC) for atom N
0448008000 Square root of Surface Area (MOPAC PC) for atom O
0449001000 Square root of Partial Surface Area (MOPAC PC) for atom H
0449006000 Square root of Partial Surface Area (MOPAC PC) for atom C
0449007000 Square root of Partial Surface Area (MOPAC PC) for atom N
0449008000 Square root of Partial Surface Area (MOPAC PC) for atom O
0450001000 Square root of Charged Surface Area (MOPAC PC) for atom H
0450006000 Square root of Charged Surface Area (MOPAC PC) for atom C
0450007000 Square root of Charged Surface Area (MOPAC PC) for atom N
0450008000 Square root of Charged Surface Area (MOPAC PC) for atom O
0451001000 Square root of Partial Charged Surface Area (MOPAC PC) for atom H
0451006000 Square root of Partial Charged Surface Area (MOPAC PC) for atom C
0451007000 Square root of Partial Charged Surface Area (MOPAC PC) for atom N
0451008000 Square root of Partial Charged Surface Area (MOPAC PC) for atom O
0462000000 min(#HA, #HD) (Zefirov PC) (all)
0463000000 count of H-acceptor sites (Zefirov PC) (all)
0464000000 count of H-donors sites (Zefirov PC) (all)
0465000000 HA dependent HDSA-1 (Zefirov PC) (all)
0466000000 HA dependent HDSA-1/TMSA (Zefirov PC) (all)
0467000000 HA dependent HDSA-2 (Zefirov PC) (all)
0468000000 HA dependent HDSA-2/TMSA (Zefirov PC) (all)
0469000000 HA dependent HDSA-2/SQRT(TMSA) (Zefirov PC) (all)
0470000000 HA dependent HDCA-1 (Zefirov PC) (all)
0471000000 HA dependent HDCA-1/TMSA (Zefirov PC) (all)
0472000000 HA dependent HDCA-2 (Zefirov PC) (all)
0473000000 HA dependent HDCA-2/TMSA (Zefirov PC) (all)
0474000000 HA dependent HDCA-2/SQRT(TMSA) (Zefirov PC) (all)
0475000000 HASA-1 (Zefirov PC) (all)
0476000000 HASA-1/TMSA (Zefirov PC) (all)
0477000000 HASA-2 (Zefirov PC) (all)
0478000000 HASA-2/TMSA (Zefirov PC) (all)
0479000000 HASA-2/SQRT(TMSA) (Zefirov PC) (all)
0480000000 HACA-1 (Zefirov PC) (all)
0481000000 HACA-1/TMSA (Zefirov PC) (all)
0482000000 HACA-2 (Zefirov PC) (all)
0483000000 HACA-2/TMSA (Zefirov PC) (all)
0484000000 HACA-2/SQRT(TMSA) (Zefirov PC) (all)
0485000000 min(#HA, #HD) (MOPAC PC) (all)
0486000000 count of H-acceptor sites (MOPAC PC) (all)
0487000000 count of H-donors sites (MOPAC PC) (all)
0488000000 HA dependent HDSA-1 (MOPAC PC) (all)
0489000000 HA dependent HDSA-1/TMSA (MOPAC PC) (all)
0490000000 HA dependent HDSA-2 (MOPAC PC) (all)
0491000000 HA dependent HDSA-2/TMSA (MOPAC PC) (all)
0492000000 HA dependent HDSA-2/SQRT(TMSA) (MOPAC PC) (all)
0493000000 HA dependent HDCA-1 (MOPAC PC) (all)
0494000000 HA dependent HDCA-1/TMSA (MOPAC PC) (all)
0495000000 HA dependent HDCA-2 (MOPAC PC) (all)
0496000000 HA dependent HDCA-2/TMSA (MOPAC PC) (all)
0497000000 HA dependent HDCA-2/SQRT(TMSA) (MOPAC PC) (all)
0498000000 HASA-1 (MOPAC PC) (all)
0499000000 HASA-1/TMSA (MOPAC PC) (all)
0500000000 HASA-2 (MOPAC PC) (all)
0501000000 HASA-2/TMSA (MOPAC PC) (all)
0502000000 HASA-2/SQRT(TMSA) (MOPAC PC) (all)
0503000000 HACA-1 (MOPAC PC) (all)
0504000000 HACA-1/TMSA (MOPAC PC) (all)
0505000000 HACA-2 (MOPAC PC) (all)
0506000000 HACA-2/TMSA (MOPAC PC) (all)
0507000000 HACA-2/SQRT(TMSA) (MOPAC PC) (all)

### Minimum Descriptors

0092001000 Min partial charge (Zefirov) for atoms for atom H
0092006000 Min partial charge (Zefirov) for atoms for atom C
0092007000 Min partial charge (Zefirov) for atoms for atom N
0092008000 Min partial charge (Zefirov) for atoms for atom O
0094000000 Min partial charge (Zefirov) for all atom types
0137000000 min(#HA, #HD) (Zefirov PC)
0198000000 min(#HA, #HD) (MOPAC PC)
0292006000 Min nucleoph. react. index for atom C
0292007000 Min nucleoph. react. index for atom N
0292008000 Mim nucleoph. react. index for atom O
0295006000 Min electroph. react. index for atom C
0295007000 Min electroph. react. index for atom N
0295008000 Min electroph. react. index for atom O
0298006000 Min 1-electron react. index for atom C
0298007000 Min 1-electron react. index for atom N
0298008000 Min 1-electron react. index for atom O
0306000000 Min atomic orbital electronic population
0313001000 Min valency for atom H
0313006000 Min valency for atom C
0313007000 Min valency for atom N
0313008000 Min valency for atom O
0316001000 Min (>0.1) bond order for atom H
0316006000 Min (>0.1) bond order for atom C
0316007000 Min (>0.1) bond order for atom N
0316008000 Min (>0.1) bond order for atom O
0319001000 Min e-e repulsion for atom H
0319006000 Min e-e repulsion for atom C
0319007000 Min e-e repulsion for atom N
0319008000 Min e-e repulsion for atom O
0321001000 Min e-n attraction for atom H
0321006000 Min e-n attraction for atom C
0321007000 Min e-n attraction for atom N
0321008000 Min e-n attraction for atom O
0323001000 Min atomic state energy for atom H
0323006000 Min atomic state energy for atom C
0323007000 Min atomic state energy for atom N
0323008000 Min atomic state energy for atom O
0325001006 Min resonance energy for bond H—C
0325001007 Min resonance energy for bond H—N
0325001008 Min resonance energy for bond H—O
0325006006 Min resonance energy for bond C—C
0325006007 Min resonance energy for bond C N
0325006008 Min resonance energy for bond C—O
0327001006 Min exchange energy for bond H—C
0327001007 Min exchange energy for bond H—N
0327001008 Min exchange energy for bond H—O
0327006006 Min exchange energy for bond C—C
0327006007 Min exchange energy for bond C—N
0327006008 Min exchange energy for bond C
0329001006 Min e-e repulsion for bond H—C
0329001007 Min e-e repulsion for bond H—N
0329001008 Min e-e repulsion for bond H—O
0329006006 Min e-e repulsion for bond C—C
0329006007 Min e-e repulsion for bond C—N
0329006008 Min e-e repulsion for bond C—O
0331001006 Min e-n attraction for bond H—C
0331001007 Min e-n attraction for bond H—N
0331001008 Min e-n attraction for bond H—O
0331006006 Min e-n attraction for bond C—C
0331006007 Min e-n attraction for bond C—N
0331006008 Min e-n attraction for bond C—O
0333001006 Min n-n repulsion for bond H—C
0333001007 Min n-n repulsion for bond H—N
0333001008 Min n-n repulsion for bond H—O
0333006006 Min n-n repulsion for bond C—C
0333006007 Min n-n repulsion for bond C—N
0333006008 Min n-n repulsion for bond C—O
0335001006 Min coulombic interaction for bond H—C
0335001007 Min coulombic interaction for bond H—N
0335001008 Min coulombic interaction for bond H—O
0335006006 Min coulombic interaction for bond C—C
0335006007 Min coulombic interaction for bond C—N
0335006008 Min coulombic interaction for bond C—O
0337001006 Min total interaction for bond H—C
0337001007 Min total interaction for bond H—N
0337001008 Min total interaction for bond H—O
0337006006 Min total interaction for bond C—C
0337006007 Min total interaction for bond C—N
0337006008 Min total interaction for bond C—O
0398001000 Min net atomic charge (typed) for atom H
0398006000 Min net atomic charge (typed) for atom C
0398007000 Min net atomic charge (typed) for atom N
0398008000 Min net atomic charge (typed) for atom O
0402000000 Min net atomic charge
0462000000 min(#HA, #HD) (Zefirov PC) (all)
0485000000 min(#HA, #HD) (MOPAC PC) (all)

### Minium Common Descriptors

0092001000 Min partial charge (Zefirov) for atoms for atom H
0094000000 Min partial charge (Zefirov) for all atom types
0137000000 min(#HA, #HD) (Zefirov PC)
0198000000 min(#HA, #HD) (MOPAC PC)
0306000000 Min atomic orbital electronic population
0313001000 Min valency for atom H
0316001000 Min (>0.1) bond order for atom H
0319001000 Min e-e repulsion for atom H
0321001000 Min e-n attraction for atom H
0323001000 Min atomic state energy for atom H
0398001000 Min net atomic charge (typed) for atom H
0402000000 Min net atomic charge
0462000000 min(#HA, #HD) (Zefirov PC) (all)
0485000000 min(#HA, #HD) (MOPAC PC) (all)

What is claimed is:

1. A method for determining absorbent molecules that are effective for the property of acid gas removal from feedstreams comprising
a) determining a set of known molecules that are effective for acid gas removal,
b) defining descriptive parameters (descriptors) that correlate with the structure of molecules with known acid gas removal,
c) assigning a value to each descriptor for each of the known molecules and developing a quantitative structure and property relationship (QSPR), and
d) generating molecular structures that will be effective for acid gas removal from the structure and property relationship.

2. The method of claim 1 wherein the acid gas is H₂S.

3. The method of claim 2 wherein determining a set of molecules that are effective for acid removal is by selectivity.

4. The method of claim 2 wherein determining a set of molecules that are effective for acid removal is by loading.

5. The method of claim 2 wherein determining a set of molecules that are effective for acid removal is by capacity.

6. The method of claim 2 wherein determining a set of molecules that are effective for acid removal is by
$$P = \frac{S \cdot {( {L}_{W} )}^{X}}{{( VP )}^{Y}}$$
where S is selectivity, L_{W} is acqueous solubility of the molecule, VP is vapor pressure of the molecule and X and Y are exponent values that may take values 0.5, 1, 2.

7. The method of claim 1 wherein said step of generating molecular structures is by the whole molecule approach.

8. The method of claim 1 wherein said step of generating molecular structures is by the molecular fragment approach.
